(19) United States
(12) Patent Application Publication
(10) Pub. No.: US 2025/0221386 A1
(43) Pub. Date: Jul. 10, 2025

(54) MODULAR ECOLOGICAL SYSTEM WITH STRUCTURAL ASSEMBLY FOR ENHANCED STABILITY AND ENVIRONMENTAL INTEGRATION

(71) Applicant: Reef Arches PHC, LLC, West Palm Beach, FL (US)

(72) Inventor: Keith Richardson, Lake Worth, FL (US)

(21) Appl. No.: 19/089,941

(22) Filed: Mar. 25, 2025

Related U.S. Application Data
(63) Continuation-in-part of application No. PCT/US24/29169, filed on May 13, 2024.
(60) Provisional application No. 63/569,645, filed on Mar. 25, 2024.
(60) Provisional application No. 63/674,710, filed on Jul. 23, 2024.
(60) Provisional application No. 63/465,937, filed on May 12, 2023.

(51) Int. Cl. A01K 61/73; A01K 61/78

(52) U.S. Cl. CPC A01K 61/73; A01K 61/78

(57) ABSTRACT

A modular ecological system is disclosed, comprising an ecological structure with a base section featuring a body with a first end region, a second end region, and upper and lower curved surfaces extending between the ends. Side walls converge at an apex region, creating a defined thickness and supporting lateral rods extending outwardly. The system includes a wheel and axle assembly attachable to the rods and a truss assembly with elements extending from the wheel and axle assembly to the apex, providing structural reinforcement. Flotation devices are attachable through openings in the curved surfaces to facilitate buoyancy. The system may include symmetrically arranged flotation devices, connection points, looped cables, and a load distribution nub on the upper curved surface. A method for assembling the system involves positioning and securing the wheel and axle assembly, engaging axle receiving sections, and attaching flotation devices through defined openings for stability in various environments.

### REFERENCE TO RELATED APPLICATIONS

This application is a non-provisional which claims the benefit of the filing date of U.S. Provisional Application Ser. No. 63/569,645 titled “APPARATUS, METHODS, AND SYSTEMS FOR TRANSPORTING AND DEPLOYING ECOLOGICAL STRUCTURES” and filed Mar. 25, 2024 and the subject matter of which is incorporated herein by reference.

This application also claims the benefit of the filing date of U.S. Provisional Application Ser. No. 63/674,710 titled “APPARATUS, METHODS, AND SYSTEMS FOR THE DEPLOYMENT, ASSEMBLY, AND STABILIZATION OF MODULAR ECOLOGICAL STRUCTURES” and filed Jul. 23, 2024 and the subject matter of which is incorporated herein by reference.

This application is also a continuation-in-part of PCT Application Serial No. PCT/US24/29169 titled “ARTIFICIAL REEF STRUCTURE” and filed May 13, 2024, which claims the benefit of the filing date of U.S. Provisional Application Ser. No. 63/465,937 titled “Artificial Reef Structure” and filed May 12, 2023, and the subject matter of which is incorporated herein by reference.

### CROSS-REFERENCES

Not applicable.

### STATEMENT REGARDING FEDERALLY SPONSORED RESEARCH OR DEVELOPMENT

Not applicable.

### INCORPORATION BY REFERENCE OF MATERIAL SUBMITTED ON A COMPACT DISK

Not applicable.

### TECHNICAL FIELD

The present disclosure relates to the field of environmental engineering, and more specifically to the field of ecological systems designed for environmental integration.

### BACKGROUND OF THE INVENTION

In recent years, environmental degradation and climate change have intensified the vulnerability of natural habitats, particularly in coastal, riparian, and transitional environments. Rising sea levels, increased storm frequency, and widespread pollution have led to accelerated erosion, habitat loss, and the decline of biodiversity. Wetlands, estuaries, riverbanks, and shorelines play critical roles in protecting against these changes by providing natural barriers, improving water quality, and supporting a range of species. However, these ecosystems are increasingly at risk, necessitating interventions for both preservation and restoration to maintain ecological balance and protect biodiversity.

Traditional approaches to ecological restoration have primarily relied on fixed infrastructure, such as concrete barriers, rock embankments, and artificial reefs. While effective to some degree, these solutions present numerous challenges. Fixed structures are often costly, labor-intensive to install, and can create a lasting disruption to the natural landscape. Moreover, these rigid installations do not adapt well to changing environmental conditions, such as varying water levels, tidal forces, and shifting substrates. In the long term, such inflexible designs can lead to additional erosion around the structure, inhibit natural sediment deposition, and disrupt the migration patterns of aquatic and terrestrial species.

On the other hand, organic or biodegradable installations, such as coir logs and oyster shells, have been explored as temporary solutions to erosion and habitat loss. While these materials offer environmental benefits and a lower impact on local ecosystems, they often lack durability and structural integrity, particularly in high-energy environments or areas subject to significant hydrodynamic forces. Consequently, such solutions may require frequent replacement, adding to maintenance costs and impacting overall project sustainability. Furthermore, the lack of modularity in these approaches makes it challenging to expand or reconfigure installations in response to changing ecological needs or conditions.

Attempts to introduce modular systems have sought to combine adaptability with ecological integration. However, existing modular solutions are limited in their functional scope, frequently lacking essential components that address buoyancy, load distribution, and structural stability under diverse environmental stresses. Many current modular designs are either overly simplistic, focusing only on interlocking structures without sufficient reinforcement, or overly complex, requiring specialized equipment and expertise for installation. This lack of balance often limits their effectiveness and scalability in real-world applications. Furthermore, many existing systems are not designed to integrate seamlessly with supplemental ecological features such as trusses, flotation devices, or buoyancy aids, which could improve stability and adaptability across different environments.

Moreover, ecological restoration efforts often require structures that are not only physically stable but also facilitate biological processes. For example, ecological systems benefit from designs that mimic natural habitats, support hydrodynamic flow, and provide suitable surfaces for flora and fauna colonization. However, many current modular solutions do not account for these ecological needs, focusing primarily on structural concerns while neglecting critical habitat functions.

As a result, there exists a need for improvements over the prior art and more particularly for a more efficient way of providing a modular ecological system that combines structural versatility with ecological compatibility. Such a system should allow for customizable configurations, enabling adjustments in size, buoyancy, and shape based on specific environmental needs. Additionally, a practical modular solution should prioritize ease of transport, assembly, and maintenance, minimizing the logistical challenges associated with large-scale ecological restoration projects. In this way, the invention can address the multifaceted demands of modern environmental management by providing a flexible, resilient, and ecologically integrative approach to habitat restoration and protection.

### BRIEF SUMMARY OF THE INVENTION

A system and method for a modular ecological system is disclosed. This Summary is provided to introduce a selection of disclosed concepts in a simplified form that are further described below in the Detailed Description including the drawings provided. This Summary is not intended to identify key features or essential features of the claimed subject matter. Nor is this Summary intended to be used to limit the claimed subject matter's scope.

In one embodiment, a modular ecological system is disclosed. The system comprises an ecological structure comprising a base section comprising a body comprising a first end region, a second end region, and an upper curved surface and a lower curved surface spanning between the first end region and the second end region. The base section comprises a first side wall and a second side wall extending from each of the first end region and second end region and converging at an apex region, wherein the first side wall and the second side wall define a thickness between the upper curved surface and the lower curved surface. A first rod extends laterally through the first end region, and a second rod extends laterally through the second end region. Each of the first rod and the second rod extend outwardly from both the first side wall and second side wall. The modular ecological system further comprises a wheel and an axle assembly attachable to the first rod at a portion extending outward from the first side wall and the second side wall. The wheel and axle assembly comprises a first receiving section on the axle disposed at a first angle relative to a second receiving section on the axle. The modular ecological system further comprises a truss assembly, wherein the truss assembly comprises a plurality of truss elements, each truss element extending upwardly from the wheel and axle assembly and having a connection point at the apex region. The modular ecological system further comprises a flotation device attached to the ecological structure. The flotation device is attached to the ecological structure with a fastener passing through an opening extending through the upper curved surface to the lower curved surface. A plurality of flotation devices are arranged symmetrically about the ecological structure. The ecological structure comprises a plurality of connection points on each of the first side wall and the second side wall. The ecological structure further comprises a looped cable extending from each of the first side wall and the second side wall. The ecological structure further comprises a load distribution nub on the upper curved surface. The upper curved surface comprises a first uniform radius of curvature and the lower curved surface comprises a second uniform radius of curvature, and the thickness between the upper curved surface and the lower curved surface continuously decreases from the apex region to each of the first end region and the second end region. The opening extending through the upper curved surface to the lower curved surface comprises a predetermined opening angle to direct a plurality of hydrodynamic forces through the structure.

Additional aspects of the disclosed embodiment will be set forth in part in the description which follows, and in part will be obvious from the description, or may be learned by practice of the disclosed embodiments. The aspects of the disclosed embodiments will be realized and attained by means of the elements and combinations particularly pointed out in the appended claims. It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute part of this specification, illustrate embodiments of the disclosure and together with the description, explain the principles of the disclosed embodiments. The embodiments illustrated herein are presently preferred, it being understood, however, that the disclosure is not limited to the precise arrangements and instrumentalities shown, wherein:

FIG. 1 is a front isometric view of a first artificial reef segment, according to an example embodiment;

FIG. 2 is an isometric view of an artificial reef configuration having three artificial reef segments connected to one another;

FIG. 3 is an isometric view of a transport configuration having three artificial reef segments stacked upon one another;

FIG. 4 is an isometric view of the artificial reef system arranged in a zigzag pattern in reef configuration, according to an example embodiment;

FIG. 5 is a front view of a portion of one of plurality of frame segments, according to a first example embodiment; and

FIG. 6 is a front view of a portion of one of plurality of frame segments, according to a second example embodiment.

FIG. 7 is a close up view of a portion of a first artificial reef structure connected to a portion of a second artificial reef structure, according to an example embodiment;

FIG. 8 is an isometric view of the artificial reef system arranged in a zigzag pattern in reef configuration, according to a second example embodiment;

FIG. 9 is an isometric view of the artificial reef system arranged in a zigzag pattern in reef configuration, according to a third example embodiment;

FIGS. 10A, 10B, 10C, 10D, 10E and 10F illustrate various views of reef inserts disposed within openings of artificial reef segment, according to an example embodiment;

FIGS. 11A, 11B, 11C, 11D and 11E are various schematic views of reef inserts, according to an example embodiment;

FIGS. 12A, 12B, 12C, 12D, 12E and 12F are schematic sectional views of an opening of the artificial reef segment, according to an example embodiment;

FIGS. 13A and 13B are top schematic views of reef inserts positioned inside an opening of an artificial reef segment, according to an example embodiment;

FIGS. 14A, 14B and 14D are schematic views of artificial reef segments, according to an example embodiment;

FIGS. 14C, 14E, 14F, and 14G are images of a configuration of artificial reef segments, according to an example embodiment; and

FIGS. 15A, 15B and 15C are block flow diagrams for configuring artificial reef structure, according to an example embodiment.

FIG. 16 is a perspective view of a system for the deployment, assembly, and stabilization of modular ecological structures in aquatic environments, according to an example embodiment;

FIG. 17A is a front view of the system for the deployment, assembly, and stabilization of modular ecological structures in aquatic environments, according to an example embodiment;

FIG. 17B is a perspective view of the system for the deployment, assembly, and stabilization of modular ecological structures in aquatic environments, according to an example embodiment;

FIG. 18 is detailed view of the system for the deployment, assembly, and stabilization of modular ecological structures in aquatic environments, according to an example embodiment;

FIG. 19A is a front view of the system of modular ecological structures in a transport configuration, according to an example embodiment;

FIG. 19B is a side view of the system of modular ecological structure in the transport configuration, according to an example embodiment;

FIG. 19C is a side view of the system of modular ecological structure in the transport configuration, according to an example embodiment;

FIG. 20A is a side view of the modular ecological structure in the amphibious vehicle configuration, according to an example embodiment;

FIG. 20B is a perspective, view of the modular ecological structure in the amphibious vehicle configuration, according to an example embodiment;

FIG. 21A is a side view of the modular ecological structure in the amphibious vehicle configuration, according to an example embodiment;

FIG. 21B is a side view of the modular ecological structure in the amphibious vehicle configuration, according to an example embodiment;

FIG. 21C is a side view of the modular ecological structure in the amphibious vehicle configuration, according to an example embodiment;

FIG. 21D is a perspective, view of the modular ecological structure in the amphibious vehicle configuration, according to an example embodiment;

FIG. 21E is a side view of the modular ecological structure in the amphibious vehicle configuration, according to an example embodiment;

FIG. 21F is a perspective view of the modular ecological structure in the amphibious vehicle configuration, according to an example embodiment;

FIG. 22A is a perspective view of the modular ecological structure in the amphibious vehicle configuration, according to an example embodiment;

FIG. 22B is a side view of the modular ecological structure in the amphibious vehicle configuration, according to an example embodiment;

FIG. 22C is a front view of the modular ecological structure in the amphibious vehicle configuration, according to an example embodiment;

FIG. 23A is a perspective view of the precision deployment apparatus, according to an example embodiment;

FIG. 23B is a perspective view of the precision deployment apparatus, according to an example embodiment;

FIG. 23C is a side view of the precision deployment apparatus, according to an example embodiment;

FIG. 23D is a perspective view of the precision deployment apparatus, according to an example embodiment;

FIG. 23E is an exploded perspective view of the precision deployment apparatus, according to an example embodiment;

FIG. 23F is a perspective view of the precision deployment apparatus in a nested configuration, according to an example embodiment;

FIG. 24A is a front view of the precision deployment apparatus in a nested configuration, according to an example embodiment;

FIG. 24B is a side view of the precision deployment apparatus in a nested configuration, according to an example embodiment;

FIG. 24C is a bottom view of the precision deployment apparatus in a nested configuration, according to an example embodiment;

FIG. 24D is a perspective view of the precision deployment apparatus in a nested configuration, according to an example embodiment;

FIG. 25 is a perspective view of the precision deployment apparatus, according to an example embodiment;

FIG. 26 is a perspective view of the precision deployment apparatus, according to an example embodiment;

FIG. 27 is a perspective view of the pivoting element of the precision deployment apparatus in attachment with an ecological structure acting as a fulcrum for pivoting, according to an example embodiment;

FIG. 28A is a detailed perspective view of the low-profile attachment plate between stacked ecological structures, according to an example embodiment;

FIG. 28B is a detailed perspective view of the low-profile attachment plate between stacked ecological structures, according to an example embodiment;

FIG. 28C is a side view of the low-profile attachment plate between stacked ecological structures, according to an example embodiment;

FIG. 29A is a side view of the low-profile attachment plate, according to an example embodiment;

FIG. 29B is a top view of the low-profile attachment plate, according to an example embodiment;

FIG. 29C is a perspective view of the low-profile attachment plate according to an example embodiment;

FIG. 29D is a perspective view of the low-profile attachment plate according to an example embodiment;

FIG. 30A is a bottom perspective view of the modular ecological structure with a minor flotation device, according to an example embodiment;

FIG. 30B is a front view of the low-profile attachment plate with a minor flotation device, according to an example embodiment;

FIG. 31A is a front view of adjacent nesting sections of the precision deployment apparatus, according to an example embodiment;

FIG. 31B is a back view of adjacent nesting sections of the precision deployment apparatus, according to an example embodiment;

FIG. 31C is a side view of adjacent nesting sections of the precision deployment apparatus in a disengaged position, according to an example embodiment;

FIG. 31D is a back view of adjacent nesting sections of the precision deployment apparatus in an engaged position, according to an example embodiment;

FIG. 32A is a detailed perspective view of adjacent nesting sections of the precision deployment apparatus in a disengaged position, according to an example embodiment;

FIG. 32B is a detailed perspective view of adjacent nesting sections of the precision deployment apparatus in a disengaged position, according to an example embodiment;

FIG. 32C is a detailed perspective view of adjacent nesting sections of the precision deployment apparatus in an engaged position, according to an example embodiment;

FIG. 32D is a detailed perspective view of adjacent nesting sections of the precision deployment apparatus in an engaged position, according to an example embodiment;

FIG. 32E is a detailed perspective view of adjacent nesting sections of the precision deployment apparatus in an engaged position, according to an example embodiment;

FIG. 33A is a front view of adjacent nesting sections of the precision deployment apparatus in an engaged, position, according to an example embodiment;

FIG. 33B is a back view of adjacent nesting sections of the precision deployment apparatus in an engaged, position, according to an example embodiment;

FIG. 33C is a perspective view of adjacent nesting sections of the precision deployment apparatus in an engaged position below a disengaged position, according to an example embodiment;

FIG. 34 is a flowchart diagram illustrating steps of a method for converting a modular ecological structure into an amphibious vehicle configuration, according to an example embodiment;

FIG. 35A is a flowchart diagram illustrating steps of a method for the deployment, assembly, and stabilization of modular ecological structures in aquatic environments, according to an example embodiment;

FIG. 35B is a flowchart diagram illustrating steps of the method for the deployment, assembly, and stabilization of modular ecological structures in aquatic environments, according to an example embodiment;

FIG. 35C is a flowchart diagram illustrating steps of the method for the deployment, assembly, and stabilization of modular ecological structures in aquatic environments, according to an example embodiment;

FIG. 36 is a diagram illustrating the flow of water through the ecological structure, according to an example embodiment;

FIG. 37 is a diagram illustrating the flow of water through the ecological structures in the chain-like configuration, according to an example embodiment;

FIG. 38 is a perspective view of the ecological structures in a chain-like configuration during deployment, according to an example embodiment;

FIG. 39 is a perspective view of the ecological structure in comparison to an eight cubic foot slab of concrete, according to an example embodiment;

FIG. 40 is a flowchart diagram illustrating the steps for a method for assembling the modular ecological structure, according to an example embodiment.

In the context of the present disclosure, it is understood that the figures provided are drawn to scale. This aspect is fundamental in accurately conveying the design and dimensions of the artificial reef segment and its system. The scaled figures offer a precise representation, essential for those involved in manufacturing, implementation, and scientific evaluation of the system. That said, it is further understood that other embodiments, proportions, and dimensions may exist that fall within the spirit and scope of the disclosure. While the figures are presented to scale for clarity and precision, they do not limit the extent of the concepts and innovations encompassed by the disclosure. Variations in design, size, and configuration that adhere to the underlying principles and functionalities of the artificial reef system are considered to be within the ambit of this disclosure.

Like reference numerals refer to like parts throughout the various views of the drawings.

### DETAILED DESCRIPTION

The following detailed description refers to the accompanying drawings. Whenever possible, the same reference numbers are used in the drawings and the following description to refer to the same or similar elements. While disclosed embodiments may be described, modifications, adaptations, and other implementations are possible. For example, substitutions, additions, or modifications may be made to the elements illustrated in the drawings, and the methods described herein may be modified by substituting reordering or adding additional stages or components to the disclosed methods and devices. Accordingly, the following detailed description does not limit the disclosed embodiments. Instead, the proper scope of the disclosed embodiments is defined by the appended claims.

The disclosed embodiments improve upon the problems with the prior art by providing a system that addresses critical shortcomings in adaptability, stability, and ecological integration. Unlike conventional systems that rely on fixed, rigid designs, the disclosed invention employs a modular structure that facilitates customization, reconfiguration, and scalability to suit a wide range of environmental conditions, including aquatic, terrestrial, and transitional ecosystems. This modularity enables tailored solutions for specific ecological needs, offering superior flexibility compared to static, monolithic installations. The invention integrates flotation devices that are symmetrically arranged and securely attached to the ecological structure through openings extending from the upper to the lower curved surfaces. This arrangement provides enhanced buoyancy and stability in dynamic environments such as tidal zones, where prior art often fails to adequately address fluctuating hydrodynamic forces. The attachment mechanism, using fasteners passing through the structure, ensures durability and ease of installation without compromising the system's structural integrity.

The ecological structure features a novel design with upper and lower curved surfaces having distinct radii of curvature and a thickness that continuously decreases from the apex region to the end regions. This configuration provides optimized load distribution and resistance to hydrodynamic forces, reducing structural stress and extending the operational lifespan. The streamlined profile mitigates environmental impacts, such as erosion or displacement, which are common limitations in prior designs. Further improvements are realized through the inclusion of a wheel and axle assembly with receiving sections disposed at specific angles. This design allows for pivotable adjustments during assembly and operation, facilitating secure attachment and orientation of truss elements. The truss assembly, comprising multiple elements extending to the apex region, provides enhanced vertical stability and load-bearing capacity, features often absent in prior modular ecological systems. These structural reinforcements allow the disclosed system to maintain resilience in high-energy environments.

The ecological structure is further enhanced with connection points and looped cables extending from the side walls, which enable secure attachment to adjacent modules, anchors, or additional equipment. These features offer greater versatility and stability, ensuring the system can be effectively deployed in diverse environmental settings. Prior art solutions often lack such integrative mechanisms, limiting their adaptability and long-term reliability. Another critical advancement is the inclusion of an angled opening extending through the upper and lower curved surfaces, designed to direct hydrodynamic forces through the structure. This feature reduces drag and stabilizes the system in high-flow environments, an improvement over traditional designs that fail to account for dynamic environmental interactions.

Collectively, the disclosed invention provides a modular ecological system that overcomes the rigidity, instability, and ecological limitations of prior art, delivering a robust, adaptable, and environmentally integrative solution for modern ecological restoration and habitat management applications.

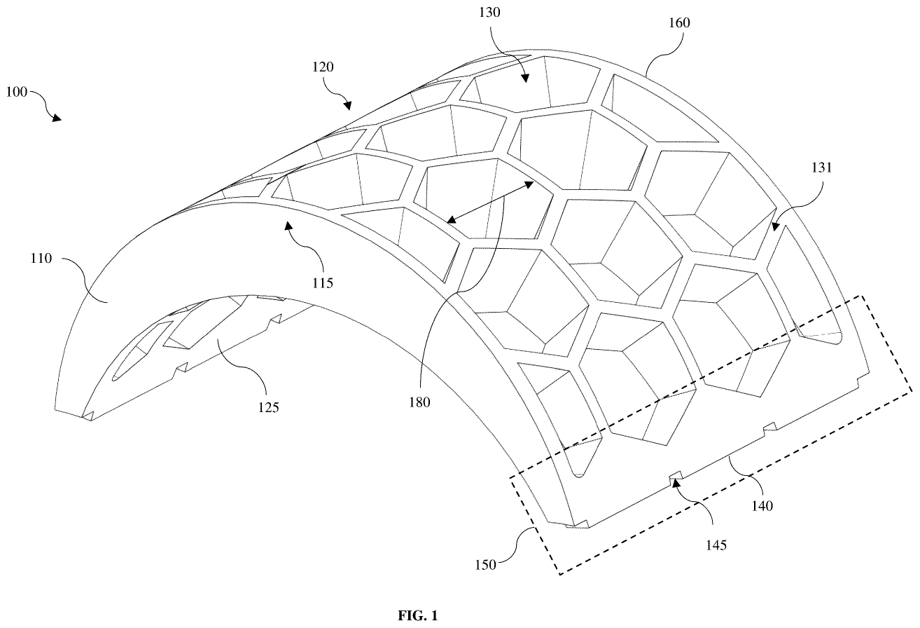

Referring now to the Figures, FIGS. 1-6 represent an artificial reef system 100 for stabilizing soil for accretion and retention of coastal water soil and for providing a water barrier, breakwater, and artificial habitation for marine life. The artificial reef system includes a plurality of artificial reef segments. Each reef segment comprises a curved frame structure 110, a plurality of openings 130 extending through the curved frame structure, a plurality of frame segments 140, and a plurality of cutouts 145. As shown in FIG. 1, this particular design combats the issue of seabed scouring such that its leading edge is a low profile open face allowing for redirection of currents with minimal destructive Eddie spawning. This design greatly improves upon the prior art by increasing the longevity and security of the structure once placed on the sea bed. As disclosed herein, the artificial reef segment has an integrated structure. In certain embodiments, the artificial reef segment may comprise multiple components that are joined or coupled together. For example, the reef segment may have two side walls (curved structure) and a central frame having the openings. The two side walls, and the central frame may be assembled by coupling with each other to form the artificial reef segment. The components may be combined using mechanical fasteners, such as nuts, or bolts. In another example, the components may be combined using sliding rail type attachment where the central frame has extended tabs on both sides and the two side walls have grooves to receive the extended tab.

FIG. 1 represents a first artificial reef segment 160. The curved frame structure 110 includes a vertex section 115, an outer curved surface 120, and an inner curved surface 125. In the present embodiment the frame structure has a side cross-sectional shape of an arch. The frame structure may be described as a load bearing structure composed of interconnected members of the same material providing stability, strength, and uniform appearance and/or a single unit formulated by a molding and curing process. The frame structure normally has symmetrical geometry or uniform structure making them easier to analyze and design. Because the frame structure is made of the same materials having the same material properties and cross-sectional shape, the behavior of the structure can be predicted more accurately when designing for specific loads and conditions. Another benefit of having frame structures is reduced maintenance. Because the members of the frame have the same properties, they should wear at the same rate, reducing the need for maintenance and repair.

The vertex section 115 or apex section may be defined as the portion of the frame structure where the curve of the frame structure changes from sloping upward to sloping downward. Also known as the apex or top portion of the arch. In the example embodiments, shown in FIGS. 1-4, the vertex section is rounded at the highest point of the frame structure. In other embodiments, the vertex may appear differently. For example, in other embodiments the vertex section may plateau forming a planar surface along the highest point of the frame structure. In other embodiments, the vertex may come to a rigid point. It is also possible for the frame structure to have multiple vertices of varied sizes and shapes.

The outer curved surface 120 of the frame structure may be defined as the outermost portion of the structure following a continuous path forming a curve. In some embodiments, the outer curved surface may be textured and rough facilitating the attachment of marine organisms. Similarly, the inner curved surface 125 may be defined as the part of the structure facing inward towards the center of the structure following the same or a different curved path of the outer curved surface. The inner and outer curved surface may be defined by a mathematical function or equation taking on different shapes from simple curves such as circles or ellipses to more complex curves like parabolas. The curvature of each curved surface may vary in magnitude or may be identical to each other. The outer curved surface 120 and inner curved surface 125 may be formed by the same material as the frame structure or may be formed from a different material with different texture or properties. Each artificial reef segment is such that it comprises a uniform structure and same material. The material used for the artificial reef segment may be reinforced, or have other materials embedded within or combinations of materials. Examples of such material may include, Concrete reinforced with fibers such as glass, polypropylene, or steel, Stainless Steel Structures, Fiber-Reinforced Polymers (FRP), Reinforced Plastics, and reinforced marine-grade concrete, Metal Matrix Composites (MMCs). In some embodiments, the curved frame structure 110 may be created from materials such as concrete, limestone, metal, rock, organic materials such as bamboo, artificial reef modules, and acrylic polymer and alumina trihydrate (ATH), derived from bauxite ore. In other embodiments, the system may be comprised of a uniform material, meaning that the entire structure is composed of the same substance throughout. This uniformity ensures consistent properties such as strength, durability, and resistance to environmental factors across the entire segment or insert. The concrete material may be made using recycled materials such as crushed glass, fly ash, or slag. This reduces the demand for new materials and helps to recycle waste. In an embodiment, the material used for the curved frame structure may be eco-friendly polymers that are specifically designed to be environmentally friendly. These polymers can be used to create artificial reef segments that mimic natural coral structure. The manufacturing processes used to create these frame structures may include extrusions, molding, casting, welding, punching, folding, 3D printing, CNC machining, etc. The frame structures may be formed from a single piece of material, or several individual pieces joined or coupled together. However, other materials and manufacturing processes may also be used and are within the spirit and the scope of the present invention.

In the fabrication of the reef arch segment and its inserts, the employment of CSA (Calcium Sulfoaluminate) concrete represents an improvement over materials traditionally used in such applications. CSA concrete distinguishes itself through its rapid setting time and high early strength, which are especially advantageous in the marine setting where quick stabilization of structures is imperative. This rapid development of strength ensures that the reef structures can withstand the dynamic and often harsh oceanic conditions soon after installation. In contrast to conventional Portland cement, CSA concrete has a reduced environmental impact due to its lower limestone content and decreased energy requirements for production. This aspect aligns with the growing emphasis on environmental sustainability in material selection. Furthermore, CSA concrete's enhanced resistance to sulfate attack—a prevalent challenge in marine environments—ensures greater durability and longevity of the reef segments and inserts. Its adaptability to marine conditions, combined with its environmental benefits, positions CSA concrete as a significant advancement over prior art in the construction of artificial reef systems.

The artificial reef segments, though appearing to be frame structures due to their interconnected frame-like appearance, are in fact single, monolithic structures created from a single pour into a mold. This design illusion arises from the sophisticated mold used during the manufacturing process, which intricately shapes the concrete to mimic a composition of multiple connected frames. However, unlike true frame structures that can be assembled or disassembled, these arches are indivisible and unmodifiable post-manufacture.

The manufacturing process involves pouring a specially formulated concrete mixture into a pre-designed mold that imparts the visual complexity of interconnected frames onto the final structure. Once the concrete cures, it forms a solid, continuous mass that retains the strength and integrity of a singular structure. This one-piece construction method eliminates any potential weaknesses that might occur at assembly joints in a true frame structure, thereby enhancing the durability and stability of the artificial reef segment under marine conditions. This integral construction ensures that the arch cannot be broken down into smaller components, reinforcing its permanence and reliability as a part of the marine infrastructure.

In certain embodiments of the artificial reef segments, the structural integrity of the concrete arches is enhanced by incorporating rebar and other reinforcing materials within the mold before the concrete mixture is poured. This addition of rebar provides essential tensile strength to the concrete arches, which naturally possess high compressive strength but require reinforcement to effectively resist bending and tensile stresses that occur during handling, transportation, and long-term environmental exposure.

During the molding process, rebar cages or meshes are carefully placed within the mold according to the structural requirements of the arch. These reinforcing frameworks are positioned to ensure they are optimally located within the thickness of the arch, particularly where the cross-sectional thickness varies, to maximize strength where it is most needed. Once in place, the concrete mixture is poured around the rebar, encapsulating it completely upon curing. This method of reinforcement ensures that each artificial reef segment not only maintains its physical integrity under marine forces but also enhances its durability, contributing to the longevity and ecological function of the reef system.

In the artificial reef structure, the materials of the inserts may differ from the main material of the reef segment. This allows for creating a mosaic of inserts, where each insert may be made from different materials, throughout the reef structure. The inserts within the artificial reef segments can be designed as a mosaic, representing a multifaceted and integrative approach to habitat creation. In this context, a mosaic refers to an assembly of different inserts, each comprising different shapes, structures, and/or materials, each forming a distinct piece of the overall system. This diverse composition allows each insert to provide unique environmental conditions suitable for various marine species.

The variation in materials is strategically chosen to cater to specific requirements of different marine organisms, enhancing the habitat's ecological value. Some materials might be selected for their ability to support the growth of specific species or for their textural properties that suit certain marine life better, thereby fostering a rich and varied underwater ecosystem. In certain embodiments of the artificial reef system, in addition to the improvement of the differing material composition the inserts, another improvement involves a single insert comprising different materials in segmented sections, each tailored to support diverse symbiotic species growth. This multifaceted insert structure exhibits a significant advancement over prior art in artificial reef technologies, primarily due to its enhanced ecological functionality and habitat diversity.

Each segment of the insert, distinct in its material composition, may be specifically designed to create unique microhabitats within the reef system. For example, one segment may utilize a porous material like bio-concrete, conducive to the growth of certain coral or algae species, while another segment might be made from a smoother material like recycled plastic, suitable for species preferring less abrasive surfaces. This diversity in material composition within a single insert allows for the simultaneous support of a range of marine species, each with unique environmental needs, thereby fostering a more dynamic and symbiotic marine ecosystem. Similarly, one entire insert may be a porous material whereas another insert located on a separate part of the system may be a smooth material.

This material variability within the system addresses a key limitation of conventional artificial reef systems and/or inserts, which often employ a uniform material composition, thereby limiting the range of species that can be supported. The innovation lies in the ability to create a mosaic of habitats within a single insert, thereby maximizing the ecological potential of the reef system. The varied material composition also potentially affects the local water chemistry and physical conditions, further contributing to the ecological complexity and health of the reef environment and not only enhances the structural complexity and biological diversity of the artificial reef system but also represents a more versatile and effective solution for marine conservation and reef restoration efforts. The ability to accommodate diverse marine life in a single insert structure significantly surpasses the capabilities of traditional artificial reef designs, marking a substantial improvement in the field.

The plurality of artificial reef segments also includes a plurality of openings 130 which extend through the curved frame structure from the outer curved surface to the inner curved surface. In FIGS. 1-3, the openings comprise a hexagonal cross-sectional opening and are placed adjacent to one another spanning across the whole structure creating a grid-like surface. These openings may provide new habitats and shelter for a variety of marine life, increasing the diversity of marine species in the area. The openings may also allow for water flow helping to increase the circulation of oxygen, nutrients, and other essential elements that support the growth of marine life. In the example embodiments shown, such as FIG. 1, there are three openings lined up next to one another spanning from one end of the frame structure to the other. These openings cover the whole artificial reef segment. Whereas, in other embodiments, the openings may be shaped, sized, or spaced differently. For example, in a different example embodiment, the openings may appear circular and may only be placed along the vertex of the structure. As disclosed herein, the openings are shown to have hexagonal cross-sectional opening, it may be understood that other cross-sectional shapes of the openings having more than six sides, such as heptagon, octagon, nonagon, decagon are also covered within the scope of the present invention.

The artificial reef segment, featuring a plurality of openings and/or hexagonal channels, incorporates a well-considered approach to ensure safety for both marine and human life. This approach is exemplified through the utilization of inserts, which serve to modify the openings in areas identified as higher risk.

For human safety, particularly in areas where divers and swimmers are common, the potential for entanglement is a critical concern. The reef segment addresses this by employing inserts, further detailed herein, that can either partially or fully close off these openings. The deployment of a hierarchical structure of openings, with inserts of different sizes and/or having openings of different sizes, allows for the precise adjustment of opening sizes. Some inserts are designed without openings, creating a smooth, flush surface with the segment's outer surface, effectively eliminating any gaps in areas where human interaction is likely.

Concerning marine life, particularly larger species such as juvenile turtles, manatees, and dolphins, the structure provides a safe environment. The customizable nature of the inserts ensures that while the openings are sufficiently large to allow these animals an escape route if they inadvertently swim into them, they also remain small enough to offer a haven from larger predators. This careful balancing act is essential in providing a secure habitat for diverse marine species.

The flexibility in the size and configuration of the openings, afforded by the varied inserts, allows the artificial reef segment to adapt to specific environmental and safety requirements. This feature underscores the segment's ability to offer ecological benefits while simultaneously prioritizing the safety of the marine ecosystem and its human visitors.

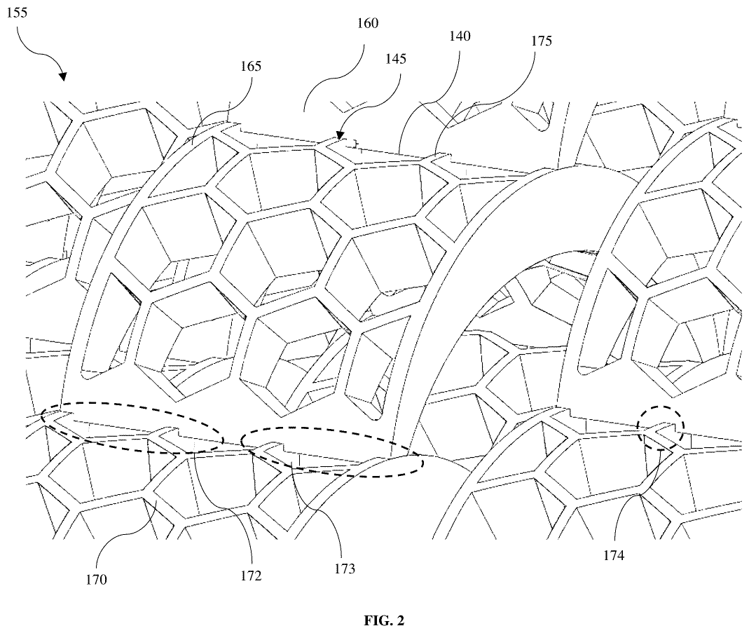

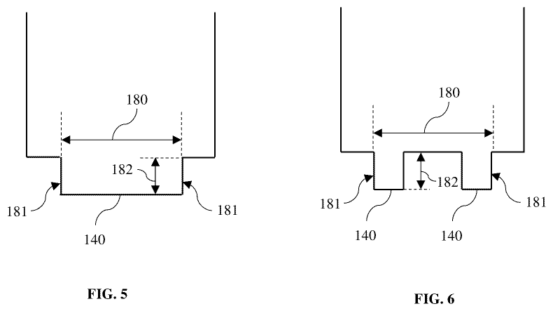

The plurality of artificial reef segments further includes a plurality of frame segments 140 where each frame segment is defined by a portion of the outer curved surface adjacent to one of the plurality of openings. The purpose of these frame segments is to function as an attaching element such that a first artificial reef segment 160 may interlock with a second artificial reef segment 165, as shown in FIG. 2. Each frame segment is sized to interlock with the openings of a second artificial reef segment. Each frame segment 140 includes a height 182 and a length 180 (as illustrated in FIGS. 5-6). The outer portions 181 (illustrated in FIGS. 5 and 6) of the frame segments are configured to fit snugly with the openings by use of force, also known as press fitting or interference fitting. As noted above, in the artificial reef configuration, the interlocking section is disposed in between two cutouts of the first artificial reef segment, and is received by the opening of the second artificial reef segment. These fittings are achieved by the normal force acting on the outer portions of the frame segments by the inner portions of the openings, and the normal force acting on the inner portions of the openings by the outer portions of the frame segments. Further embodiments are shown and described below in FIG. 5 and FIG. 6.

A frame segment, in the context of the artificial reef structure or similar construction, can be described as a fundamental component that forms part of the boundary or wall of an opening within the overall structure. Essentially, it acts as a supporting element that defines and maintains the shape and integrity of each opening.

In the structure of the artificial reef segment, each frame segment serves a dual purpose. Firstly, it contributes to the physical framework that outlines an individual opening, helping to create and maintain its specific shape, whether that be circular, hexagonal, or any other geometric form. This is crucial in determining the size and contours of the space through which water, nutrients, and smaller marine organisms can flow, as well as providing surfaces for marine life to adhere to and inhabit.

Secondly, and equally importantly, each frame segment plays a role in the overall stability and robustness of the reef segment. When multiple frame segments are combined, they form a cohesive and interconnected network that adds strength and resilience to the entire reef structure. This interconnectedness allows the structure to withstand the dynamic forces of the marine environment, such as water currents and the physical impact of marine life.

Thus, in the larger context of the artificial reef segment, frame segments are not just individual entities but integral parts of a larger, cohesive structure. They work in unison to provide both the physical form and the structural integrity necessary for the artificial reef to function effectively in its ecological role.

The plurality of artificial reef segments further includes a plurality of cutouts 145 disposed along a terminating end 150 of each artificial reef segment. The terminating end may be defined as the farthest end from the vertex of the segment. Terminating end 150 is also illustrative of the interlocking sections of the arch structure. In a symmetrical embodiment such as the example embodiments shown, there are two terminating ends. In some embodiments, such as FIG. 1, these cutouts may be sized to fit the portion of material 131 between each hexagonal cross-sectional opening such that the cutout may be inserted onto the portion of material 131 forming a snug fit, as shown by interlocking sections 172, 173 and 174 in FIG. 2. Each cutout serves as a shoulder for the interlocking section such that a portion of the terminating end of the artificial reef structure is disposed within the opening of the adjacent artificial reef structure. In other embodiments, the cutouts may be angled differently applying different pressures to the openings when in contact. It would be noted that the terms hexagonal opening and hexagonal cross-sectional opening are used interchangeably in the disclosed embodiment and refer to the openings 130.

The described cutout on the bottom portion of a reef segment is a specialized feature designed to facilitate the modular assembly of an artificial reef structure. This cutout is essentially a void or an intentionally left-out space, shaped and sized to precisely accommodate a frame segment from another reef segment. Its primary purpose is to enable the interlocking or attachment of multiple reef segments, thereby creating a larger, cohesive artificial reef structure.

The configuration of this cutout is critical for ensuring a secure and stable connection between adjoining reef segments. It must be shaped to correspond exactly to the dimensions and contours of the frame segment it is intended to receive. This precision ensures that, when a frame segment from another reef segment is inserted into the cutout, it fits snugly and securely, minimizing any movement or misalignment.

This interlocking mechanism provided by the cutout and the corresponding frame segment is a key aspect of the reef segment's design. It allows for the easy and efficient assembly of larger reef structures from individual segments. Once connected, the segments collectively contribute to the structural integrity and functional effectiveness of the overall artificial reef.

Furthermore, this design feature facilitates flexibility in the construction and layout of the reef. By enabling segments to be securely attached to one another, the overall shape and size of the artificial reef can be customized according to specific environmental needs or conservation goals. This modularity is particularly beneficial in reef restoration projects, where the artificial reef needs to adapt to varying seafloor topographies and ecological conditions.

The artificial reef segment features a curved structural design that is essential for its functional deployment in marine environments. The curvature extends from a prominently defined vertex section through to the segment's terminating ends. A key feature of this design is the variable thickness of the structure, which is not uniform throughout its length but instead designed to decrease continuously from the thicker vertex section to the thinner terminating ends. This tapering of thickness is critical for optimizing the distribution of material, enhancing the structural integrity at points of higher stress concentration near the vertex while reducing unnecessary mass towards the ends where lesser support is required.

Additionally, the segment's thickness is maintained uniformly from the front side to the back side across its entire span. This consistent lateral thickness ensures an even distribution of support and resistance against environmental forces such as waves and currents, providing stability and durability. The design facilitates not only structural robustness but also efficient stacking and storage, as the uniform lateral profile aids in aligning multiple segments compactly.

Overall, these technical features of the curved artificial reef segment—namely, the decreasing thickness from vertex to ends and the uniform lateral thickness—are deliberate to enhance the segment's environmental resilience and functional longevity. This thoughtful engineering ensures that the artificial reef can withstand the dynamic pressures of underwater environments while supporting marine life and contributing to shoreline protection.

Furthermore, in certain embodiments, the longitudinal span of each arch in the artificial reef system significantly impacts the structural integrity and performance of the reef in marine environments. The longitudinal span—the distance between the first terminating end and the second terminating end of each arch—optimizes the arch's ability to withstand oceanic forces, distribute stress, and facilitate effective wave energy management. When installed, the longitudinal span of the arch is perpendicular to the subject shoreline and/or the incoming waves. The length of the longitudinal span is crucial for distributing the forces exerted by waves and currents over a greater area as the waves roll over the arch, thereby reducing the concentration of stress at any single point along the arch. This distribution helps prevent structural failures, such as cracking or collapsing, ensuring the arch maintains its integrity over time. The effectiveness of the arch in dissipating wave energy is directly influenced by its longitudinal span. A longer span allows the arch to interact with waves over a more extended area as they propagate towards the shoreline, gradually absorbing and reducing the energy of the waves as they pass through and around the arch. This gradual dissipation of energy is essential for protecting shorelines from erosion and for reducing the power of waves before they reach sensitive coastal areas.

FIG. 2 depicts an artificial reef configuration 155. The artificial reef configuration includes a first artificial reef segment 160 arranged on top of a second artificial reef segment 165 and a third artificial reef segment 170 such that at least one interlocking section is disposed where cutouts of the first artificial reef segments receive at least one of the plurality of frame segments of the second artificial reef segments and at least one of the plurality of frame segments of the third artificial reef segment. In an example, two or more artificial reef segments may be arranged on top of a third artificial reef segment by interlocking the two artificial reef segments on the third reef segment. By having each reef segment interlock with one another, the strength and stability of the reef increases providing a safe and protected environment for marine life. Dependent on the purpose or use of the artificial reef system, the quantity of reef segments may vary. For example, if the intended use of the system is to act as a submerged breakwater, the user may require a large number of segments creating a large system of artificial reefs. If the intended use is to support marine growth in an already inhabited area, then the system may only require a few artificial reef segments. A detailed view of how these artificial reef segments interlock with one another is shown in FIG. 7.

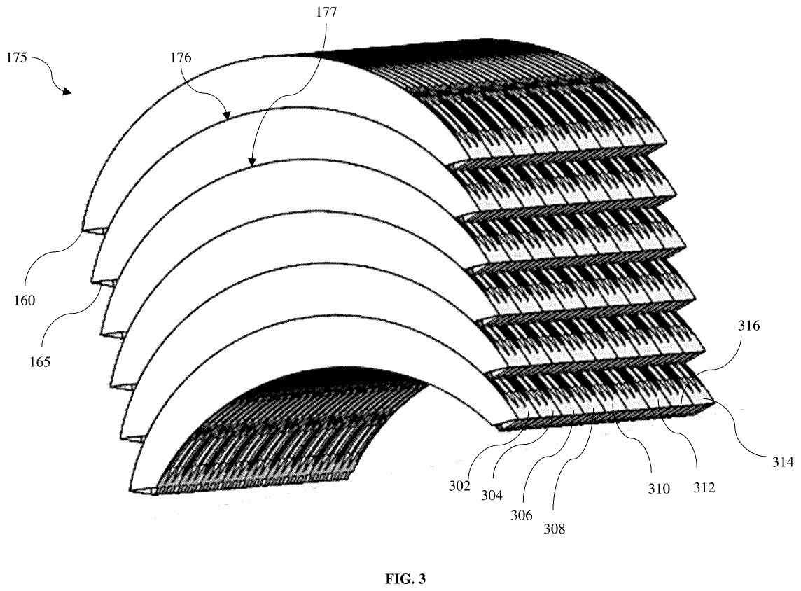

FIG. 3 depicts a transport configuration 175 having the first artificial reef segment 160 stacked on the second artificial reef segment 165 such that the first artificial reef segment's vertex section 176 is adjacent to the second artificial reef segment's vertex section 177. Further, multiple artificial reef segments may be stacked in a side by side manner as shown in FIG. 3. For example, the artificial reef segments 302, 304, 306, 308, 310, 312, 314, and 316 are stacked in the side-by-side manner for transporting. This configuration provides several benefits when transporting the artificial reef system. These benefits may include maximizing use of available space in transportation vehicles, increasing amount of cargo that may be transported in a single trip, stabilizing structure reducing risk of damage, reducing transportation costs, etc. When in transport configuration, a majority of the inner curved surface of the first artificial reef segment abuts a majority of the outer curved surface of the second artificial reef segment. In the transport configuration, the inner curved surface of the first artificial reef segment substantially abuts a majority of the outer curved surface of the second artificial reef segment, as shown in FIG. 3. In an example, the first artificial reef segment is stacked on the second artificial reef segment such that the vertex section the first artificial reef segment is adjacent to the vertex section of the second artificial reef segment. As shown in FIG. 3, in the transport configuration, a first artificial reef segment substantially abuts a majority of the outer curved surface of a second artificial reef segment.

In the stacked configuration of the artificial reef segments, the tapered nature of the segment thickness from the vertex section to the terminating ends is crucial for effective stacking. This tapering is facilitated by both the outermost and innermost curved surfaces of each segment having the same radius of curvature. The identical curvature of these surfaces allows for a precise alignment when the segments are stacked. Specifically, the inner curved surface of one segment conforms closely to the outer curved surface of another segment below it. This congruence in curvature enables the segments to fit together without gaps, optimizing space utilization and ensuring stability in the stacked arrangement. Such a configuration enhances the practical aspects of transportation and storage by minimizing the space required and improving the structural integrity of the stacked arrangement. This uniformity in curvature across the segments facilitates a more streamlined and stable assembly when constructing larger reef structures, directly impacting their performance and durability in marine settings.

In certain embodiments, small protrusions, or nubs, are strategically disposed on the top side of each arch. These nubs serve a critical function by creating uniform gaps between adjacent arches when they are stacked. This spacing prevents direct contact between the surfaces of the arches, thereby reducing the risk of abrasion or stress concentrations that could compromise the structural integrity of the arches. Additionally, these nubs help to stabilize the stacked configuration, preventing slippage and providing a more secure load during handling and transport. This thoughtful addition to the arch design enhances the practicality and safety of moving and storing large numbers of artificial reef segments, ensuring they arrive at their deployment site in optimal condition.

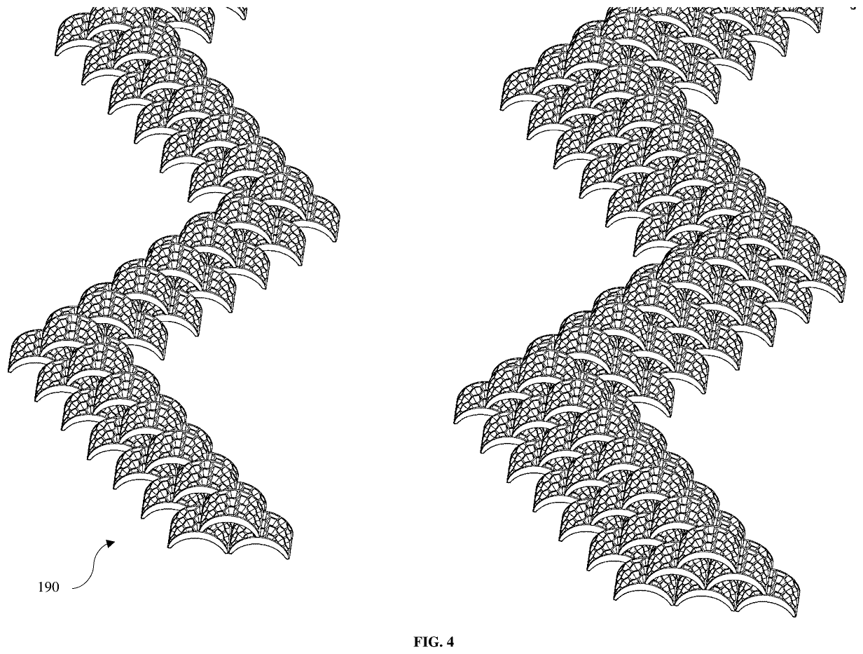

FIG. 4 depicts the artificial reef system 100 comprising a zigzag pattern 190 defined by the plurality of artificial reef segments in the artificial reef configuration. This pattern is extremely beneficial for withstanding and mitigating wave energy. Because each reef segment is connected to form an assembly, the power of a wave cannot destroy any individual arches. The wave energy is reduced as the wave moves through the assembly, but the assembly only realizes the impact of a wave a small amount at a time. Wave attenuation can help protect the shoreline from erosion and damage caused by strong waves and currents. This zigzag pattern can also improve water circulation by creating areas of eddies and turbulence. This turbulence helps to oxygenate the water and improve nutrient distribution, benefiting marine life and promoting the growth of coral and other organisms. This will promote the exchange of water between protected areas and the open ocean helping to maintain a healthy marine ecosystem. As mentioned above, this pattern requires a plurality of artificial reef segments to be connected using frame segments and openings of each artificial reef segment.

Additionally, the zigzag pattern creates more surface area compared to a linear or clustered arrangements. This increased surface area provides more attachment points for marine organisms to settle and grow, enhancing biodiversity and promoting the establishment of a thriving ecosystem. The zigzag pattern can help dissipate wave energy, reducing the impact of strong currents and waves on the reef structure. This can help protect the reef from erosion and damage, ensuring its longevity and stability. The interlocking nature of the zigzag pattern provides increased structural stability to the artificial reef. The segments reinforce each other, reducing the risk of collapse or shifting due to external forces such as currents or storms.

In the contemplated design of the artificial reef system, the strategic arrangement of reef segments in a zig-zag pattern is employed to effectively dissipate wave energy. This configuration, distinct from linear alignments, capitalizes on the angular positioning of each segment to redirect and spread the force of incoming waves across a broader area, thereby diminishing their erosive potential. The zig-zag pattern inherently increases the surface area of interaction between the structure and the water, enhancing the system's capacity to absorb and mitigate wave energy. This design consideration not only contributes to the structural integrity of the artificial reef under various oceanic conditions but also plays a significant role in coastal protection, reducing the impact of waves on shorelines. Additionally, from an ecological standpoint, the zig-zag arrangement creates a diverse range of microhabitats within the reef structure, catering to different marine species and thus augmenting the biodiversity supported by the reef. The specific angular placement of the segments within this configuration is crucial for achieving the desired balance between wave dissipation, structural stability, and ecological functionality, underscoring the innovative nature of this artificial reef system design.

FIG. 5 represents a first example embodiment of a plurality of frame segments 140 where each frame segment is rectangularly shaped having a length 180 where length 180 is measured as the distance between the outer portions 181 of a single frame segment (140). Length 180 is also equal to the inner measurement of a single opening (shown in FIG. 1). Having frame segment 140 being the same length as the inner measurement of an opening allows the frame segment to fit securely in the opening. In other embodiments, length 180 may be slightly larger than the inner measurement requiring an interference fit as mentioned above.

FIG. 6 is a second example embodiment of a plurality of frame segments 140 having different shaped frame segments. In this embodiment, the frame segments have the same length 180, measured as the distance between the outer portions 181 so that the frame segments may still fit snugly inside an opening of another artificial reef segment. In this embodiment, the frame segments have removed material from the inner portion of the frame segment leaving negative space in the rectangular segment. This example embodiment reduces the amount of material used and still allows for the interlocking of a frame segment and an opening.

In other embodiments, the frame segments may include a different fastening mechanism. For example, the outer portion 181 of the frame segments may include a ball spring plunger. Ball spring plungers work by applying controlled force and pressure in a specific direction. In this example, the ball or pressure mechanism would be applying pressure to the inside wall of the opening maintaining consistent pressure to keep the two artificial reef segments connected. In an embodiment, the two artificial reef segments may be connected via cylindrical pins that are pressed into the negative space in the rectangular segment, creating a tight and secure fit. The two artificial reef segments can be designed with interlocking tabs that fit into corresponding slots or grooves, creating a snug fit when assembled. In other embodiments, the frame segments may include a more permanent type of fastener such as screws or bolts. In some embodiments the user may prefer each artificial reef segment to be easily detachable in case of an overwhelming force applied to a group of artificial reefs segments oriented in artificial reef configuration 155, in this case the interlocking portion may not be as strong as a connection with permanent fasteners.

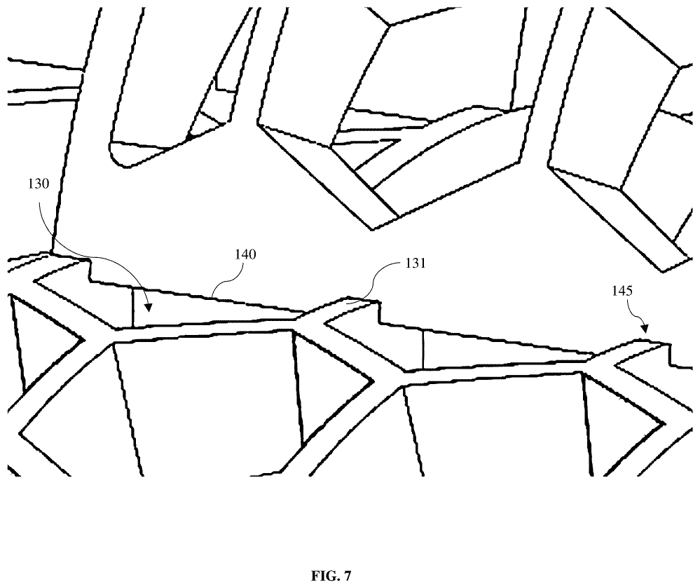

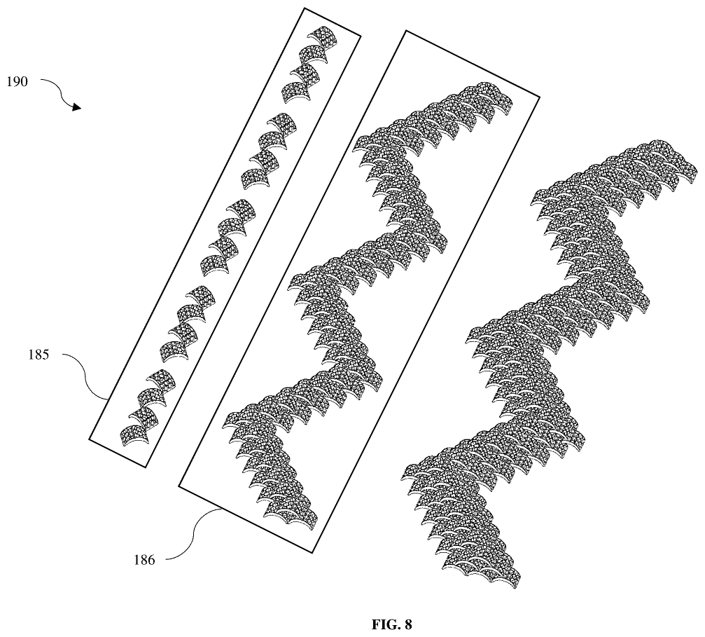

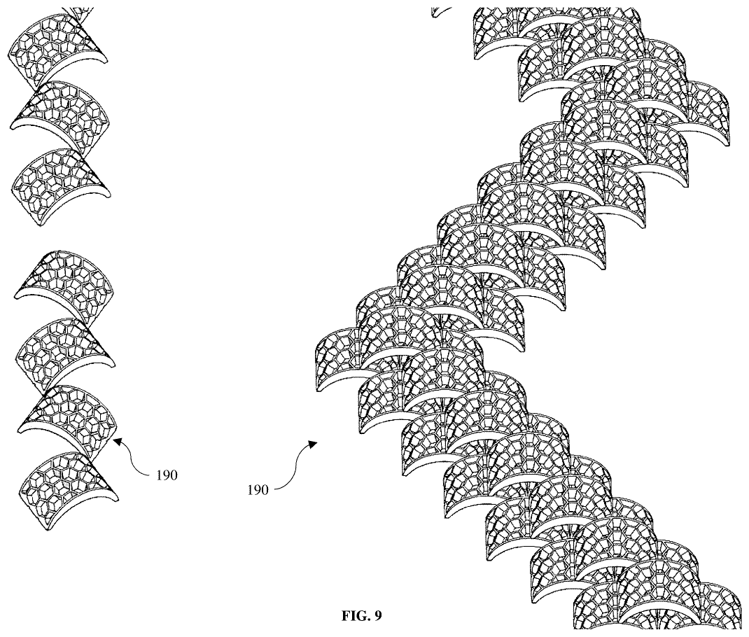

FIG. 8 and FIG. 9 depict the artificial reef system 100 comprising a zigzag pattern 190 defined by the plurality of artificial reef segments in the artificial reef configuration. As mentioned before in FIG. 4, utilizing a pattern such as zigzag significantly aides the structure when faced with great forces such as strong wave energy. As a wave approaches the artificial reef configuration in zig zag pattern, the first point of contact is the first line segments 185. These artificial reef segments will dissipate the wave energy. As the wave continues forward, it will reach the second line segments 186. The first point of contact will be the peaks of the zigzag pattern. As the wave energy is forced upon these peaks, the energy will flow through each artificial reef segment in pattern dissipating at every segment. In comparison to a linear configuration, the zigzag configuration is more effective and reliable due to its behavior as an assembly only realizing the impact of a wave a little at a time. However, other configurations or patterns may also be used with the artificial reef system and is within the spirit and the scope of the present invention.

The artificial reef system employs an interconnected arrangement of curved arch segments, each featuring end portions equipped with rods that extend through their structure. These rods facilitate robust connections between adjacent arch segments, particularly in a zigzag configuration, enhancing the structural cohesion and resilience of the entire assembly. Additionally, these rods allow for the attachment of supplementary components or accessories that may augment the ecological functionality or protective characteristics of the reef, and assist in the deployment of the arches.

In terms of dynamic stability, the design of each arch is optimized to counteract the vertical forces exerted by ocean waves. The curvature of the arches is specifically engineered to channel these forces downward, which typically promotes sediment accumulation that can bury conventional reef structures. To mitigate this, strategically placed openings within each arch feature varying arc angles that facilitate water flow through the structure. These openings are designed such that the internal geometry of the arch creates an uplift force inside the arch, countering the downward pressure of the waves and thus preventing the structure from embedding into the seabed.

The zigzag configuration of the reef system addresses lateral stability challenges posed by wave dynamics. As waves approach and interact with the shoreline, their speed and angle of approach can increase erosive forces. The staggered arrangement of the arches within the zigzag pattern effectively absorbs and dissipates these forces. Each arch in the formation is designed to confront wave energy directly at the points of peak curvature—the most structurally fortified points. This design ensures that wave energy is incrementally absorbed and weakened as it travels through the sequence of arches, significantly reducing the potential for erosion.

In the zigzag pattern, each arch is strategically placed to absorb and dissipate the lateral forces exerted by incoming waves. The positioning allows each arch to intercept waves at an angle, which helps distribute the energy of the wave along the length of the arch rather than concentrating it at a single point. This distribution is critical in reducing the sheer force impact and the subsequent movement or shifting of individual segments. Moreover, the connections between each arch-facilitated by rods that extend through the terminating ends of each segment-further reinforce the assembly against lateral movements.

In an embodiment, the artificial reef system comprises artificial reef inserts configured for being retained within the plurality of openings of the artificial reef segments. The reef inserts are specialized structures or modules designed to fit and be secured within the openings of artificial reef segments. In an example, the reef inserts may be retained by removably fitting inside the openings of the reef segments. The artificial reef inserts may be reinforced and/or further secured within the opening using adhesive to prevent uplifting of the reef inserts. The adhesives may be water resistant and corrosion resistant, such as marine epoxy resins, polyurethane marine sealants, marine silicone sealants. The openings have depth, and the reef inserts are placed within the depth of the openings.

The artificial reef inserts within the reef system are equipped with pyramidal-shaped protrusions, which serve a crucial role in protecting marine life from predators. The unique pyramidal shape of these protrusions is instrumental in deterring various predators, including different sizes of crabs, by creating a physically challenging terrain that hinders their access to smaller, vulnerable organisms. This geometric design is effective in providing a safer environment for these smaller marine species to thrive.

Additionally, the protrusions on the inserts vary in size, which is essential for supporting a hierarchical ecosystem within the insert. This variation allows for different sizes and types of marine life to find suitable habitats. Smaller protrusions offer refuge to tiny species, while the larger ones can accommodate bigger organisms, fostering a diverse and balanced marine ecosystem.

The design of the inserts also includes strategically placed openings that facilitate water flow. These openings are crucial as they allow the circulation of water through the insert, ensuring that essential nutrients and small organisms can flow through, which is vital for the sustenance and growth of marine life attached to the inserts. The water flow also helps in maintaining optimal water quality and temperature conditions around the reef structure.

Overall, the combination of the protective pyramidal protrusions, varied habitat spaces due to different protrusion sizes, and the inclusion of openings for water flow enhances the ecological functionality of the artificial reef inserts. These features collectively contribute to the effectiveness of the reef system in supporting a diverse and thriving marine ecosystem, aiding in both the restoration and conservation of reef environments.

The artificial reef inserts also play a pivotal role in facilitating coral out planting and oyster growth. The pyramidal protrusions on the inserts, varying in size, provide an ideal substrate for coral out planting. The increased surface area of the pyramidal structures having multiple wings offer multiple attachment points for young coral fragments, which is essential for their initial establishment and growth. The varied sizes and shapes of the protrusions cater to different coral species, accommodating their specific growth patterns and size requirements. This design feature ensures that a variety of coral species can be successfully out planted and nurtured on the inserts, contributing to the biodiversity and resilience of the reef system.

In addition to supporting coral growth, the artificial reef inserts are conducive to oyster colonization. Oysters require sturdy and complex surfaces for attachment, and the textured surface of the inserts, especially the pyramidal protrusions, provides an ideal environment for oyster larvae to settle and grow. The presence of oysters on these inserts is particularly beneficial as they are natural water filterers, thus contributing to the overall health of the marine ecosystem by improving water quality. The strategic placement of reef segments offshore, yet within proximity to coastal areas, is aimed at facilitating oyster recruitment. By positioning these segments in locations that are accessible to oyster larvae, yet sufficiently offshore to avoid direct human impact and coastal disturbances, the reef structure provides an optimal environment for oyster colonization and growth. The proximity to shore ensures that the segments are within the range of natural oyster larvae dispersal, which is crucial for the successful establishment and development of oyster populations. This arrangement not only contributes to the restoration and conservation of oyster habitats but also enhances the ecological benefits of the reef segments, such as water filtration and shoreline protection, provided by a thriving oyster population. The careful consideration of location in relation to oyster recruitment demonstrates a thoughtful approach to maximizing the ecological impact of the artificial reef system.

The openings in the inserts facilitate the flow of water, which is crucial for both coral and oyster development. This water flow brings in essential nutrients and oxygen, while also allowing for the passage of small organisms that form part of the food chain. For corals, the flow of water helps in the removal of waste products and delivers phytoplankton and other microscopic food sources. For oysters, the water flow ensures a steady supply of plankton, their primary food source.

Additionally, for instance, the reef inserts may be made from an environmentally friendly materials, such as textured ceramic tiles or specially designed habitat structures and are fitted into the openings of artificial reef segments to create a more intricate and habitat rich environment for marine life, including invertebrate and other lifeforms and provides protection from a plurality of predators. The structure provides hiding spots and shelters where smaller fish and invertebrates can take refuge, making it more challenging for predators to locate and capture them. The reef inserts retained within the openings of artificial reef segments operate by adding complexity and diversity to the reef structure. The additional surfaces provided by these inserts serve as attachment points for marine organisms, promoting the settlement of coral, algae, and other fauna. This, in turn, contributes to increased biodiversity and ecological functionality within the artificial reef system.

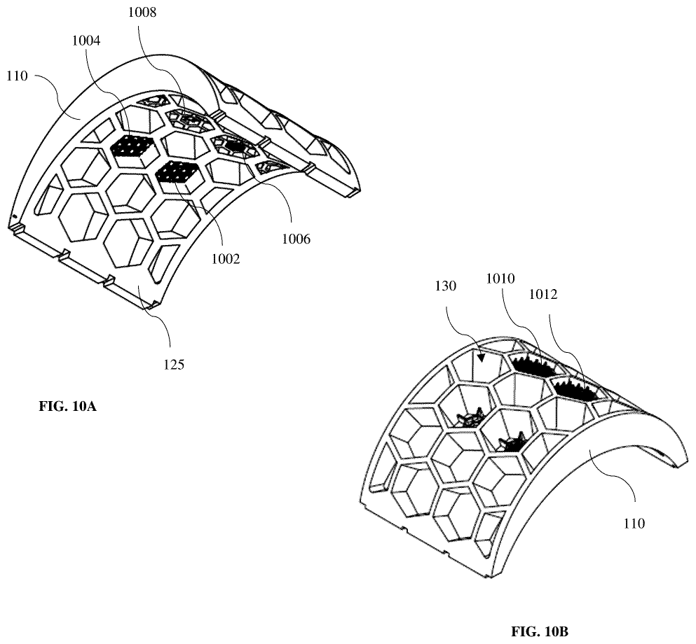

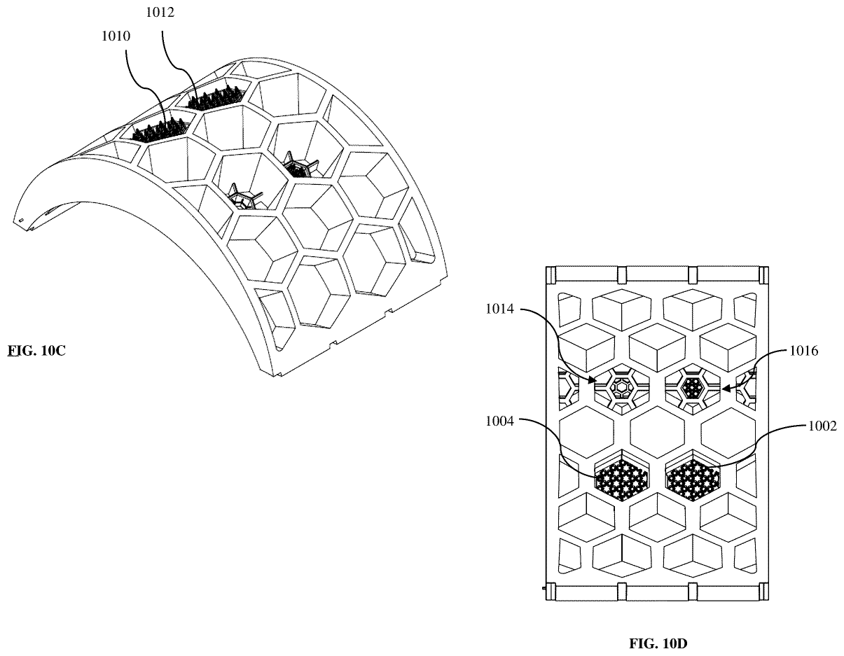

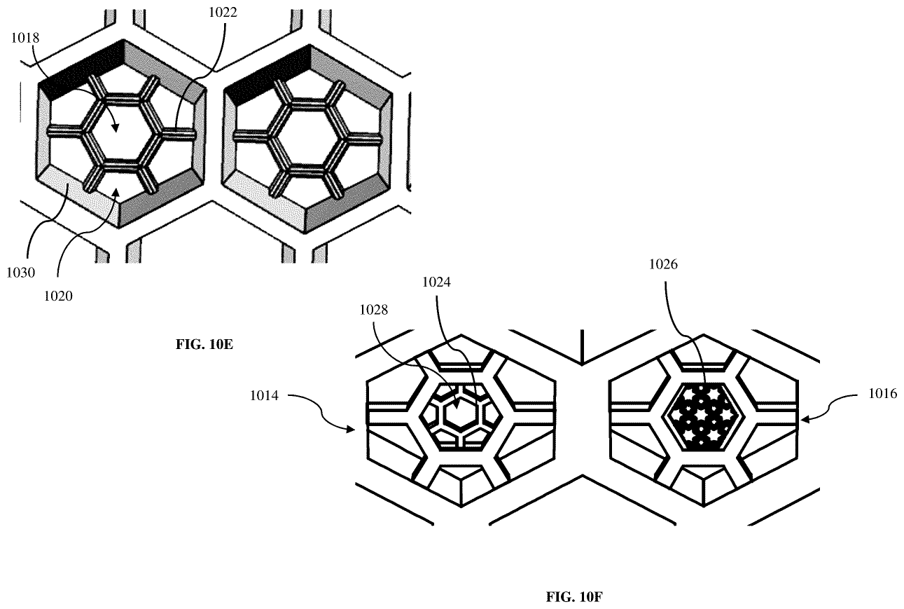

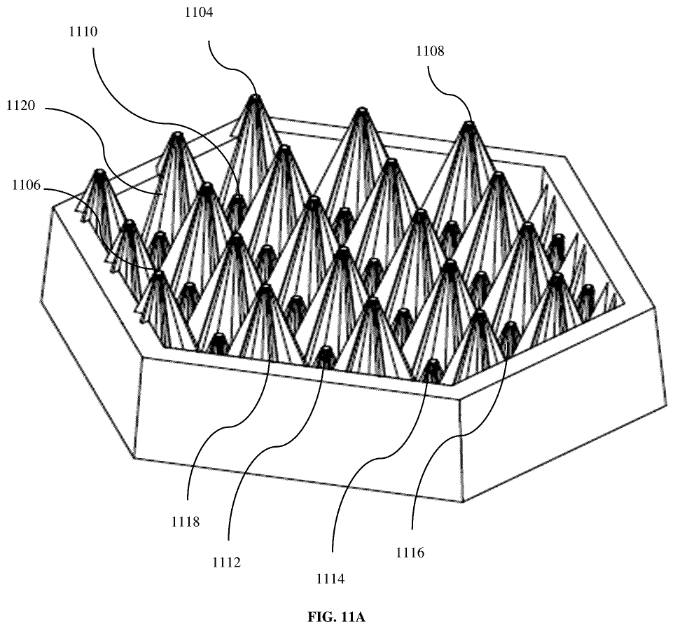

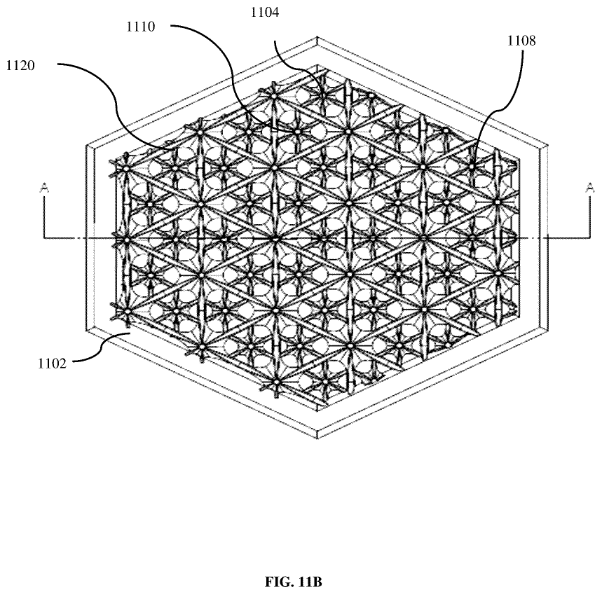

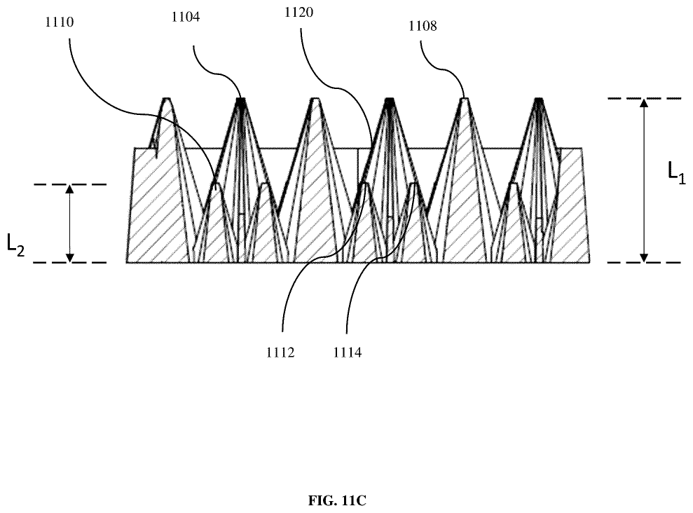

FIGS. 10A, 10B, 10C and 10D illustrate the reef inserts 1002, 1004, 1006, 1008, 1010, and 1012 are inserted withing the respective openings 130 of the artificial reef segments. As shown, the reef inserts may have different shapes, such as hierarchical webbings, star pattern, inserts with pyramidal protrusions. In the figures, the reef inserts 1002 and 1004 have star pattern, the reef inserts 1006, 1008 have hierarchical webbings, and the reef inserts 1010 and 1012 have pyramidal protrusions. In an example, the reef inserts 1002 and 1004 are the rear side of the reef inserts 1010 and 1012. The pyramidal protrusions have structures that extend from the base of the reef insert towards the opening of the reef insert partially along the depth of the opening and have substantially pyramidal shape, as shown with reference to FIGS. 11A, 11B, 11C, 11D and 11E. Each of the reef inserts have a base structure 1102 and pyramidal structures that protrude from the base structure having a first side and a second side. The objective of such a structure is to provide more surface area and a denser structure for the marine organisms to attach and grow. In an example, the base structure is configured for providing water flow from the first side of the base structure to the second side of the base structure.

FIG. 11B shows a top schematic view of an insert with pyramidal protrusions. The pyramidal protrusions also have wing structures that protrude from these pyramid protrusions to provide a complex dense structure having an increased surface area of the pyramidal protrusions. As shown, the reef insert has the base structure 1102 on which the pyramidal structures are set, also referred to as the first side of the reef insert. The pyramidal protrusions have substantially pyramidal shape as noted above. FIG. 11C illustrates a sectional view of the insert with pyramidal protrusions along a plane AA shown in FIG. 11B. The reef insert has a plurality of first elongated protrusions extending upward from the first side of the base structure, wherein each of a plurality of first elongated protrusions define a first length L1, and a plurality of second elongated protrusions extending upward from the first side of the base, wherein each of a plurality of second elongated protrusions define a second length L2, wherein the second length is less than the first length. Further, the reef insert has an apex defining by a terminating end of each of the plurality of first protrusions and second protrusions and at least one wing extending along each of the plurality of first protrusions and second protrusions.

As shown, the reef insert has apex 1104 for each of the pyramidal protrusions, first protrusions 1106, 1108 and second protrusions 1110, 1112, 1114 and 1116, and wings 1118, 1120 on the pyramidal protrusions. Each of the first and second protrusions have a substantially pyramidal shape. In an example, one pyramidal protrusion can have two or more wings. The first protrusions 1108 extend upward from a first side of the base structure, and each first protrusion has a first length L1 as shown in FIG. 11C. The second protrusions 1110, 1112, 1114 and 1116 extend upwards from the first side of the base, and each second protrusion define a second length L2, and the second length L2 is less than the first length L1. The apex is defined by a terminating end of each of the first protrusions and the second protrusions. The wing extends along the lengths of each of the first protrusions and the second protrusions from the apex to the base portion. These wings on the same protrusion are separated by a distance and provide additional surface area of the reef inserts in the artificial reef segments for the organisms to attach and grow. The wings contribute to habitat complexity and provide extra barrier for protection from predators and contributes in providing a water barrier, breakwater, and artificial habitation. The wings contribute to coral out planting, as noted above. The concept of habitat complexity refers to the variety in the arrangement of physical structures and features within an environment that contains a diverse range of elements. These elements include shelters, substrates, vegetation, and various physical structures, all of which contribute to creating a three-dimensional and intricate living space. This complexity is essential for providing different niches and resources that support a diverse array of species, fostering rich biodiversity and ecological interactions within the habitat. Such habitat complexity enhances the overall biodiversity and ecological dynamics of a particular habitat. As disclosed herein there are two types of protrusions such as the first protrusions and the second protrusions, it is understood that the design and structure of the insert more have more protrusions of a length other than L1 and L2 to have a denser and complex layout and provide more surface area.

FIG. 11D is the bottom view of the reef insert shown in FIG. 11A. The reef insert has the base 1122 also referred to as the second side and a number of openings distributed across the surface of the reef insert, such as the openings 1124, 1126, and 1128. In another embodiment, the reef insert of FIG. 11A has a different design of the base, as shown in the bottom view of the insert in FIG. 11E. The holes 1125 correspond to the apex of the first protrusions, the holes 1127 correspond to the apex of the second protrusions and the holes 1129 illustrate the wings of the first protrusions from bottom view.

The artificial reef system is designed with versatility in mind, allowing for different configurations of its components to suit varying ecological and structural needs. In one embodiment, the insert is a separate, removable segment that can be precisely positioned within the overall reef structure. This removable design offers flexibility, enabling adjustments or replacements of the insert as required by environmental conditions or specific conservation goals. It allows for easy maintenance and adaptation of the reef structure to evolving marine life needs.

In other embodiments, the reef segment may be manufactured with an insert already embedded within an opening. In this design, the insert and the surrounding reef structure form a uniform, homogenous entity. This can be achieved through a molding process, where both the insert and the reef segment are cast together, resulting in a seamless integration of the two components. This unified structure offers enhanced stability and durability, as there are no separate parts that could potentially shift or detach under marine conditions. The homogenous design also ensures a consistent texture and surface across the entire reef segment, which can be beneficial for certain types of marine life that require uniform habitats. Such a manufacturing approach simplifies the installation process and ensures a cohesive structure that is well-suited for long-term ecological support and marine habitat creation.

As shown in FIGS. 10C and 10D, the openings 130 can have different types of reef inserts within the openings of an artificial reef segment. For example, the openings may have three-dimensional web-like structure 1014 and 1016 and star pattern reef inserts 1002 and 1004 within the openings of the same artificial reef segment. FIG. 10E illustrates a top view of the reef inserts having three-dimensional web-like structure. A three-dimensional web-like structure refers to an arrangement where multiple interconnected frame segments come together to form a complex network of openings. These openings can vary in size and shape, creating a hierarchical structure of spaces. The interconnected nature of the frame segments means that each segment contributes to the overall stability and shape of the entire structure, much like the strands of a spider's web interlace to form a cohesive whole.

In this context, the term ‘three-dimensional’ emphasizes that the structure extends in all spatial directions-length, width, and height-rather than being flat or two-dimensional. This quality allows for a more intricate and spatially complex design, offering a greater variety of niches and habitats, particularly useful in applications like artificial reefs or architectural designs where spatial complexity is desirable.

The hierarchical nature of the openings in this structure refers to the varying sizes of the spaces created by the frame segments. This can mean larger openings are supported by broader frame segments, while smaller, more intricate openings are formed by finer interconnections. Such a design allows for a wide range of uses and can cater to different requirements, whether they be for specific species in an ecological context or particular functional needs in architectural or engineering projects.

The three-dimensional web-like structure is configured for providing a complex spatial arrangement for enhancing habitat complexity and water flow. The complex spatial arrangement enhances overall biodiversity and ecological dynamics of a particular habitat. In an embodiment, the three-dimensional web-like structure comprises a base structure having a first side and a second side, plurality of secondary openings being of a smaller size than the plurality of openings of the artificial reef segment. The secondary openings are configured for providing water flow from a first side of the base structure to a second side of the base structure. As shown, the openings 1018, and 1020 represent the secondary openings that are smaller than the size of the opening 130 of the artificial reef segment. The structure has arms 1022, also referred to as a frame segment, that are in contact with the inner wall 1024 of the opening.

In another embodiment, as shown in FIG. 10F, the reef inserts may define a pattern within the structure, such as the three-dimensional web-like structure 1016 defined inside the secondary opening 1018 of the three-dimensional web-like structure 1014, and a star pattern of the reef insert 1026 define within the secondary opening 1018 of the three-dimensional web-like structure 1016. Such a structure defines a plurality of tertiary openings, such as the opening 1028 of the three-dimensional web-like structure 1016 or the openings in the star pattern of the reef insert 1026, within the secondary opening 1018 of the plurality of openings thereby creating a hierarchical openings within the artificial reef insert and is also referred to as hierarchical webbings. In an example, the secondary openings are smaller than the plurality of openings and larger than the tertiary openings. The hierarchical openings are uniform and have secondary openings and tertiary openings provide additional support and reinforcement to the secondary openings of reef inserts. This helps to maintain the structural integrity of the reef and prevents collapse or shifting of materials over time. The structure increases the complexity of the habitat. This allows for a greater variety of microhabitats and niches, attracting a wider range of marine organisms. Such reef structures provides a substrate for the attachment of marine organisms such as corals, sponges, and algae. This promotes the colonization of the reef by a diverse array of species, leading to increased biodiversity and ecological productivity and creates sheltered areas within the reef, providing protection for juvenile fish and other small marine organisms. This helps to support the growth and survival of young organisms, contributing to the overall health of the ecosystem.

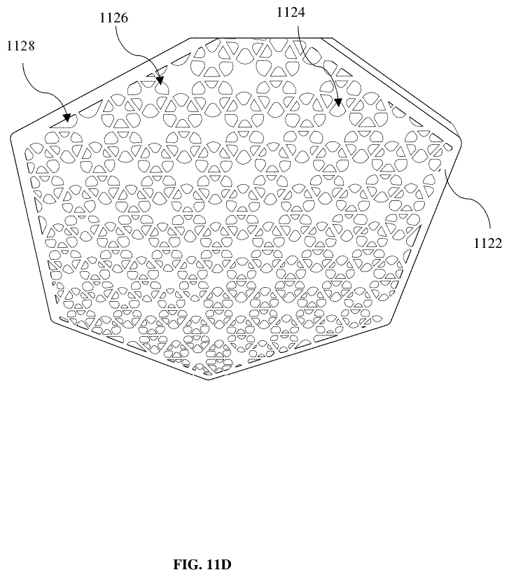

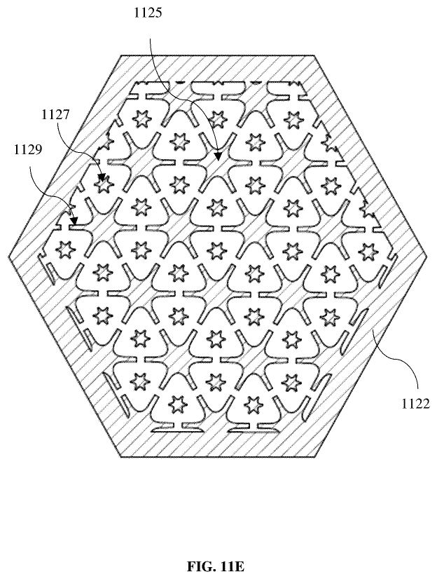

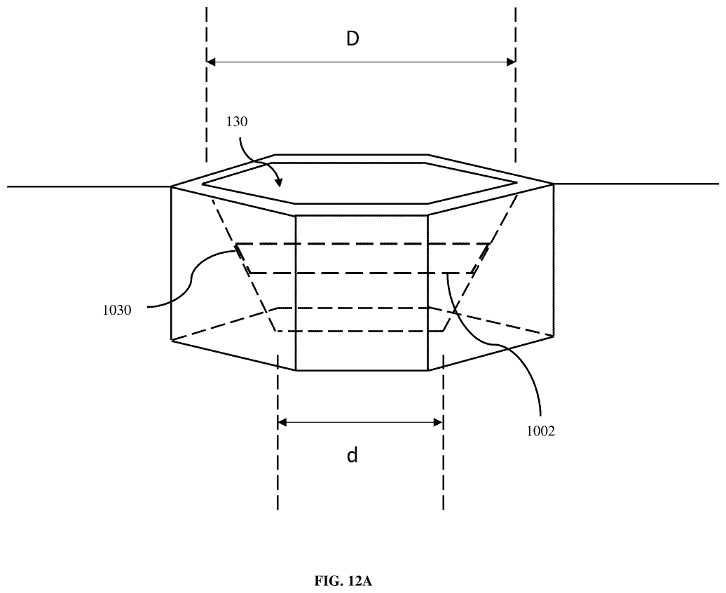

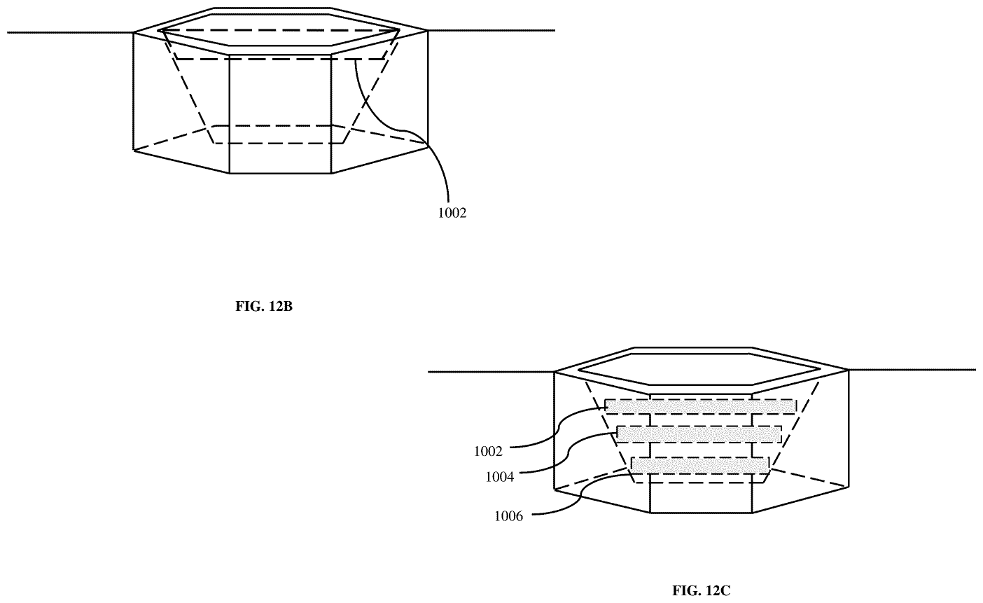

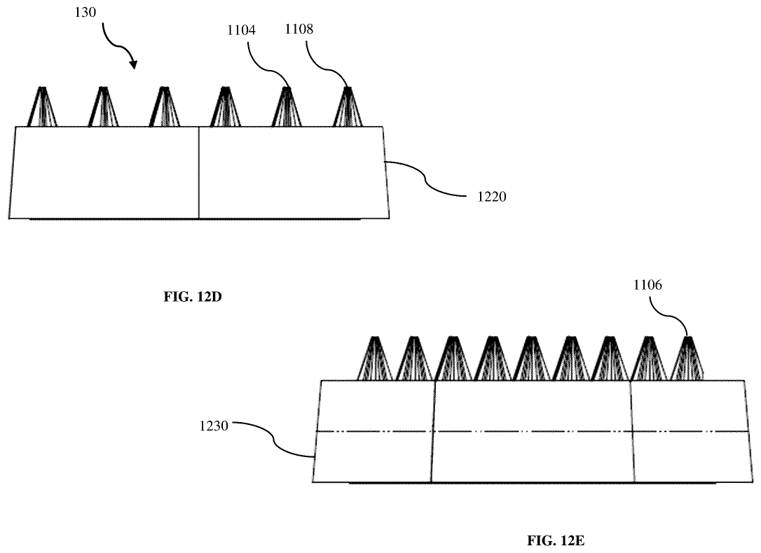

FIGS. 12A, 12B are schematic sectional views of the openings 130 of the artificial reef segment. In an example, the opening 130 has a tapered structure having inner wall 1030 of the opening gradually narrow or converge toward the back of the opening defines a channel. The openings are to receive and attach reef inserts, such as the reef insert 1002 within the channel. In one embodiment, the reef inserts may be press-fitted into the channel to snugly fit into the reef segments. The reef inserts may have friction fit inserts and the reef inserts are designed to fit tightly into the openings through friction, creating a secure and stable attachment without additional fasteners. In other embodiment, the reef inserts have features that interlock with corresponding structures inside the opening, providing a strong and stable connection, such as a puzzle-piece-like structures on the inserts that fit into complementary cutouts within the opening. In another example, the reef inserts may have be coupled to the walls of the openings based on a stop mechanism, such as threaded components that can be screwed or twisted into matching threads within the opening or any other mechanical fasteners such as bolts, nuts or pins. In another embodiment, the reef inserts have components designed to snap securely into place within the opening or have magnetic attachment, providing a quick and reliable attachment. The reef inserts may have snap-fit tabs or hooks on the inserts that latch onto corresponding features inside the opening. In certain examples, the reef inserts may be inserted using pressure fit, or sliding track or rail mechanism. As noted above, the reef inserts are secured within the opening using marine-friendly adhesives, bonding the insert to the reef structure. This may include epoxy, marine sealants, or other adhesive materials applied to the contact surfaces of the reef insert and the opening.

As shown, the separation between opposite walls or the diameter at the back or lowest point is d and the distance between the opposite walls near the front side of the opening is D. The diameter D is proximate to where the opening meets the outer curved surface of the artificial reef segment and is referred to as the first diameter. The first diameter D is proximate to where the opening meets the inner curved surface of the artificial reef segment and is referred to as the second diameter herein. In an example, due to the tapered design, the distance between the opposite walls at the front of the opening gradually reduces towards the back of the opening. The first diameter D is greater than the second diameter d of the opening.

The artificial reef segment, featuring hexagonal-shaped openings, leverages this geometric configuration to enhance its structural integrity. The hexagonal shape is known for its efficiency in distributing stress and strain across the structure, a principle widely observed in nature and engineering. In the context of the artificial reef, these hexagonal openings contribute to a more uniform distribution of mechanical forces exerted by water currents and waves. This uniform stress distribution is crucial for maintaining the segment's stability and durability under various marine conditions.

When these hexagonal openings are tapered, with a design that narrows from the outermost surface to the inner surface, this feature further reinforces the structural aspect of the reef segment. The tapering creates a channel-like effect, which not only contributes to the overall strength of the structure but also enhances its ability to withstand the dynamic marine environment. The tapered design aids in reducing the direct impact of forces, such as strong underwater currents and wave action, by channeling and dissipating these forces more effectively throughout the structure.

Additionally, the hexagonal arrangement and the tapered channels play a significant role in breaking up wave energy. When waves encounter the artificial reef segment, the hexagonal and tapered structure disrupts the wave's energy, causing it to be diffused and dissipated over a larger area. This is particularly important for the protection of marine life and the conservation of reefs and living shorelines. By reducing the power and impact of waves, the artificial reef provides a calmer and more stable environment for marine organisms, including corals and fish. This stability is essential for their growth and survival, as excessive wave force can cause physical damage to delicate marine species and disrupt their natural habitats.

Furthermore, the reduction in wave energy contributes to the preservation of existing natural reefs and living shorelines. By acting as a buffer, the artificial reef segment mitigates coastal erosion and protects the shoreline from the damaging effects of strong waves and storm surges. This is vital for maintaining the integrity of coastal ecosystems and for the long-term sustainability of the shorelines that are crucial for both ecological balance and human activities.

Additionally, the tapered channel design within the artificial reef segment plays a crucial role in the efficient fitting and retention of multiple inserts. The channels, which narrow from the outermost surface towards the inner surface, create a conical shape that is ideally suited for holding the inserts snugly in place. This tapering ensures that as an insert is positioned within the channel, it fits more tightly and securely the further it is inserted, providing a stable and secure fit. The incorporation of multiple inserts stacked within a tapered channel presents a unique structural feature. This configuration allows for the sequential placement of inserts, each conforming to the tapering geometry of the channel, thereby ensuring a secure and precise fit. The layered arrangement of these inserts within the channel is critical for several reasons.

Firstly, this stacking technique provides enhanced habitat complexity within the reef segment. Different layers can be tailored with varying characteristics, such as surface texture or material composition, to suit diverse marine species and ecological needs. This multifaceted approach to habitat creation offers a significant improvement in fostering biodiversity compared to more uniform, single-layer designs.

Additionally, the capacity to stack multiple inserts in a tapered channel allows for greater customization and adaptability of the reef segment. Depending on the specific environmental requirements or conservation objectives, inserts can be selectively added, removed, or replaced, affording a high degree of flexibility in the configuration of the reef structure.

Furthermore, from a structural standpoint, the snug fitting of inserts within the tapered channel contributes to the overall stability and durability of the reef segment. The tapered design ensures that each successive insert is firmly secured, enhancing the segment's ability to withstand marine environmental forces such as currents and wave action.

The design of these tapered channels simplifies the process of installing the inserts. The wider opening at the outermost surface allows for easy initial placement of the inserts, while the narrowing channel naturally guides and positions the insert as it is pushed inward. This feature is particularly beneficial in ensuring that the inserts are correctly and securely positioned within the reef structure, minimizing the risk of misalignment or displacement under marine conditions.

Furthermore, the snug fit provided by the tapered channels is essential for the long-term stability of the inserts within the artificial reef segment. Once in place, the inserts are less likely to move or dislodge, even in the presence of strong currents or wave action. This stability is vital for the overall effectiveness of the reef system, ensuring that the inserts remain in their intended positions to provide continuous ecological benefits, such as supporting coral growth and offering protection to marine life.

The reef insert may be positioned at different heights within the opening based on the diameter of the reef inserts. The diameter of the reef inserts are also referred to as a third diameter. In certain embodiments, the third diameter is sized to fit within a channel defined by a tapered portion of the first opening such that the artificial reef insert is retained within the channel. For example the reef insert may be positioned in the middle of the opening as depicted in FIG. 12A. In another embodiment, as shown in FIG. 12B, the reef insert may be positioned towards the top of the opening closer to the front end of the opening to create a flush surface. The reef insert in such a configuration aligns seamlessly with the surrounding structure, resulting in a smooth and level surface. The flush surface encourages a smoother flow of water over the reef structure and minimizes drag and water turbulence over the reef structure. This reduces stress on the artificial reef in dynamic marine environments, promoting stability and longevity. The smooth and flush surface provides an ideal substrate for encrusting organisms, such as corals, sponges, and algae. These organisms can attach and grow across the surface, contributing to the development of a diverse and thriving ecosystem.

In another embodiment, FIGS. 12D and 12E illustrate the side views of the artificial reef segment having the reef insert, such as the insert with pyramidal protrusions, when the reef insert is placed towards the top of the opening 130. As shown, the protrusions 1104, 1108 extend out from the opening 130 in FIG. 12D from a portion 1220 of the artificial reef segment in a side sectional view. FIG. 12E shows the protrusions, for instance protrusion 1106 extending out of the opening 130 from the portion 1230 of the artificial reef segment. Such protrusions extending out the opening can mimic natural features, such as rocks or coral branches, creating a more complex and habitat-rich environment within the artificial reef. This complexity attracts a greater diversity of marine life, including fish, invertebrates, and algae. The protrusions create additional shelter spaces for fish and other marine organisms. These features may serve as ideal locations for fish to seek refuge from predators or as spawning sites, contributing to the reproductive success of certain marine species.

In another embodiment, two or three reef inserts may be disposed within the same opening at a distance from each other. FIG. 12C shows three reef inserts 1002, 1006 and 1008 positioned within the same opening for increased surface area and density of structure provided for marine organisms to attach and grow. The two or three inserts can be of the same type or can be of different types depending on the surface area and the density of structure required. For example, the top two reef inserts can be three-dimensional web like structures and the third reef insert may be pyramidal protrusion. The two or three inserts in one opening allows for efficient use of space within the artificial reef segment and enhance the resilience of the artificial reef to disturbances. If one insert is damaged or dislodged, the other two inserts may continue to provide habitat and support the ecosystem. In another example, the reef inserts may have structure having a base with no openings and are used as fillers. When disposed within the opening 130, the reef inserts close the opening 130 of the artificial reef segment.

FIG. 12F shows the interlocking portions 1202 and 1204 where one reef segment 1206 is affixed with another reef segment 1208. For ease of explanation, a hexagonal structure 1210 of the reef segment 1208 is illustrated. As noted above, the frame segment 1206 is sized to interlock with the openings of the artificial reef segment 1208, with reference to FIGS. 5 and 6. Each frame segment includes a height 182 and a length 180. The outer portions 181 (illustrated in FIGS. 5, 6 and 12F) of the frame segments are configured to fit snugly with the openings by use of force, also known as press fitting or interference fitting. The artificial reef segments includes a plurality of cutouts 145 disposed along the terminating end 150 of each artificial reef segment. The cutouts are designed and sized to fit the portion 1212 between each hexagonal opening such that the cutout may be inserted onto the portion 1212 forming a snug fit. In some embodiments, the cutouts may be angled differently applying different pressures to the openings when in contact. The precise fit of the cutouts ensures a snug connection, reducing the risk of movement caused by water currents or external forces. Such interlocking allows stacking of reef segments on top of each other and attaching in a side by side manner. The connected segments distribute loads and stresses more uniformly, making the artificial reef less susceptible to breakage or failure. The interlocking design simplifies the installation process. Aligning and connecting the reef segments becomes more straightforward compared to other connection methods.

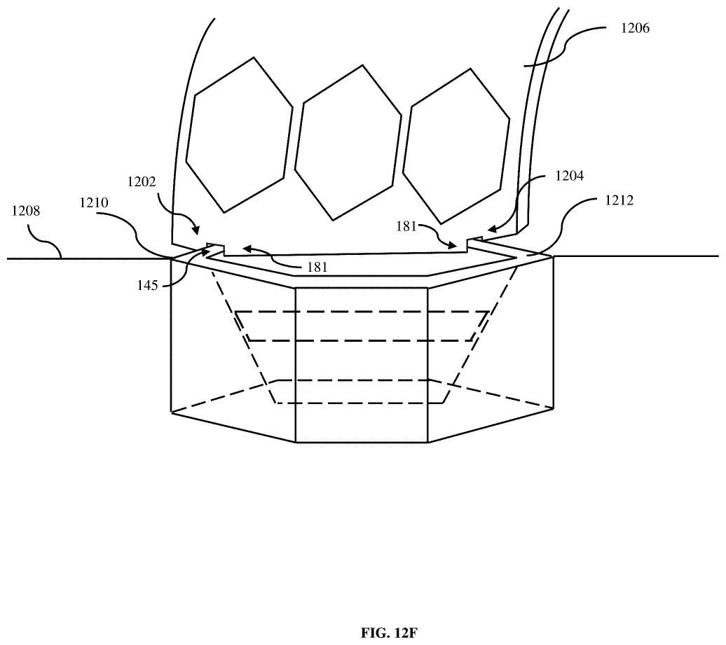

As noted above, the reef inserts may have same shape as the openings of the artificial reef segment. For instance, the artificial reef insert comprises an insert perimeter designed to correspond with the opening perimeter of the opening such that the shape and structure of the perimeter of the reef insert matches with the perimeter of the opening. The reef inserts engage with the plurality of openings of the artificial reef segment, where the artificial reef insert of the plurality of artificial reef inserts is disposed within a first opening of the plurality of openings. The artificial reef insert comprises an insert perimeter designed to correspond with an opening perimeter of the first opening at the outer curved surface of the artificial reef segment such that the at least one artificial reef insert is securely fit within the first opening. As noted above, the reef inserts have a third diameter sized to fit within a channel defined by a tapered portion of the first opening such that the artificial reef insert is retained within the channel. For example, the reef inserts 1002, 1004, 1006 and 1008 have a hexagonal shape to be disposed within the hexagonal opening of the reef segment. In this configuration, each outer side of the reef insert abuts an inner wall of the opening, such that each inner wall of the opening is in contact with a portion of the reef insert. In other embodiments, the reef inserts may have a different shape and the outer sides of the reef insert may contact fewer inner walls of the openings. For example, in FIG. 13A, the reef insert 1302 has a rectangular shape and abuts four inner walls of the hexagonal opening instead of six inner walls. FIG. 13B shows a star shaped reef insert 1310 that abuts the vertex points (corners) of the inner walls of the opening. The gaps 1304 may allow passage of water and reduce water or current pressure on the reef inserts to maintain a uniform flow of water. The reef inserts also has holes 1306 uniformly distributed across the surface of the reef inserts.

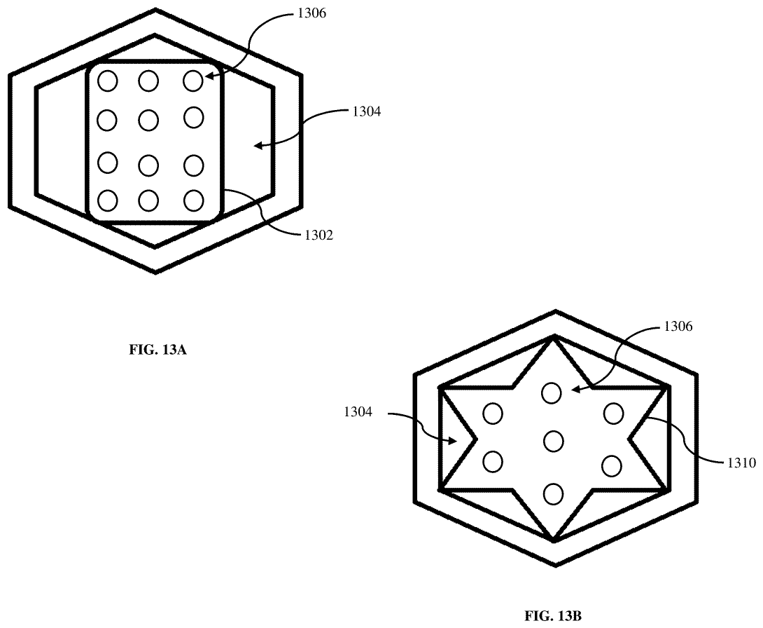

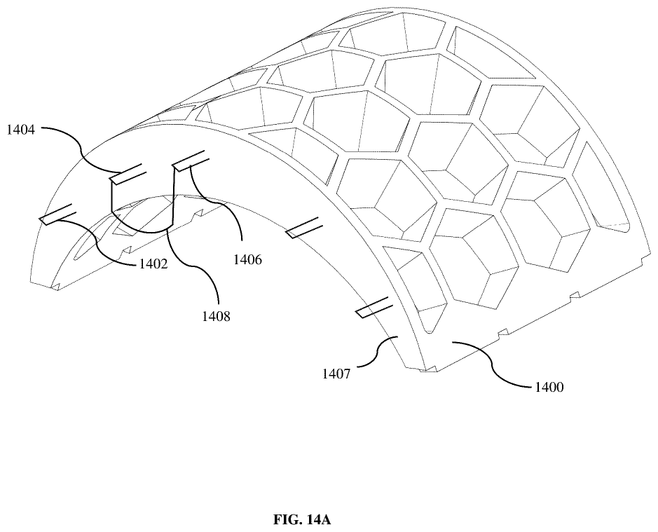

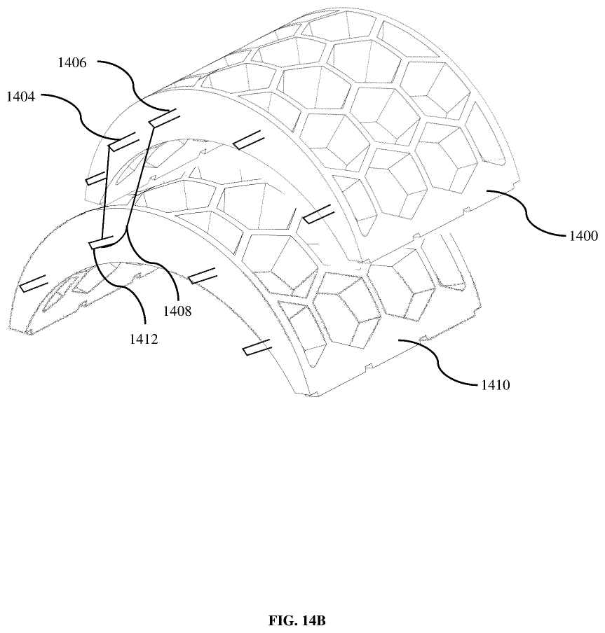

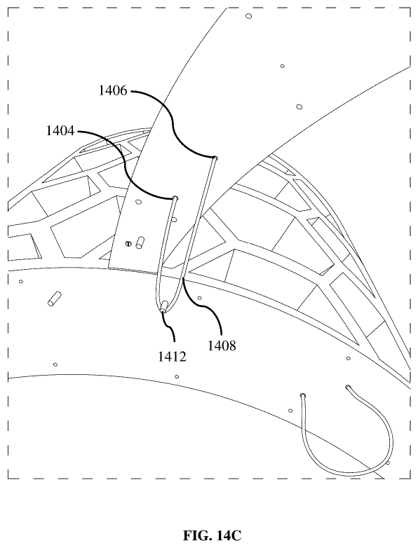

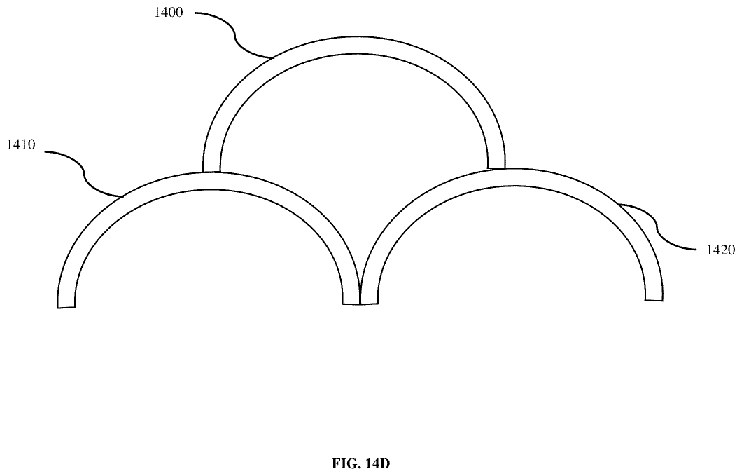

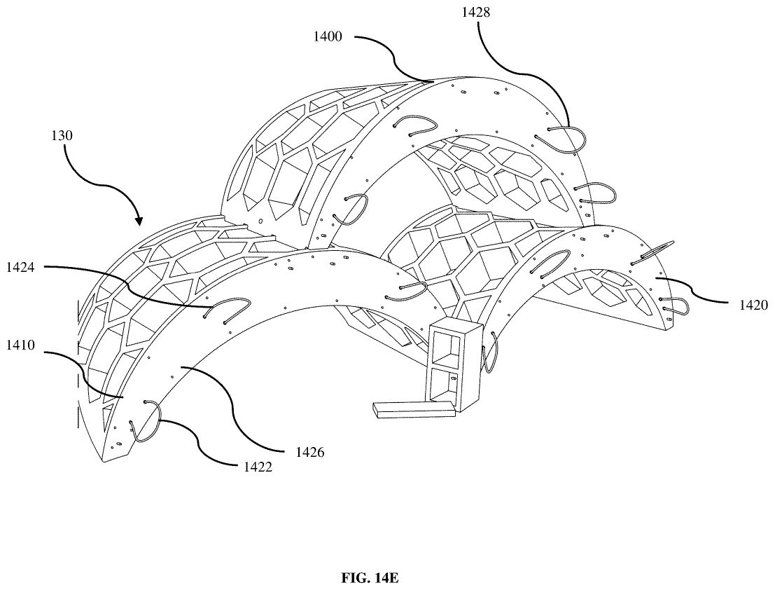

FIG. 14A illustrates a side view of the artificial reef segment 1400 having steel attachments, such as rods protruding out from side surface of the artificial reef segments. As shown, the rods 1402, 1404, 1406, partly extend from the side face 1407 of the reef segment. As illustrated, there are five rods extending from the side face, it is understood that there may be number of rods greater than five or fewer than five covered within the scope of the invention. In an embodiment, these rods may extend across the width of the artificial reef segment and partly protrude from the other side face opposite to the side face 1407 of the artificial reef segment. The structure and shape of the rods may be rectangular or tubular, and may be angled downwards to provide an improved coupling with other artificial reef segments. In an example, the rods are made of material, such as stainless steel that is an alloy composed of iron, chromium, nickel, and other elements, and is corrosion-resistant due which protects it from rusting. Stainless steel is durable, strong, and resistant to both corrosion and staining. Other materials used for the rods may be galvanized steel coating with a layer of zinc. The rods may also be coated using epoxy coatings or polymer coatings on the steel. The material selected for the rods are rust-resistant for longevity and structural integrity of the artificial reef segments. Rusting compromises the aesthetic appeal of the reef and also leads to the formation of cracks, which affects the overall stability of the structure. The rods that partly protrude out from the side face provide an attachment point for lifting and transporting the reef segments during and after installation of the artificial reef segments. The steel structures aid in securing the reef segments to other reef segments for a particular configuration of a reef structure using the metal wires.

The reef segment 1400 also has a metal wire 1408 coupled to the rods 1404 and 1406. The metal wire 1408 is used for attaching with rods of another reef segment, such as 1420 placed beneath the reef segment 1400, as shown in FIG. 14B and FIG. 14C. In such configuration, metal wires are employed as connectors to physically link the two reef segments. The wires are typically wrapped around the rods or protrusions extending from each reef segment, creating a secure connection. The metal wires may also be used for connecting two reef segments positioned adjacent or side-by-side to each other. As shown in FIGS. 14B and 14C, the metal wire 1408 is wrapped around the rod 1412 of the reef segment 1410.

FIGS. 14D, 14E, 14F and 14G illustrate a configuration having one artificial reef segment 1400 placed on top of two adjacent reef segments 1410 and 1420 in a pyramid structure. In such configuration, the three artificial reef segments may be coupled with the metal wires with each other. FIG. 14E shows the artificial reef segment 1410 having metal wires 1422 and 1424 extending out from the side face 1426 and the artificial reef segment 1400 having the metal wire 1428 that extends out of the side face of the artificial reef segment. As shown, there may be multiple metal wires on the side face extending out from the side face of the reef segments. The metal wires have a loop structure that facilitates coupling with rods of other reef segments. There may be other configurations of combining the three reef segments covered within the scope of the invention. Further, the configuration of three artificial reef segments may be positioned close to each other in a zig-zag pattern as shown in FIGS. 4, 8 and 9 to create the reef structure.

In an embodiment, the artificial reef segments have large openings to accommodate and support root growths of mangrove trees or other coastal trees. Openings in the reef structures may be sized and spaced to allow mangrove tree seedlings or mangrove roots to grow through. The hexagonal pattern can accommodate the natural growth patterns of mangrove roots, providing a supportive structure.

Further, in the application of the artificial reef segment as a part of a living reef, particularly in coastal environments, the openings plays a crucial role in supporting the growth and development of tree roots, such as those of mangroves. These roots, known for their ability to stabilize shorelines and provide habitats for various marine species, find an advantageous environment in and around the reef segment's structure.

The openings in the reef segment allow mangrove roots to grow through and around them, effectively intertwining with the structure. This interaction between the biological and artificial components serves multiple ecological and structural functions. Firstly, as the mangrove roots grow and extend through the openings, they become entangled with the reef segment, creating a natural binding effect. This entanglement not only stabilizes the mangroves themselves, anchoring them firmly in place, but also reinforces the structural integrity of the reef segment. Over time, as the roots thicken and expand, they form a robust network that further secures the reef segment against shifting or erosion.

Moreover, the integration of mangrove roots within the reef segment contributes to the reinforcement of the shoreline. Mangroves are renowned for their shoreline stabilization properties, as their complex root systems reduce wave energy and prevent soil erosion. By providing a substrate for these roots to latch onto and grow, the artificial reef segment enhances these natural shoreline protection capabilities. The roots, in conjunction with the reef structure, form a barrier that absorbs and dissipates wave energy, protecting the shore from erosion and storm surges. The openings may also be used for soil collection and for stabilizing soil for accretion and retention of coastal water soil. The hexagonal openings in the artificial reef structures can be designed to create pockets or chambers that allow sediments to settle. The spaces in between the inner walls of the openings accumulate fine particles for soil collection. The disclosed artificial reef segments integrate with mangroves for reducing soil erosion and contributes to broader coastal protection. The disclosed artificial reef segments have geometric and hydrodynamic properties for mitigating coastal erosion.

In addition to structural benefits, the mingling of mangrove roots with the artificial reef segment creates a unique and biodiverse habitat. The spaces within and around the roots become home to various marine organisms, including fish, crustaceans, and mollusks. This habitat complexity, resulting from the combination of artificial and natural structures, supports a rich array of marine life, contributing to the overall ecological health of the coastal area.

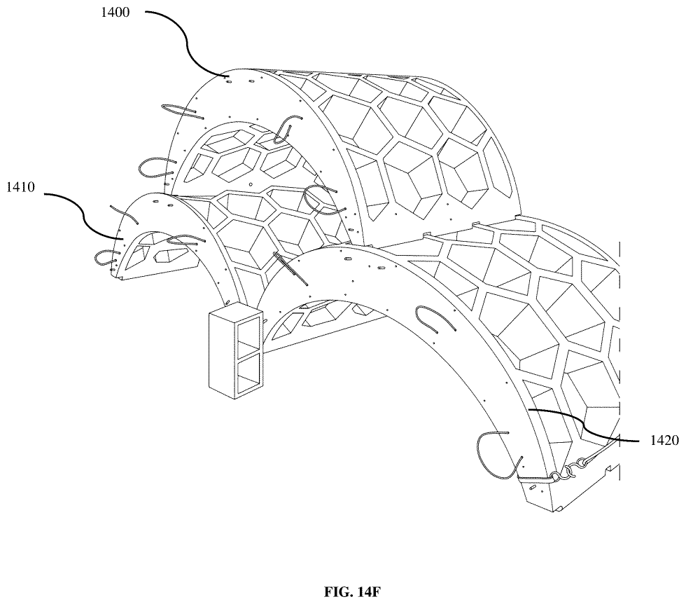

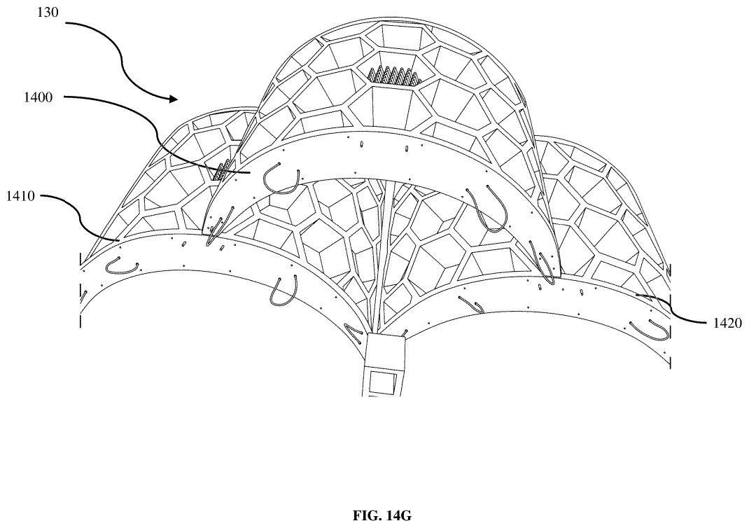

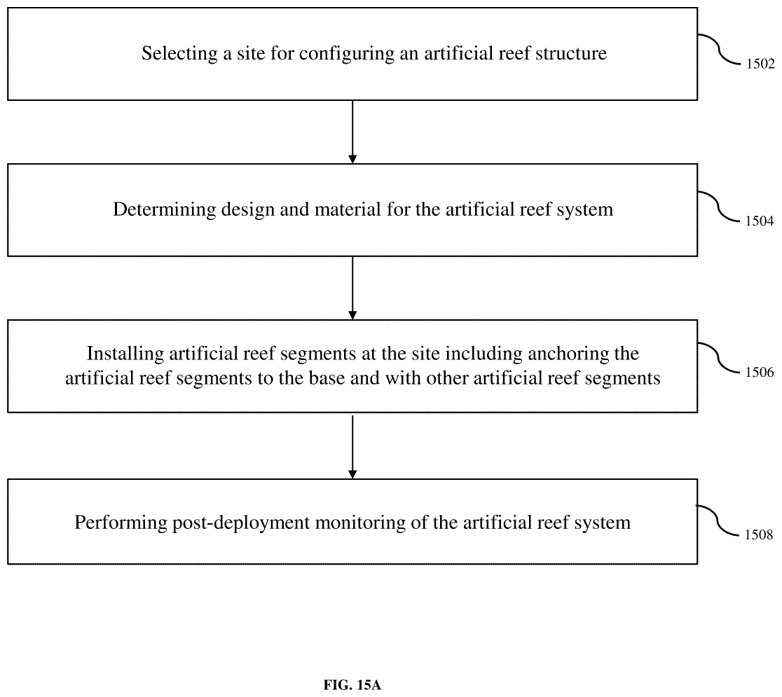

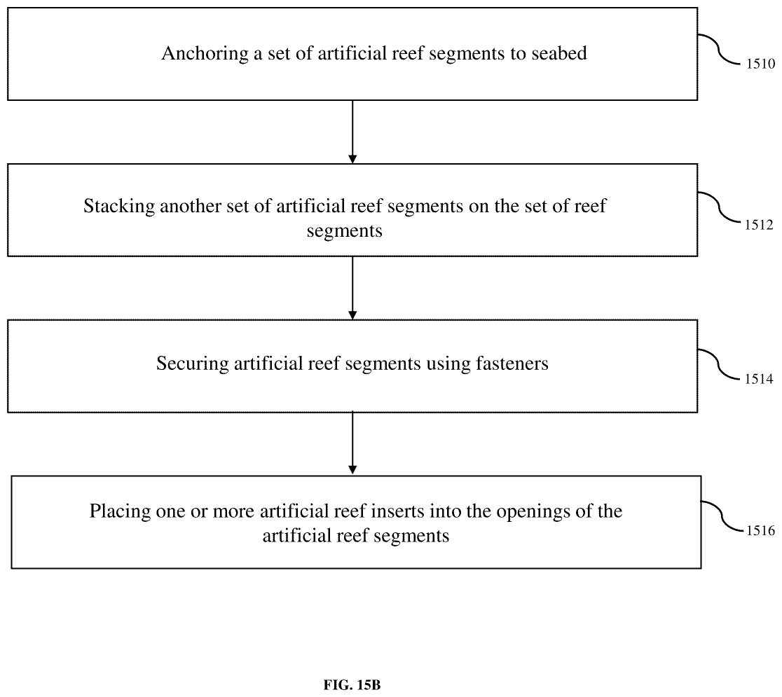

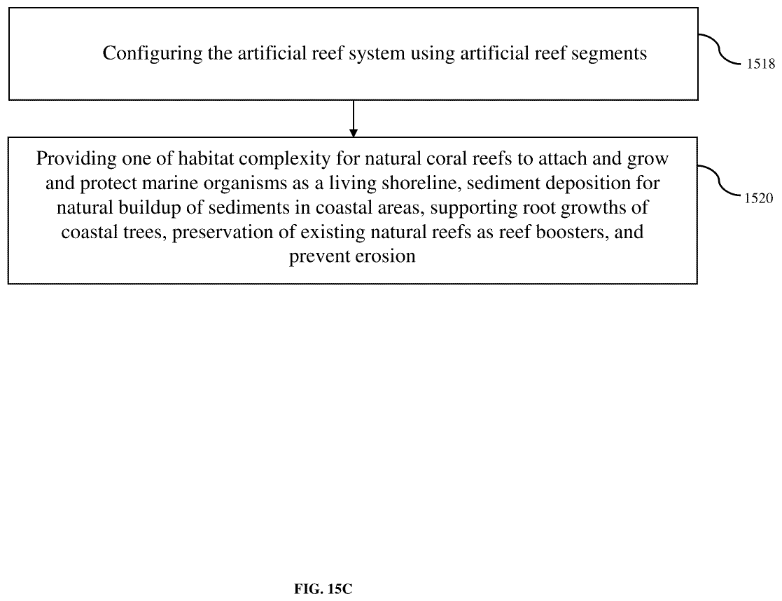

FIGS. 15A, 15B and 15C illustrate block diagrams of configuring artificial reef segments for stabilizing soil for accretion and retention of coastal water soil and for providing a water barrier, breakwater, and artificial habitation for marine life. In step 1502, a site for installation of the artificial reef system is selected. Multiple factors, such as water depth, substrate type, current patterns, and proximity to existing ecosystems at a coastal area may be considered. This may include conducting a thorough research and assessment of the chosen site, including ecological surveys, sediment analysis, and consideration of local marine life. In step 1504, a design and material of the artificial reef system may be determined. The material used for the artificial reef system may be reinforced, or have other materials embedded within or combinations of materials that are durable, non-toxic, and environmentally friendly. Examples of such material may include, concrete reinforced with fibers such as glass, polypropylene, or steel, Stainless Steel Structures, Fiber-Reinforced Polymers (FRP), Reinforced Plastics, and reinforced marine-grade concrete, Metal Matrix Composites (MMCs). In some embodiments, the homogenous curved frame structure may be created from materials such as concrete, limestone, metal, rock, organic materials such as bamboo, artificial reef modules, etc. and has a uniform structure. The design must ensure stability, durability, and resilience against environmental forces, such as currents, waves, and storms. A structurally sound artificial reef is more likely to persist over time, providing long-term benefits to marine ecosystems. The design should allow for adaptability, considering that environmental conditions and ecological dynamics may change over time. This flexibility can enhance the long-term success of the artificial reef. If the artificial reef project is part of a broader conservation or restoration initiative, the design should be scalable to accommodate larger-scale deployments if needed. In an embodiment, the design and structure of the artificial reef segment is a curved structure that provides adaptability and scalability.

In step 1506, artificial reef segments are installed at the site including anchoring the artificial reef segments to the seabed. FIG. 15B illustrate the block diagram for installing the artificial reef segments. In step 1510, the reef segments are anchored to the seabed. This may include transporting the artificial reef segments to the site using cranes or other lifting equipment. Installing a first set of artificial reef segments on the seabed in a specific pattern or design, such as a zig zag pattern. The anchoring may include attaching the structure to the substrate or using additional weights to prevent movement of the first set of artificial reef segments. Stacking a second set of artificial reef segments on the first set in step 1512, wherein the stacking would involve positioning two or more artificial reef segments sidewise on a common artificial reef segment in a pyramidal manner. Each frame segment of the second set is sized to interlock with the openings of the artificial reef segment of the first set. The artificial reef segments have interlocking sections disposed in between two cutouts of a first artificial reef segment, and is received by the opening of a second artificial reef segment. These fittings are achieved by the normal force acting on the outer portions of the frame segments by the inner portions of the openings, and the normal force acting on the inner portions of the openings by the outer portions of the frame segments. This interlocking mechanism provided by the cutout and the corresponding frame segment is a key aspect of the reef segment's design. It allows for the easy and efficient assembly of larger reef structures from individual segments and in an assembled state, the segments collectively contribute to the structural integrity and functional effectiveness of the overall artificial reef. In step 1514, the artificial reef segments are secured to each other. For example, the artificial reef segment of the second set is secured to the artificial reef segment beneath via metal wires as shown in FIGS. 14B and 14C.

The method of installing the artificial reef structure may also include placing artificial reef inserts within the openings of the artificial reef segments in step 1516. The reef inserts may be retained by removably fitting inside the openings of the reef segments and further secured within the opening using adhesive to prevent uplifting of the reef inserts. The adhesives may be water resistant and corrosion resistant, such as marine epoxy resins, polyurethane marine sealants, marine silicone sealants. In an example, the first reef insert may be positioned on top of a second reef insert with a spacing in between the reef inserts. The placing of two or more reef inserts provide more surface area and a denser structure for the marine organisms to attach and grow. These inserts have openings that facilitate water flow that are crucial as they allow the circulation of water through the insert, ensuring that essential nutrients and small organisms can flow through, which is vital for the sustenance and growth of marine life attached to the inserts. In addition to supporting coral growth, the artificial reef inserts are conducive to oyster colonization. As noted above, Oysters require sturdy and complex surfaces for attachment, and the textured surface of the inserts, especially the pyramidal protrusions, provides an ideal environment for oyster larvae to settle and grow. The presence of oysters on these inserts is particularly beneficial as they are natural water filterers, thus contributing to the overall health of the marine ecosystem.

Referring to FIG. 15A, in step 1508, a post-deployment monitoring of the artificial reef system may be performed. Post-deployment monitoring of an artificial reef system is a critical phase in assessing the success and effectiveness of the structure. This monitoring helps evaluate whether the artificial reef is achieving its intended goals, such as enhancing marine biodiversity, supporting fisheries, or providing recreational opportunities. The monitoring may include examining the condition of the artificial reef structures to ensure they remain stable and intact. This may involve underwater inspections using remotely operated vehicles (ROVs) or divers deployment plan to stack the reef segments in the desired configuration. This may also involve assessing effects of currents and waves on the artificial reef structures, as these can influence their stability and the distribution of marine organisms. One of the goals is to enhance fisheries or specific marine organisms, such as oysters by conducting surveys to assess the abundance, size, and diversity of target fish species or marine organisms.

FIG. 15C illustrates configuring the artificial reef system using artificial reef segments in step 1518. After configuration, the artificial reef system provides one of habitat complexity for natural coral reefs to attach and grow and protect marine organisms as a living shoreline, sediment deposition for natural buildup of sediments in coastal areas, supporting root growths of coastal trees, preservation of existing natural reefs as reef boosters, and prevent erosion in step 1520. The artificial reef system provides shelter, substrates, and various physical structures for habitat complexity and natural coral reefs to attach and grow to boost marine life, and protect marine organisms as a living shoreline. These structures attract fish, invertebrates, and other organisms, such as oysters contributing to a more diverse and resilient ecosystem. The openings in the artificial reef segments may provide new habitats and shelter for a variety of marine life, increasing the diversity of marine species in the area. The openings may also allow for water flow helping to increase the circulation of oxygen, nutrients, and other essential elements that support the growth of marine life. The artificial reef inserts of the artificial reef segments provide hiding spots and shelters where smaller fish and invertebrates can take refuge, making it more challenging for predators to locate and capture them, working as a living shoreline. Such reef structures provide a substrate for the attachment of marine organisms such as corals, sponges, and algae that promotes colonization of the reef by a diverse array of species, leading to increased biodiversity and ecological productivity for habitat complexity and boost marine life.

The configured reef artificial system facilitates sediment deposition for natural buildup of sediments in coastal areas to prevent erosion. The reef segments hold sediment on beaches by trapping the sediment within the openings of the segments. Such an approach not only prevents erosion but also maintains, or even enhances, the natural ecosystem functions and biodiversity. The openings of the disclosed artificial reef segments accommodate the natural growth patterns of roots of mangrove trees or other coastal trees, providing a supportive structure. The disclosed artificial reef segments provide protection to roots of coastal trees against erosion and physical disturbances. Artificial reef systems can serve as effective tools for the preservation and enhancement of existing natural reefs as reef boosters. Artificial reefs can serve as submerged breakwaters, reducing the energy of incoming waves. This attenuates wave action, protecting natural reefs from the damaging effects of excessive wave energy, such as erosion and physical breakage. By strategically placing artificial reef structures, the artificial reef system influence the flow of water currents. This can help divert strong currents away from vulnerable natural reefs, preventing sedimentation and potential damage to coral structures. Further, in cases where natural reefs are threatened by invasive species or diseases, artificial reefs can act as a form of quarantine or control. By strategically placing barriers, artificial reefs may prevent the spread of harmful agents to natural reef ecosystems.

In summary, the design of the artificial reef segment, with its strategically placed openings, is highly effective in facilitating the growth and integration of mangrove roots and other coastal trees. This interaction not only enhances the structural stability of both the mangroves and the reef segment but also reinforces the shoreline and creates a diverse and thriving marine ecosystem.

Moreso, the artificial reef segments may force waves to deposit their energy offshore rather than directly on the coastline, and in another scenario, the reef segments may hold sediment on beaches by trapping the sediment. In addition, the disclosed artificial reef segments contribute to carbon sequestration. Coastal ecosystems that include mangrove, salt marsh, seagrass, algal beds, and phytoplankton are identified as potential carbon sinks. The artificial reef segments increase biomass at artificial reefs and provide a form of blue carbon storage that actively captures and stores carbon dioxide (CO2) from the atmosphere and simultaneously serves as habitats for marine life. The artificial reef segments provide a water barrier, breakwater, and artificial habitation for marine life.

The disclosed embodiments have steel attachments such as rods protruding out from side surface of the artificial reef segments that facilitate in lifting and transportation of the reef segments during and after installation of the artificial reef segments. The steel structures aid in securing the reef segments to other reef segments for a particular configuration of a reef structure.

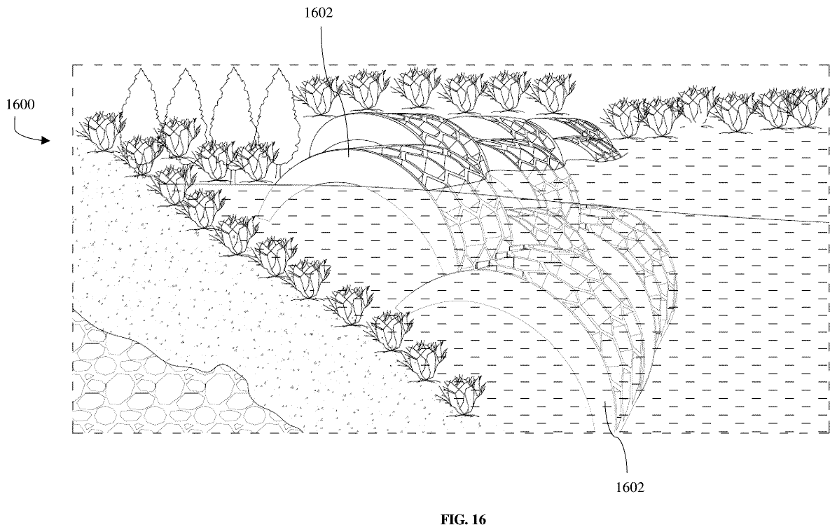

FIGS. 16 through 20B and 23A through 23D illustrate the system 1600 for the deployment, assembly, and stabilization of modular ecological structures 1602 in aquatic environments, according to an example embodiment. The system includes a plurality of modular ecological structures, each characterized by a specific surface area to weight ratio optimized for environmental efficiency and structural compatibility with aquatic ecosystems. The modular ecological structures include integrated load distribution nubs 1604 for efficient stacking and deployment. Each ecological structure includes a threaded rod 1606 disposed at a lower terminating end portion 1608 of the ecological structure. The threaded rod spans a width of the ecological structure and extends outwards from a plurality of side walls. Each ecological structure further includes a plurality of fasteners 1610 on a side wall of the ecological structure. Fasteners 1610 are a looped cable extending from each of the first side wall and the second side wall. The threaded rod 1606 and the fasteners 1610, or looped cables, are configured for securing the ecological structure to a second ecological structure and for attaching subsequent mechanical attachments for deployment and transportation of the ecological structure. These fasteners provide additional points for securing either mechanical attachments or connecting with other modules. This feature allows for the flexible expansion and reconfiguration of the overall structure, offering a significant improvement over traditional fixed-form aquatic installations which do not allow for easy adjustment or expansion once deployed. The threaded rod and fasteners are specifically designed to enable secure interconnections between separate structures and to attach additional mechanical aids necessary for the deployment and transportation of these structures. The threaded rod is strategically placed at a lower terminating end portion 1608 of each ecological structure. It spans the width of the structure, extending outward from the side walls, creating a robust anchoring system. This rod is threaded along its length, allowing fasteners to be screwed onto it at various points, which facilitates adjustable and secure connections. In operation, the threaded rod serves as a fundamental anchor within each ecological structure, enabling it to be securely joined to an adjacent structure. Each ecological structure has a section of all thread ran through it from side to side for reinforcement and attachment to the adjacent arch. This is done with a piece of drilled fiber-reinforced polymer or stainless-steel cable.

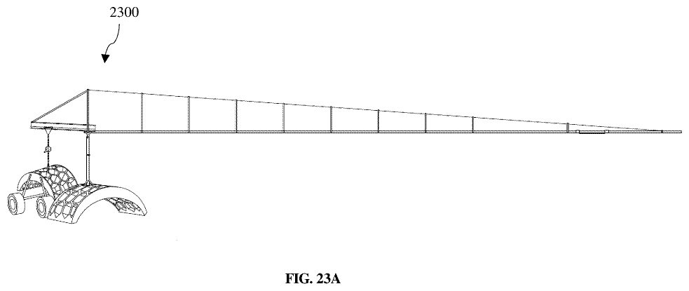

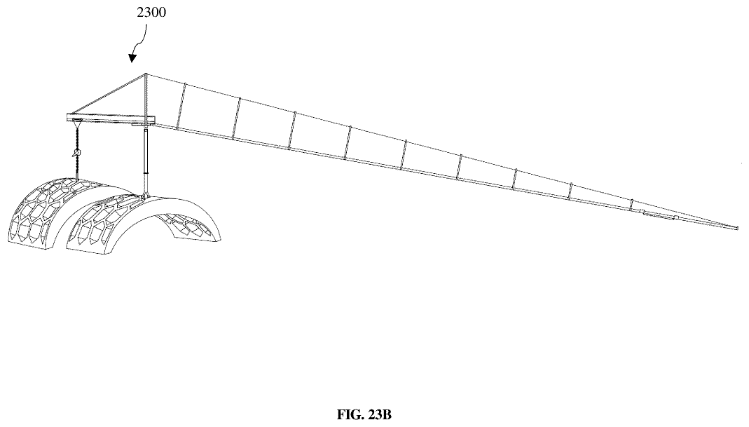

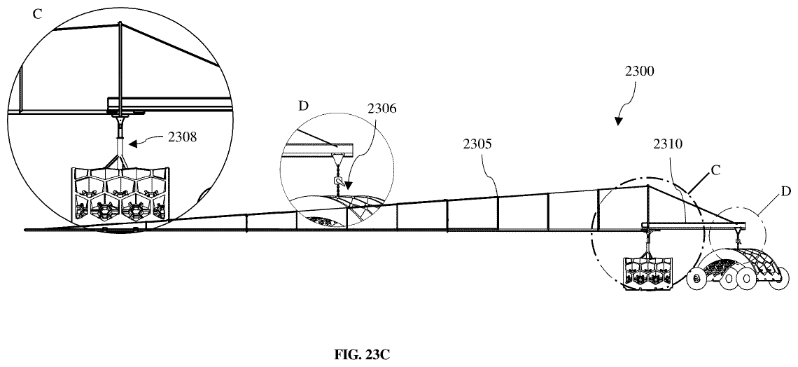

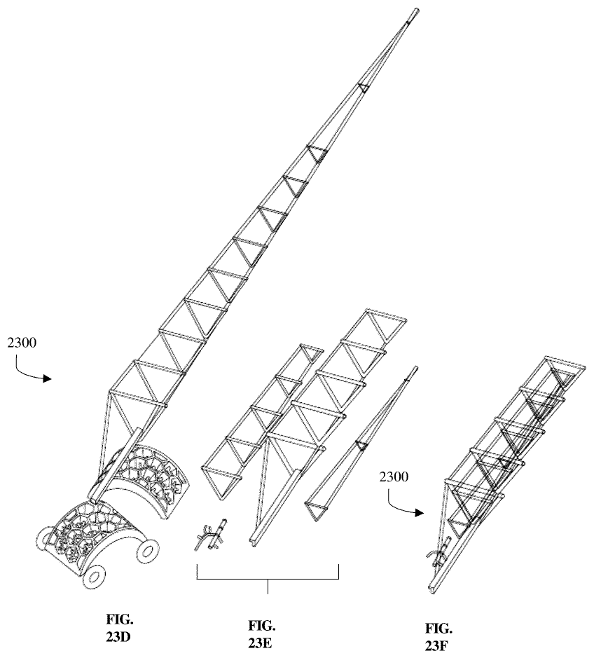

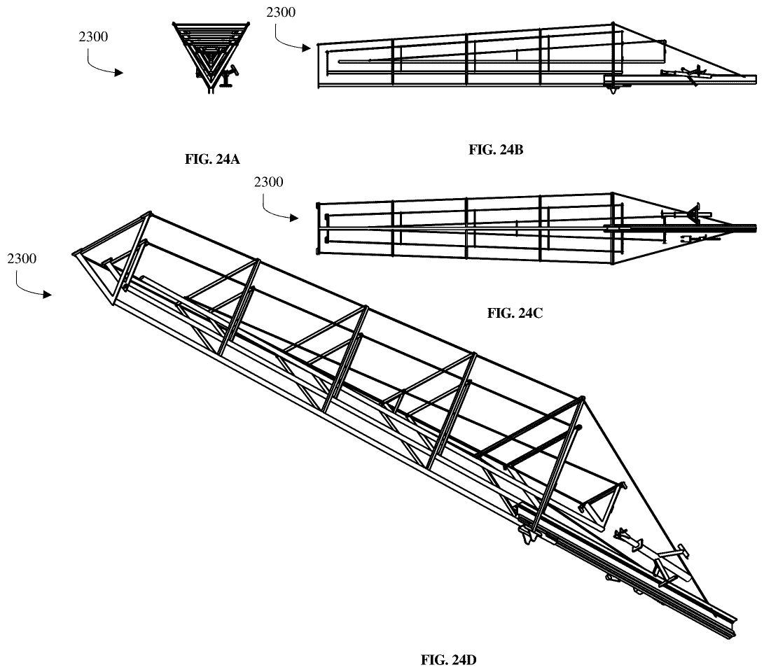

The system further includes an adjustable buoyancy control mechanism 1612 configured to attach to each modular ecological structures, designed to adjust the buoyancy for controlled descent and precise placement within aquatic environments, further facilitating the gentle harvesting and relocation of coral heads for ecological rehabilitation purposes. The system further includes a precision deployment apparatus 2300, shown in FIGS. 23A through 24D, including a pivoting cantilever 2305 with an integrated I-beam trolley system 2310, enabling the accurate positioning of modular ecological structures by allowing for controlled lowering, pivoting, and positioning without compromising the attachment integrity of the structures or a seabed. The pivoting cantilever is modular such that it comprises a hierarchy of nesting sections that can be quickly assembled and disassembled via interlocking segments. The system further includes a low-profile hoisting system designed to engage with the load distribution nubs on the modular ecological structures, facilitating the tight, efficient stacking and lifting of the structures, particularly when stored in close proximity, thereby enhancing the system's utility in constrained storage and deployment scenarios. The system includes a fabric foundation module deployable beneath the modular ecological structures to prevent excessive settling in low-capacity soils, thereby ensuring the long-term stability and integrity of the deployed structures within diverse soil conditions. The system includes a low profile attachment plate configured to slide between adjacent ecological arches in a stacked or transport configuration for providing an attachment point within an opening of the ecological structure for hoisting said ecological structure.

The modular ecological structures are individual units that can be assembled together to form larger structures. These units are designed to be modular, meaning they can be easily configured in various arrangements to suit different environmental needs and spatial constraints. Each ecological structure is characterized by a specific surface area to weight ratio. This ratio is optimized to balance environmental efficiency—such as promoting aquatic life colonization and growth—and structural compatibility, ensuring that the structures do not disrupt the aquatic ecosystem but rather integrate smoothly into it. This optimization is crucial for the structures' function and deployment in water, affecting how they interact with currents, sediment, and biological entities.

The fabric foundation module is a deployable underlay designed to be placed beneath modular ecological structures. Its primary function is to provide a stable and supportive base that prevents the structures from sinking or settling excessively into soft or low-capacity soils, which are common in many aquatic environments. This foundation module is made from a robust, flexible fabric material capable of withstanding the underwater environment and distributing the load of the overlying structures. The fabric is selected for its durability, resistance to degradation from water exposure, and its ability to conform to the seabed while providing a stable and uniform support surface. This helps to distribute the weight of the ecological structures evenly, preventing points of excessive pressure that could lead to sinking or tilting. When deployed, the fabric foundation module interacts with both the seabed and the modular ecological structures. It acts as a barrier and distributor of forces between these structures and the variable soil conditions below. By doing so, it maintains the intended positioning and alignment of the structures, crucial for their ecological function and structural integrity over time.

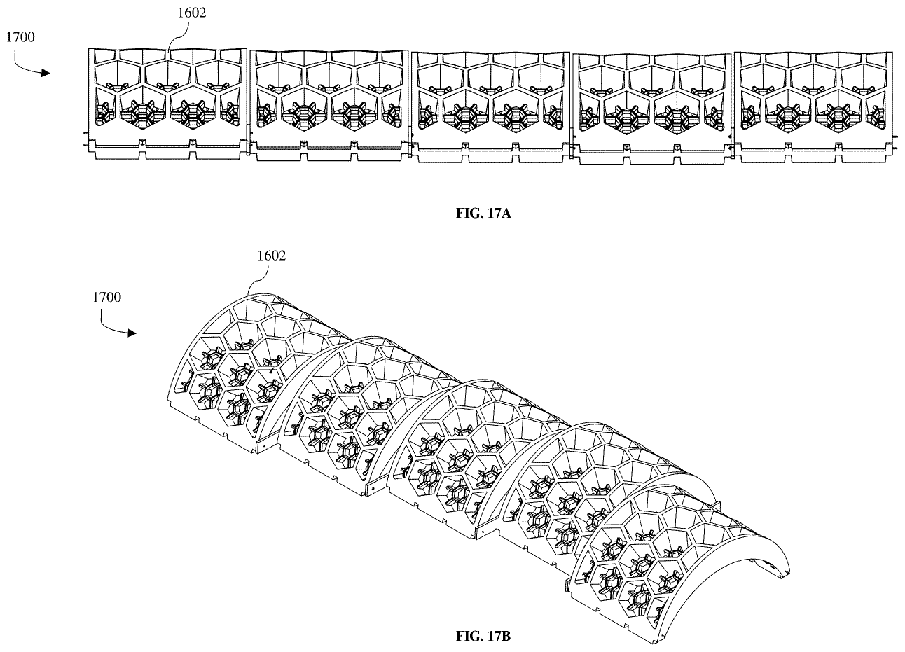

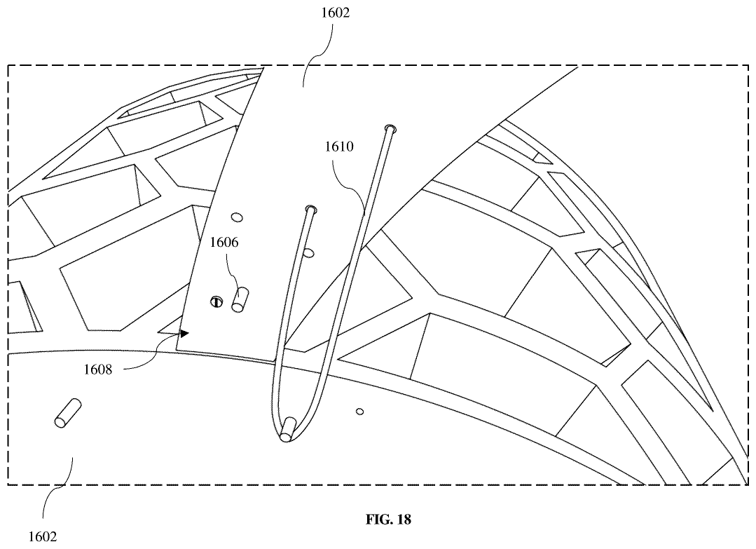

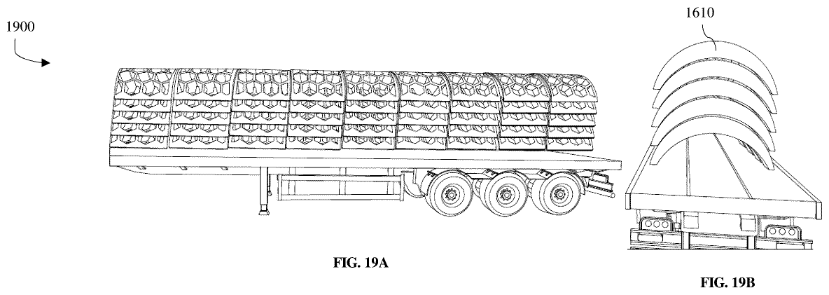

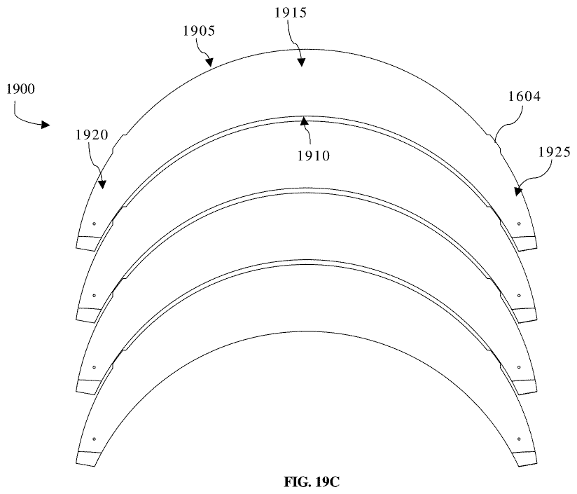

FIGS. 19A through 19C illustrate the modular ecological structures in a transport configuration 1900, according to an example embodiment. The modular ecological structures include integrated load distribution nubs 1604. These nubs are specifically designed to enhance the efficiency of stacking and deployment. By distributing the load evenly, these nubs prevent damage to the structures during handling and maximize the stability of the assembled configuration under water. The upper curved surface 1905 includes a first uniform radius of curvature and the lower curved surface 1910 includes a second uniform radius of curvature, and the thickness between the upper and lower curved surfaces continuously decreases from the apex region 1915 to each of the first end region 1920 and the second end region 1925. The term “radius of curvature” refers to the radius of an idealized arc that best approximates the curved geometry at a given point, and in this context, the upper and lower curved surfaces are each defined by arcs having consistent radii along their respective spans. The first and second radii may differ to achieve a tailored profile optimized for structural efficiency and hydrodynamic performance. The consistent curvature of the upper and lower surfaces contributes to the mechanical predictability of the structure, ensuring uniform load distribution and improved stress management under both static and dynamic conditions.

The continuous decrease in thickness between the upper and lower curved surfaces—from the apex region toward the opposing end regions—forms a tapered cross-sectional profile. This tapering enhances the structural behavior of the ecological structure in several ways. It reduces weight at the extremities, thereby lowering the moment of inertia and improving the structure's capacity to flex or deflect in response to external forces such as wave energy or shifting substrate. Simultaneously, the thicker apex region reinforces the structural core where bending moments and compressive forces are typically most concentrated. The combination of dual-radius curvature and tapering geometry results in a form that efficiently channels environmental forces along predictable load paths, reducing the likelihood of localized stress concentrations or failure points.

Compared to prior art, which may rely on flat panels or constant-thickness sections, this configuration offers a hydrodynamically responsive and structurally resilient alternative. The dual-curvature profile provides enhanced buoyant distribution when flotation elements are used, and the tapered thickness allows for seamless integration with anchoring or truss systems, enabling the structure to remain balanced and stable across diverse deployment scenarios. The geometric taper also simplifies stacking and transport, offering additional advantages in logistical efficiency for modular ecological systems.

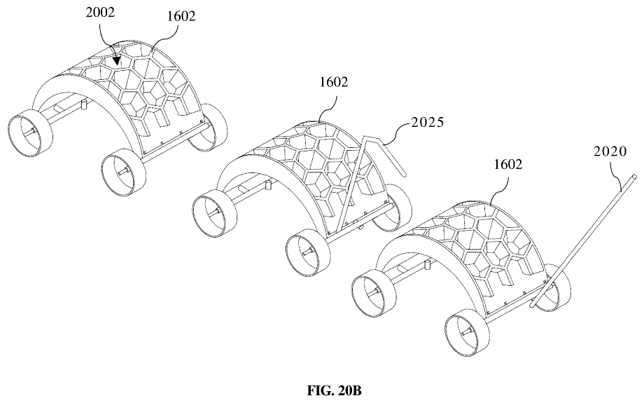

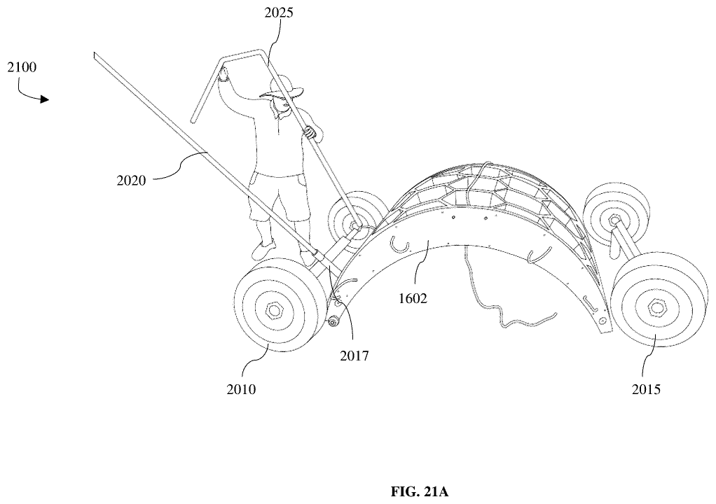

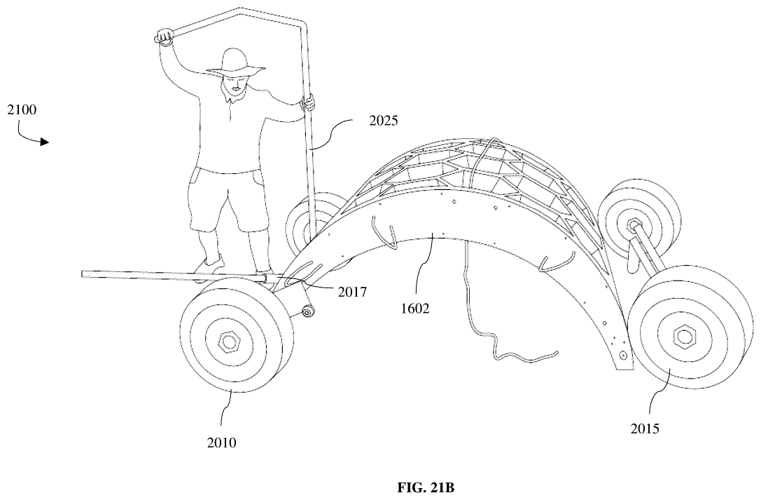

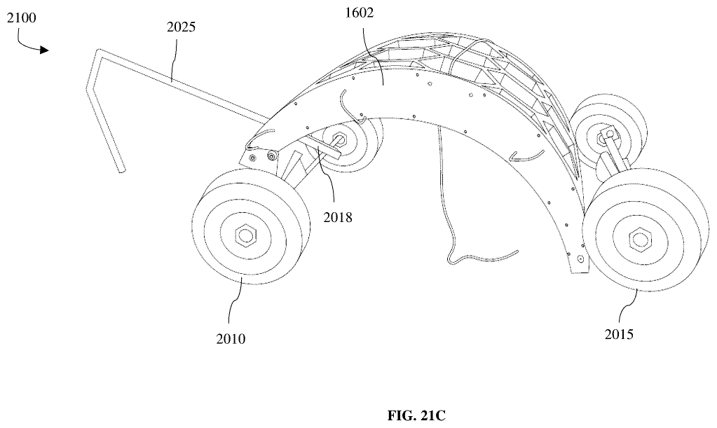

FIG. 21E illustrates the truss assembly in attachment with the ecological structure, according to an example embodiment. The truss assembly includes a plurality of truss elements 2105, each truss element extending upwardly from the wheel and axle assembly and having a connection point at the apex region. Generally, a truss assembly refers to a framework composed of interconnected structural elements, designed to distribFlute weight and resist external forces through a network of load-bearing components. Specifically, the truss assembly in this system features truss elements that are strategically positioned to provide vertical and lateral reinforcement. Each truss element is securely connected at a lower end to the wheel and axle assembly, which serves as a stable base for the modular structure. The upper ends of the truss elements converge at the apex region of the ecological structure, forming a cohesive support network that strengthens the overall framework. This connection enhances the load-bearing capacity of the structure, allowing it to withstand external forces such as wind, water currents, or shifting loads.

In general, a truss element includes a rigid body that may have a tubular, rectangular, or I-beam cross-sectional geometry, depending on the specific requirements of the system. The geometry of the truss elements is optimized to balance material efficiency and structural strength. For example, tubular designs offer superior resistance to torsional forces, while I-beam configurations provide greater stability under bending loads. The truss elements may be manufactured using lightweight and high-strength materials such as aluminum alloys, stainless steel, composite materials like carbon fiber or fiberglass, or corrosion-resistant polymers. These materials ensure durability, resistance to environmental degradation, and ease of transport and assembly. At the lower end, each truss element includes a secure connection mechanism for attachment to the base assembly, such as threaded connectors, hinges, or locking pins. These mechanisms allow the truss elements to be precisely aligned and firmly anchored to the wheel and axle assembly or other structural components. The upper ends of the truss elements converge at the apex region of the ecological structure, forming connection points that integrate with the apex design. These connection points may feature pre-drilled holes, clamps, or welded joints to ensure a robust attachment while allowing for modular adjustments or reconfiguration.

Truss elements are configured to operate under tension and compression, distributing forces evenly across the structure and reducing the risk of localized stress or failure. Their placement and orientation are critical to maintaining the stability of the ecological system, particularly in environments subject to dynamic forces such as wind, water currents, or shifting terrain. In aquatic applications, the truss elements contribute to stability by reinforcing the connection between the base assembly and the ecological structure, preventing overturning or displacement. On land, they help support vertical loads and distribute weight evenly across the system.

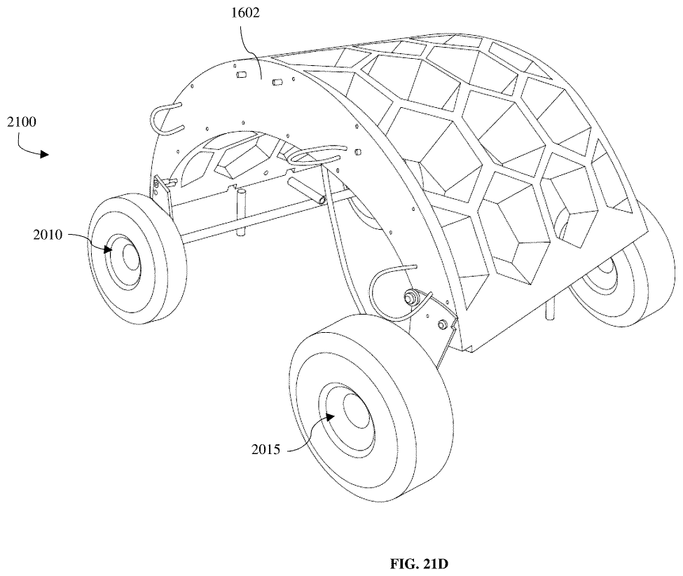

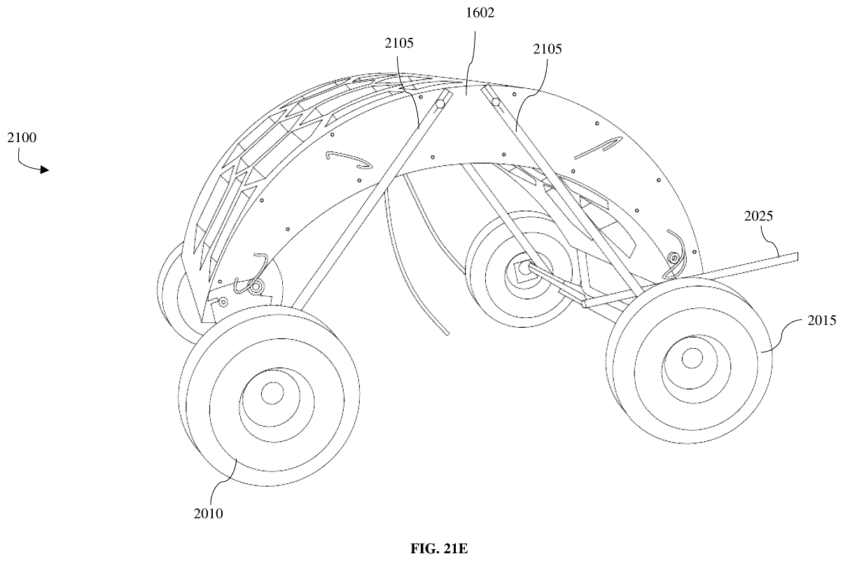

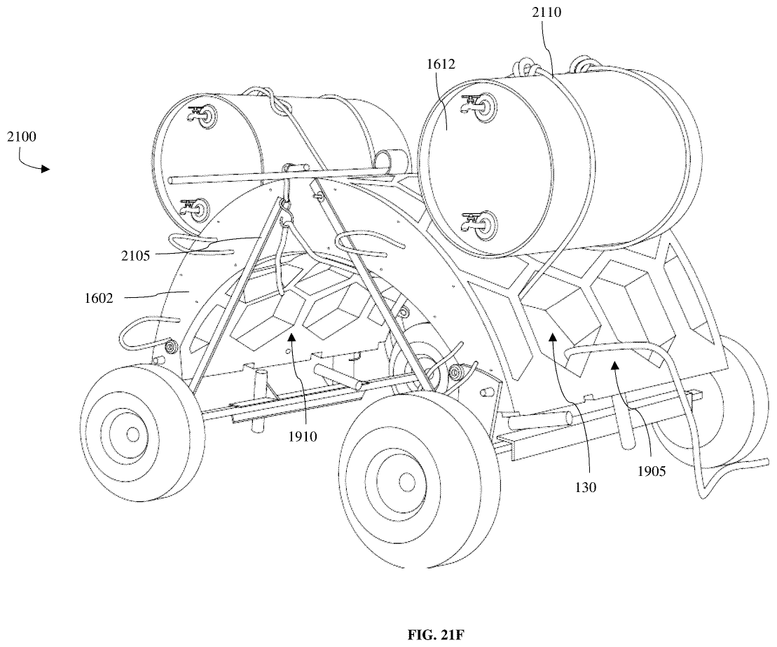

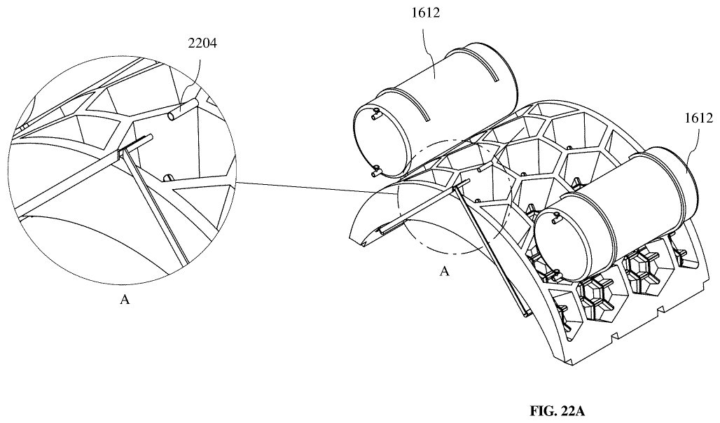

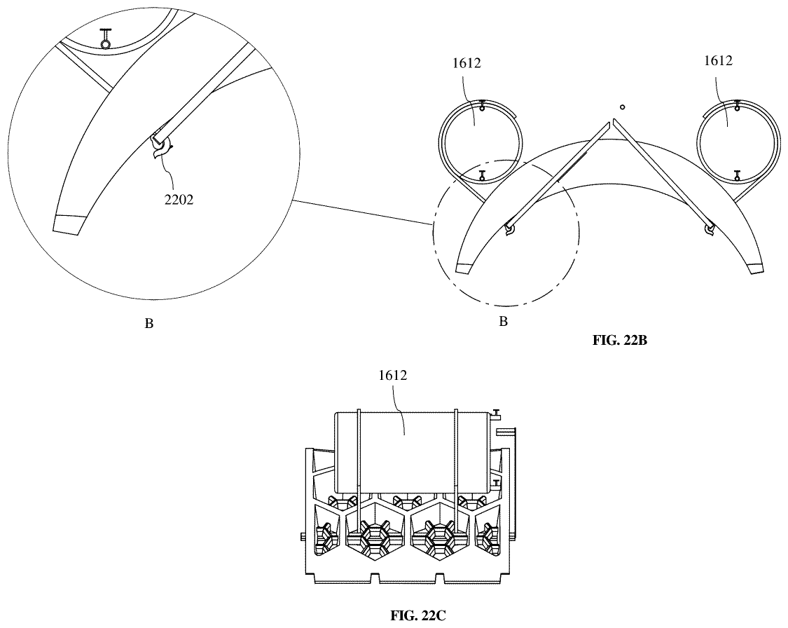

FIGS. 21F through 22C illustrate the adjustable buoyancy control mechanism 1612 in attachment with the ecological structure, according to example embodiments. The adjustable buoyancy control mechanism is a device integrated with each modular ecological structure to manage its buoyancy. This control is essential for enabling the structures to be lowered into the water at controlled speeds and depths, a critical aspect when working in sensitive aquatic environments. This buoyancy control mechanism is specifically designed to attach seamlessly to the modular ecological structures. It features adjustable settings that allow operators to fine-tune the buoyancy of each structure. This adjustability is crucial for achieving controlled descent and precise placement of the structures, ensuring that they land gently and in the correct orientation on the seabed or other targeted areas within the aquatic environment. By adjusting the buoyancy, the mechanism plays a pivotal role in the overall deployment process. It not only facilitates the initial placement of the structures but also supports their repositioning or removal for maintenance, relocation, or ecological assessment. This dynamic capability is particularly important for ecological rehabilitation projects, such as the transplantation of coral heads, where minimal disturbance to marine life and precise placement are paramount. The structure may include a rotating cam bar and hasp 2202 for quick release of each adjustable buoyancy control mechanism 1612. The detailed view illustrates the locking grip 2204 in a dislocated position.

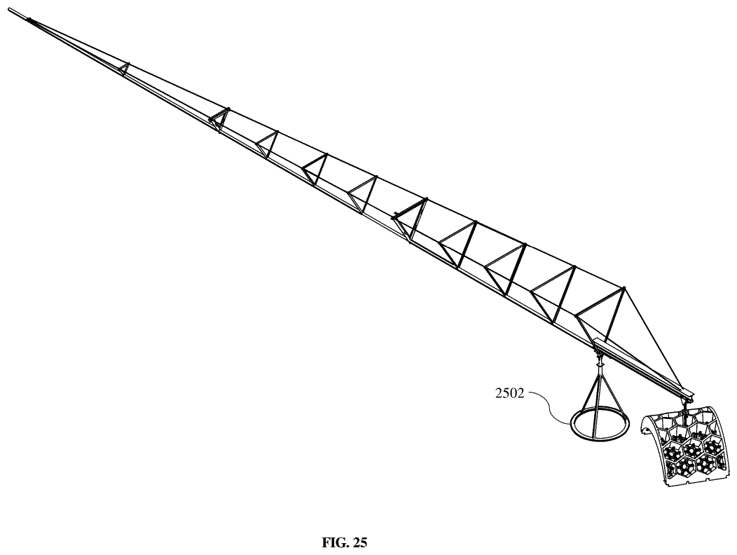

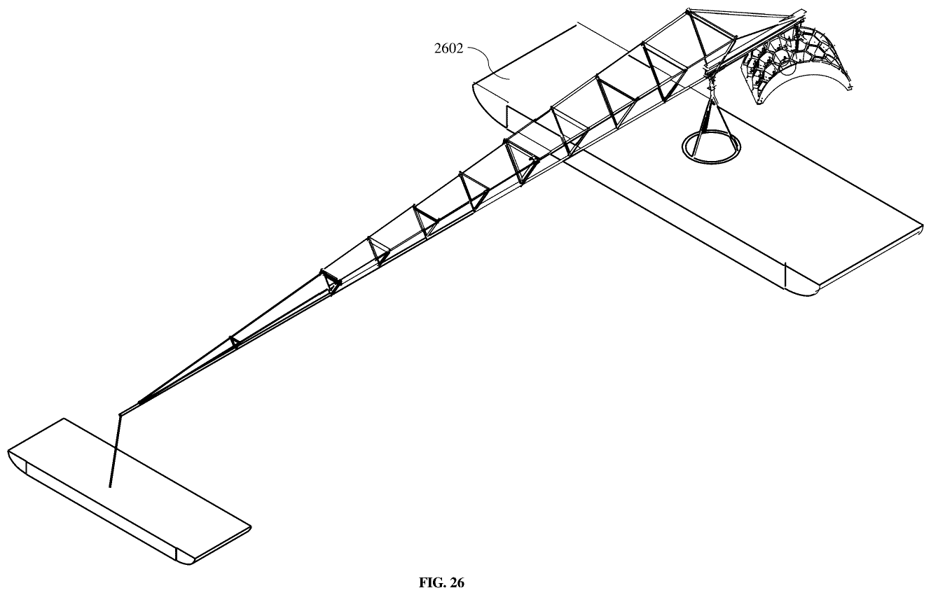

FIGS. 23A through 24D illustrate the precision deployment apparatus 2300, according to example embodiments. The precision deployment apparatus is an engineered system used to position modular ecological structures accurately within aquatic environments. Its primary function is to facilitate the controlled lowering, pivoting, and precise positioning of these structures, critical for ensuring optimal placement without disturbing the aquatic bed or compromising the structural integrity. This deployment apparatus includes the pivoting cantilever 2305 integrated with an I-beam trolley system 2310. The cantilever allows for a variable reach and the ability to pivot by hand, which provides flexibility in placing the structures precisely even in difficult-to-reach areas. The I-beam trolley system enhances this capability by allowing smooth horizontal and vertical movement of the structures, thereby facilitating fine adjustments in positioning without requiring direct manual handling that could disturb the seabed or damage the structures. The pivoting cantilever of the apparatus is modular, featuring a hierarchy of nesting sections that interlock. This modularity allows for rapid assembly and disassembly, which is crucial for operations in various field conditions and locations. The interlocking segments ensure that the cantilever can be progressively moved forward quickly, providing versatility across different deployment scenarios and environmental conditions. This deployment apparatus improves over traditional methods, which often lack the capability for fine-tuned placement and require more manual intervention, increasing the risk of error and environmental impact. The integration of the pivoting cantilever with the I-beam trolley system allows for unprecedented precision and control in the deployment of ecological structures, substantially improving efficiency and reducing the potential for damage to both the structures and the seabed. FIG. 24A through 24D illustrate how the precision deployment apparatus may be nesting for transport and storage. FIG. 25 illustrates how a base modification 2502 may be used instead of the ecological structure in the amphibious vehicle configuration. This allows the cantilevering I-beam trolley to be utilized on a dock/piling/seawall, where land water access is limited. FIG. 26 illustrates how a watercraft 2602 may be used instead of the ecological structure in the amphibious vehicle configuration. A small, weighted boat can be used to allow the offloading of a small barge or skiff with the cantilevering I-beam trolley. This may be a solution if there are permitting conflicts or other access constraints.

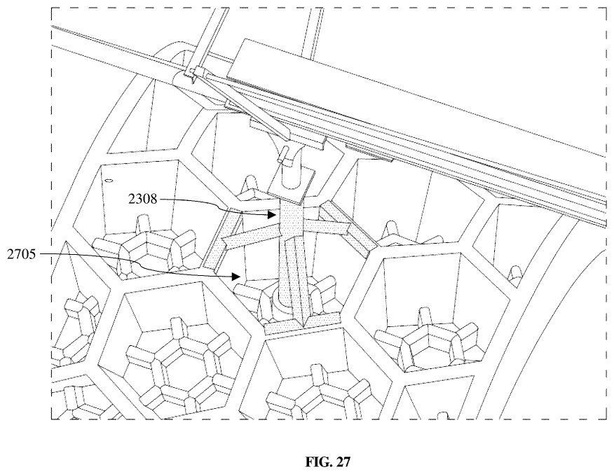

FIG. 27 is a perspective view of the pivoting element 2308 of the precision deployment apparatus in attachment with an ecological structure acting as a fulcrum for pivoting, according to an example embodiment. The pivoting element (also shown in FIG. 23C) refers to a component that rotates around a fixed point, acting as a lever to facilitate movement and positioning. A fulcrum is the fixed point around which the pivoting element rotates, providing leverage. The ecological structure itself acts as a fulcrum. Specifically, the topmost center opening 2705 of the ecological structure serves as the pivoting point around which a pivoting cantilever mechanism operates to deploy another modular ecological structure. When deploying a second ecological structure, the first ecological structure is positioned such that its topmost center opening becomes the fulcrum point. The pivoting cantilever attaches to this opening, allowing the entire cantilever system to rotate around it. This setup enables precise control over the positioning of the second modular ecological structure by leveraging the stability and fixed position of the first structure.

The fulcrum point allows for fine control over the placement of the second structure, ensuring accurate and stable positioning. The fixed position of the first ecological structure provides a stable base for the deployment of additional structures, reducing the risk of misalignment or tipping. The system allows for rapid and accurate placement of multiple structures, streamlining the deployment process and reducing operational time. By distributing forces through the fulcrum point, the system minimizes stress on both the deploying mechanism and the structures themselves, enhancing durability.

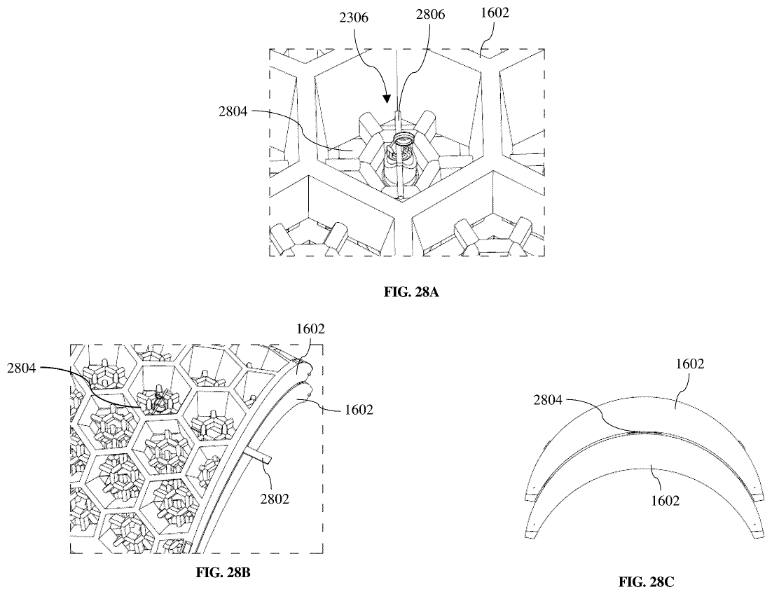

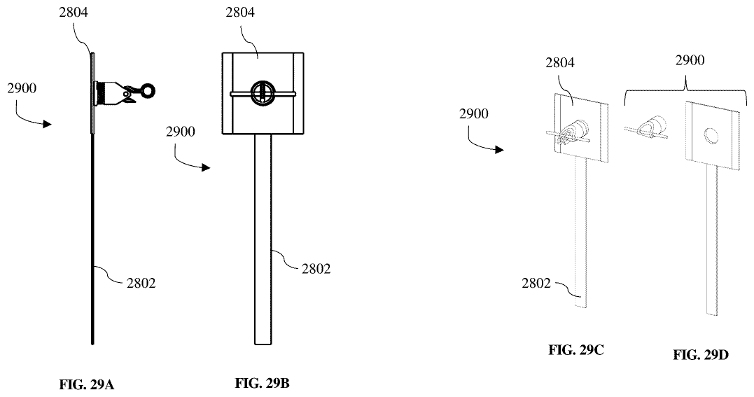

FIGS. 28A through 28C illustrate the low-profile attachment plate between stacked ecological structures. FIGS. 29A through 29D illustrate the low-profile attachment plate 2900, according to an example embodiment. The low-profile hoisting system 2306 (also shown in FIG. 23C) is a mechanical apparatus designed to lift, stack, and transport modular ecological structures. Its “low-profile” design is critical for minimizing the space required for the hoisting mechanism itself, which is particularly advantageous in constrained spaces commonly found in storage and deployment scenarios on marine vessels or coastal facilities. Because the nubs of the ecological structures provide space This hoisting system is uniquely designed to engage with the low-profile attachment plate that is positioned within the spaced created by the integrated load distribution nubs found on the modular ecological structures. The low-profile hoisting system facilitates not only the lifting but also the precise alignment and stacking of the ecological structures. This is particularly important when these structures need to be stored in close proximity, such as in the hold of a ship or in a storage yard where space is at a premium. The system's ability to engage specifically with the low-profile attachment plate means that each structure can be positioned and stacked in an optimized configuration, maximizing storage efficiency and minimizing the physical footprint of the stacked structures.

The low-profile attachment plate slides between the ecological structures. The T-handle 2806 is then screwed into the threaded base plate 2804. This action is assisted by holding the plate 2804 in place with the integral handle 2802 (the plate and the handle indicated our one piece). This allows for an attachment point for hoisting the ecological structures when there is little other opportunity for attachment once the ecological structures are stacked and loaded, face-to-face. The low-profile attachment plate is a component designed to facilitate the handling and transportation of modular ecological structures. It serves as an intermediary device that connects the hoisting system to the ecological structures, ensuring they can be safely lifted and moved. Configured to slide between adjacent ecological arches, the attachment plate is uniquely designed to fit snugly and unobtrusively within the openings of the ecological structures. Its low profile ensures that it does not protrude excessively, maintaining the compact and efficient design of the stacked or transported structures. This design minimizes spatial requirements and prevents any interference with the close packing of the structures. When in use, the attachment plate acts as a crucial linkage point within the ecological structure. It provides a stable and secure attachment point for hoisting cables or mechanisms for a single point attachment. The ability to slide the plate into position between stacked arches allows for quick and easy adaptation to various configurations, facilitating rapid preparation of structures for lifting without the need for extensive reconfiguration or additional tools.

FIGS. 30A and 30B illustrate the ecological structure 3000 in attachment with minor flotation devices 3002. These flotation devices to keep the arch in an upright position as it descends. Because it is relatively lightweight and stackable. Lots of them can be loaded onto a barge deck. This can be helpful in establishing Deepwater reefs, and as a deterrent for bottom trawling by international offenders. To alleviate environmental concerns glass buoys can be used or cotton rope treated with a combination of muriatic acid, and then petroleum jelly will provide a timed detachment. This will allow the recovery of high visibility numbered synthetic buoys.

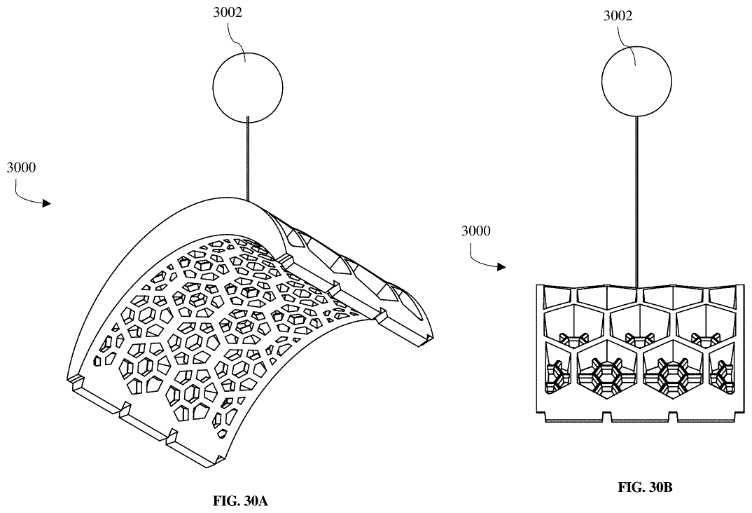

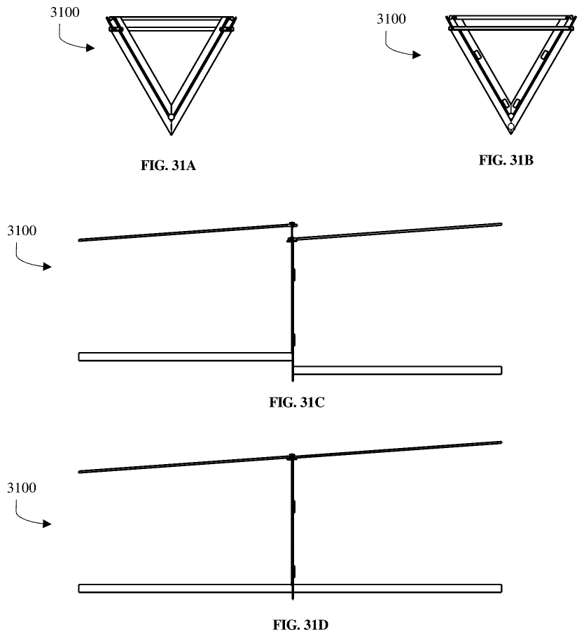

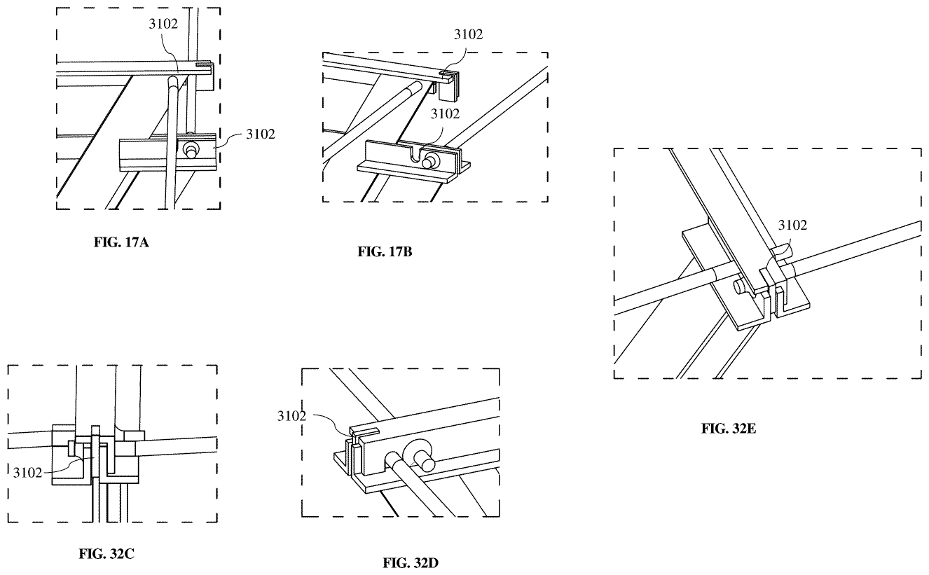

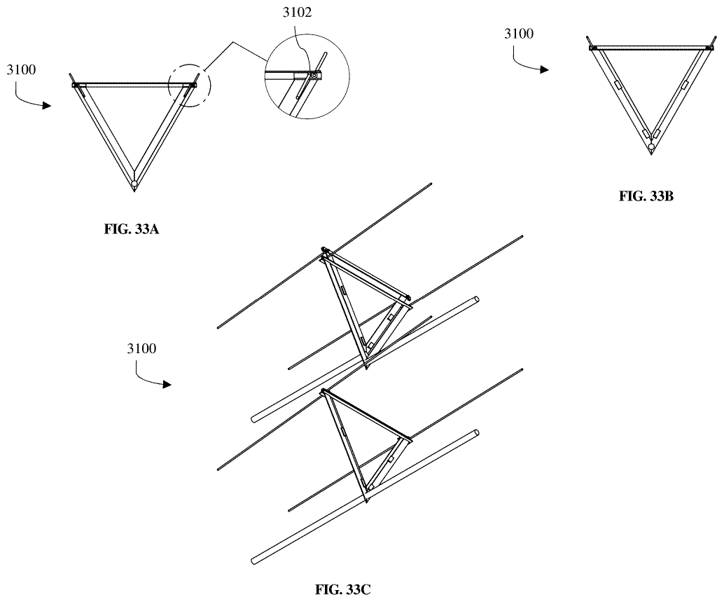

FIGS. 31A through 33C illustrate how the hierarchy of nesting sections 3100 of the modular pivoting cantilever can be quickly assembled and disassembled via interlocking segments 3102. The interlocking segments require no fasteners. It is a slide-down, fast-engagement interlocking system that provides conveniency.

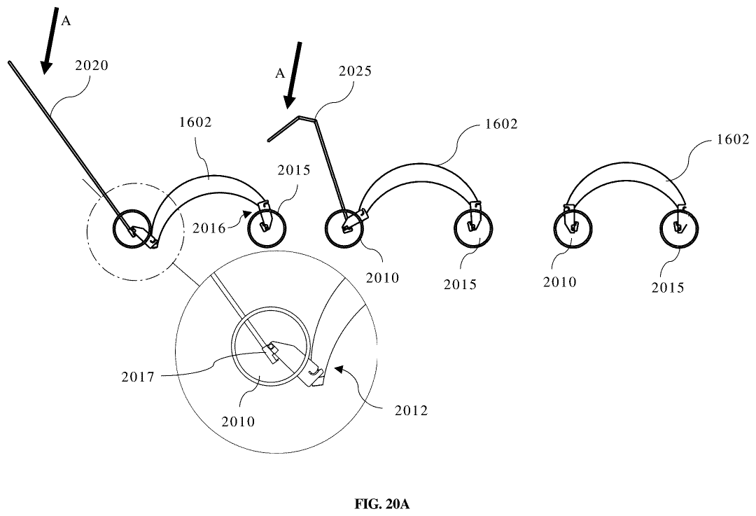

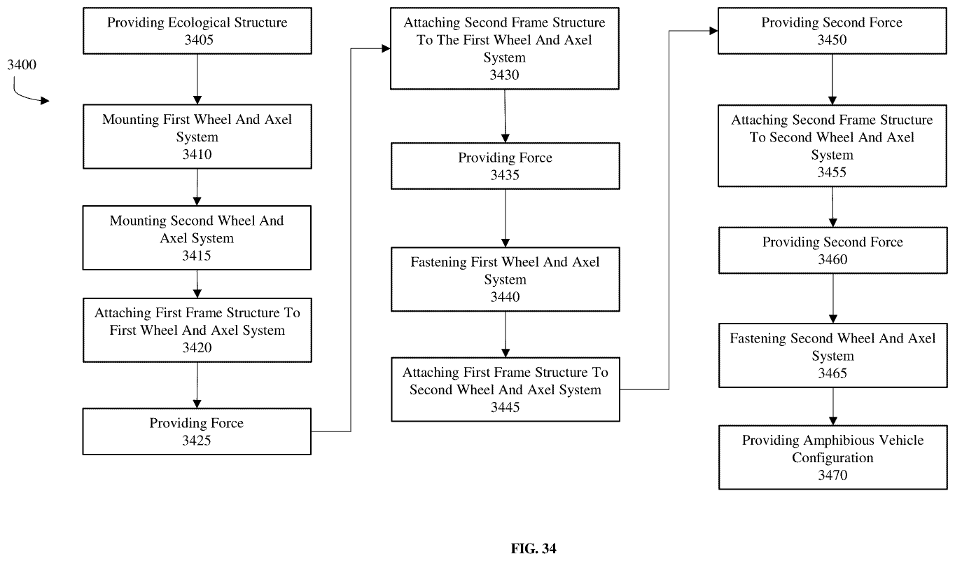

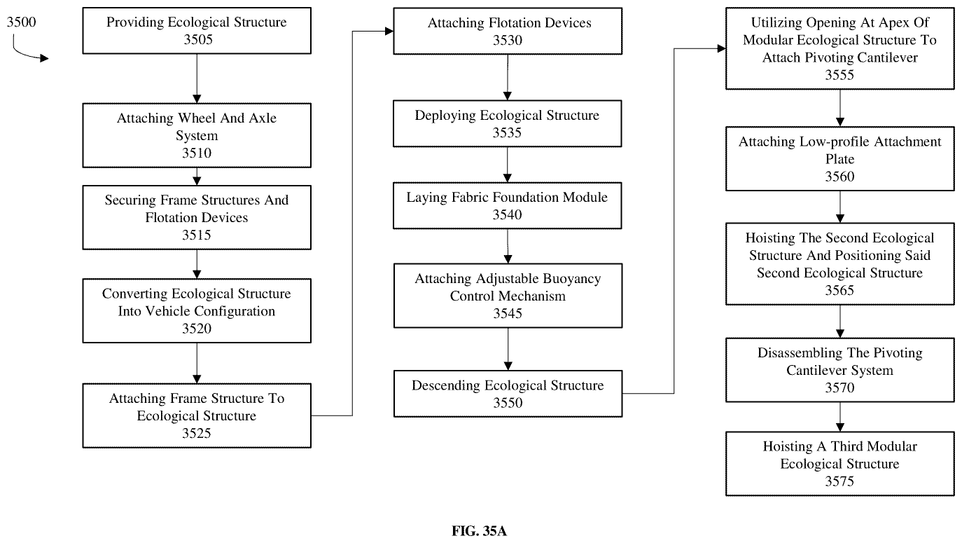

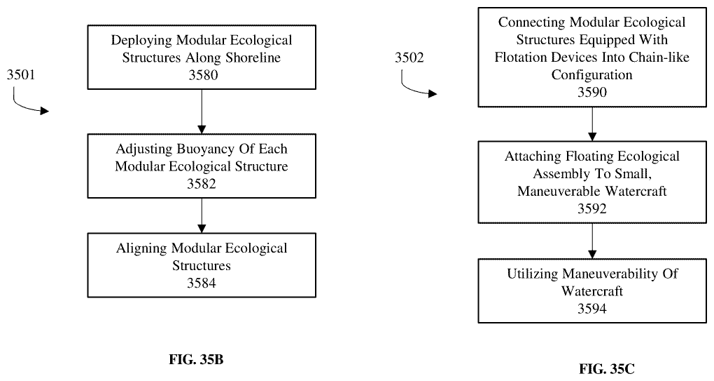

With reference to FIGS. 20A through 21D and 34, the steps for a method 3400 for converting a modular ecological structure into the amphibious vehicle configuration 2100 is shown will be described, according to an example embodiment. Initially, the method includes providing 3405 an ecological structure 1602. The ecological structure includes an opening 2002 on a top portion of the ecological structure, a threaded rod disposed at a lower terminating end portion of the ecological structure, and a plurality of sidewall fasteners. The threaded rod spans a width of the ecological structure and extends outwards from a plurality of sidewalls. This configuration provides the structural basis for mounting auxiliary systems and ensures transverse stability across the structure's base. The outwardly extending ends of the threaded rod function as rotational or bearing supports, facilitating the subsequent mounting of the axle assemblies.

The method further includes mounting 3410 a first wheel and axel system 2010 to first end portion 2012 of the modular ecological structure and mounting 3415 a second wheel and axel system 2015 to a second end portion 2016 of the modular ecological structure. Each of the first wheel and axel system and the second wheel and axel system includes a first receiving section 2017 and a second receiving section 2018. The first receiving section is perpendicular to the second receiving section. The first receiving section and the second receiving section are configured to receive the first frame structure and the second frame structure, respectively. The use of orthogonally disposed receiving sections allows for sequential engagement of frame elements during staged transitions, enabling controlled deployment and locking of the axle assembly into operable position. This geometry also reduces mechanical stress by aligning applied forces with structurally reinforced zones.

Then, the method includes attaching 3420 a first frame structure 2020 to the first wheel and axel system. Next, the method includes providing 3425 a force A to the first frame structure to engage the first wheel and axel system. Then, the method includes attaching 3430 a second frame structure 2025 to the first wheel and axel system. Then, the method includes providing 3435 the force A to the second frame structure to engage the first wheel and axel system, thereby transitioning the first wheel and axel system beneath the first end portion 2012. The transition of the wheel and axle system beneath the structure permits the redistribution of load from the sidewalls to the axle, enabling ground clearance and facilitating amphibious mobility. The application of force A may be performed manually or with mechanical assistance, depending on deployment scale or environmental constraints.

Next, the method includes fastening 3440 the first wheel and axel system to the plurality of sidewall fasteners. This fastening ensures that once transitioned into position, the wheel and axle system is rigidly secured to prevent shifting or torsional movement under dynamic loading. Locking mechanisms may include threaded bolts, clamps, or locking pins that engage with pre-formed fastener housings in the sidewall.

Next, the method includes attaching 3445 the first frame structure to the second wheel and axel system. Then, the method includes providing 3450 a second force to the second frame structure to engage the second wheel and axel system. Next, the method includes attaching 3455 the second frame structure to the second wheel and axel system. Next, the method includes providing 3460 the second force to the second frame structure to engage the second wheel and axel system, thereby transitioning the second wheel and axel system beneath the second end portion. The use of a second force application mirrors the first engagement process, maintaining symmetry in wheel alignment and balancing the structure longitudinally. This step ensures that both ends of the structure are lifted in a coordinated fashion, which is especially important in uneven terrain or tidal deployment zones.

Then, the method includes fastening 3465 the second wheel and axel system to the plurality of sidewall fasteners. This final fastening step secures the full wheelbase of the modular ecological structure, effectively converting it into an amphibious-ready configuration with stabilized load-bearing support on both ends.

Next, the method includes providing 3470 the amphibious vehicle configuration including a wheel and axel including leverage receivers attached to the axel. The wheel and axel are attached to the lower terminating end portion of the ecological structure. Its purpose is to stabilize the axles, preventing the rotation of the axles to their unloaded position. The leverage receivers receive pivot forces from the frame structures to maintain axle alignment during operation. The amphibious vehicle configuration further includes a third frame structure 2105 connected to each of the wheel and axels and a vertex of the ecological structure. This triangulated connection increases torsional rigidity and distributes vertical and lateral loads across the structure. The amphibious vehicle configuration further includes flotation devices 1612 attached to the ecological structure, shown in FIG. 21F. The flotation devices ensure buoyancy when the system is submerged or partially submerged, facilitating transitional use in aquatic and terrestrial environments. Their attachment at calculated positions contributes to hydrostatic balance, reducing pitch or roll during water-based deployment.

Referring now to FIG. 35A, a flowchart diagram illustrating steps of a method 3500 for the deployment, assembly, and stabilization of modular ecological structures in aquatic environments is shown, according to an example embodiment. Initially, method 3500 includes providing 3505 the ecological structure 1602. Then, the method includes attaching 3510 a wheel and axle system 2010 to the threaded rod at the lower terminating end portion of the ecological structure 1602, thereby converting the structure into a mobile vehicle for terrestrial transport. This step enables the structure to be moved across land surfaces prior to aquatic deployment, allowing access to shorelines or staging areas without heavy-lift equipment. The threaded rod serves as both a structural anchor and rotational axis for the wheel and axle system 2010, facilitating a secure, balanced connection point.

Next, the method includes securing 3515 frame structures and flotation devices to the sidewall fasteners and the ecological structure 1602, enabling the ecological structure to be adapted for transport and deployed within aquatic environments, while also leveraging these fasteners for the attachment of subsequent modular ecological structures to create a cohesive and integrated assembly. The use of standardized sidewall fasteners allows modular scalability and ensures consistent, load-bearing points across different deployment configurations. Next, the method includes converting 3520 the ecological structure 1602 into a vehicle configuration by attaching a wheel and axle 2010 to each terminating end portion 2012 and 2016 of the ecological structure. This dual-axle configuration provides longitudinal balance, facilitating smoother mobility and more controlled deployment into aquatic zones.

Then, the method includes attaching 3525 a frame structure 2020 to the ecological structure in the vehicle configuration. The frame structure 2020 may include leverage receivers, pivot points, or structural reinforcements to assist in raising or guiding the structure during deployment. Then, the method includes attaching 3530 flotation devices 1612 to the ecological structure in the vehicle configuration. These flotation devices 1612 may be symmetrically or asymmetrically arranged depending on desired buoyancy characteristics. Next, the method includes deploying 3535 the ecological structure into a body of water. This may be done by rolling, hoisting, or floating the unit from a shoreline or barge. Next, the method includes laying 3540 a fabric foundation module at a restoration site. In other embodiments, if it is not practical to lay the fabric below the ecological structure, the method includes attaching the fabric directly to the bottom of the ecological structure 1602 while in the hoisted position. This configuration allows sediment control or substrate stabilization fabric to be pre-integrated prior to placement, reducing underwater labor and improving positioning accuracy.

Then, the method includes attaching 3545 an adjustable buoyancy control mechanism configured to attach to each modular ecological structure 1602, designed to adjust the buoyancy for controlled descent and precise placement within aquatic environments, further facilitating the gentle harvesting and relocation of coral heads for ecological rehabilitation purposes. These buoyancy control mechanisms may include inflatable bladders or fluid ballast compartments operable via valve or remote control. Next, the method includes descending 3550 the ecological structure 1602 onto the restoration site. Controlled descent minimizes environmental disruption, allowing accurate positioning in sensitive marine environments.

Next, the method includes utilizing 3555 an opening at an apex of the modular ecological structure 1602 to attach a pivoting cantilever with an integrated I-beam trolley system, wherein the pivoting cantilever with an integrated I-beam trolley system engages with the opening to convert the ecological structure into a fulcrum, facilitating the lifting and positioning of additional modular ecological structures or related components. The apex-mounted pivot point enables the structure to function as a mobile gantry or rigging base, leveraging structural geometry for deployment of subsequent units with minimal equipment repositioning.

Next, the method includes attaching 3560 a low-profile attachment plate to a second ecological structure to provide a point-of-attachment for hoisting and controlled descent mechanisms. The low-profile design minimizes interference with structural hydrodynamics and simplifies alignment with lifting apparatuses. Then, the method includes hoisting 3565 the second ecological structure and positioning said second ecological structure into place proximate to the ecological structure 1602. Placement in close proximity supports interlocking or side-by-side configuration, enhancing stability and increasing effective habitat coverage.

Next, the method includes disassembling 3570 the pivoting cantilever system previously used for the deployment of the first ecological structure 1602 and reattaching it to the second ecological structure, repurposing the second structure as the new deployment point for additional structures. This handoff strategy allows deployment to continue in a “leapfrog” fashion, maximizing efficiency by minimizing movement of primary equipment. Then, the method includes hoisting 3575 a third modular ecological structure using the repositioned pivoting cantilever system and positioning it proximate to the second ecological structure, thereby extending the ecological assembly further within the aquatic environment. This modular repetition facilitates rapid, scalable deployment across wide aquatic zones with minimal environmental disruption.

Referring now to FIG. 35B, a flowchart diagram illustrating steps of the method 3501 for the deployment, assembly, and stabilization of modular ecological structures in aquatic environments is shown, according to an example embodiment. The method further includes deploying 3580 the modular ecological structures along a shoreline to form a living shoreline. The structures are positioned to provide erosion control and habitat restoration by the following steps. Then, the method includes adjusting 3582 the buoyancy of each modular ecological structure to ensure they rest at predetermined depths along the shoreline, fostering the growth of aquatic vegetation and providing a substrate for marine organisms. Precise buoyancy control ensures stable vertical placement regardless of tidal variation or sediment displacement. Next, the method includes aligning 3584 the modular ecological structures in a configuration that follows the natural contour of the shoreline, creating a buffer that reduces wave energy and protects the shoreline from erosion, while simultaneously enhancing the marine habitat. This bio-integrated arrangement mimics natural shoreline profiles, promoting sediment accretion and habitat complexity.

Referring now to FIG. 35C, a flowchart diagram illustrating steps of the method 3502 for the deployment, assembly, and stabilization of modular ecological structures in aquatic environments is shown, according to an example embodiment. The method further includes connecting 3590 a plurality of modular ecological structures equipped with flotation devices into a chain-like configuration, thereby forming a floating ecological assembly. This chain-like configuration may be preassembled on land or in shallow water to facilitate rapid deployment. Next, the method includes attaching 3592 the floating ecological assembly to a small, maneuverable watercraft such as a jet ski. The compact size and agility of the watercraft allow access to otherwise unreachable deployment zones, such as mangrove corridors, salt marsh inlets, or narrow estuarine channels. Then, the method includes utilizing 3594 the maneuverability of the watercraft to transport the connected ecological structures to a designated restoration site through waterways and areas where large boats and barges cannot feasibly reach, ensuring precise placement and deployment of the ecological structures at the restoration site for habitat restoration or creation purposes. This method significantly expands the range of viable deployment locations while lowering operational costs and minimizing disturbance to sensitive ecosystems.

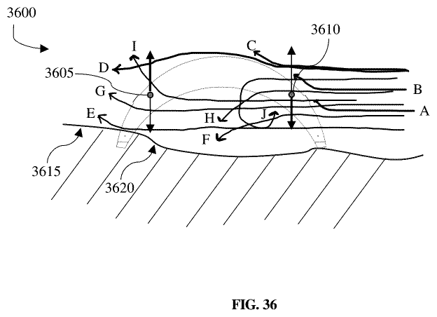

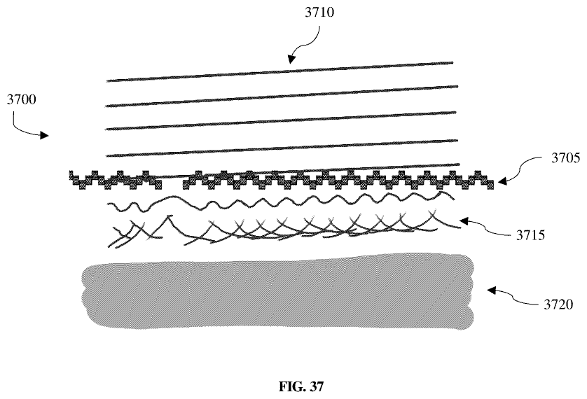

Referring now to FIGS. 36 and 37, the fluid dynamics caused by the ecological structures will be discussed. FIG. 36 is a diagram 3600 illustrating the flow of water through the ecological structure, according to an example embodiment. FIG. 36 depicts an ecological structure in the form of an arch, highlighting the interaction between wave currents and the structural features of the design. The ecological structure includes a honeycomb texture, represented by a plurality of openings within the arch, as well as its overarching curved geometry. Together, these features interact with wave currents to create a highly stable and resilient system capable of withstanding dynamic environmental forces.

The opening extending through the upper curved surface to the lower curved surface comprises a predetermined opening angle that is configured to direct a plurality of hydrodynamic forces through the structure. This opening serves not merely as a pass-through feature, but as a strategically oriented conduit designed to influence the behavior of fluid flow interacting with the ecological structure. The “predetermined opening angle” refers to the inclination or angular orientation of the axis of the opening relative to the surfaces of the structure-specifically selected to achieve controlled directionality of water or other fluid movement. In a general sense, openings extending between opposed surfaces can serve to relieve pressure differentials, allow for drainage, or reduce drag. However, in this embodiment, the opening is engineered with a defined angle to actively shape the flow of hydrodynamic forces—such as currents, wave energy, or tidal movement—passing through the structure. By directing these forces through the opening rather than allowing them to concentrate on external surfaces, the system mitigates destabilizing pressure and reduces the occurrence of turbulent wake zones around the structure. This contributes to improved structural stability and prolongs the functional life of the unit by reducing erosion and scouring effects in sediment-rich environments. The angled opening also promotes passive pressure equalization across the structure during submersion or wave impact, improving the ecological structure's ability to remain seated and resist uplift. For example, in one embodiment, the opening angle may be oriented downward and forward, relative to the direction of prevailing current, to facilitate forward sediment transport and subsurface deposition beneath the structure. In another embodiment, multiple angled openings may be used in a staggered configuration to generate counter-rotating internal flow paths, adding a stabilizing effect during lateral current shifts. This design improves over prior art, which often omits any mechanism for force redirection through the interior of ecological structures, relying instead on external bulk to resist hydrodynamic loads. By incorporating an internal flow-directing element with a predetermined angle, this system actively engages with its environment, reducing reactive forces, enhancing energy dispersion, and contributing to overall ecological integration by encouraging sediment settlement and water circulation through and around the modular system.

The arrows E, F, G, H, I, J illustrate the reaction forces generated by wave currents as they pass through and interact with the honeycomb structure. This honeycomb texture, characterized by a plurality of openings within the ecological structure, allows water to flow through the arch in a controlled manner. As the currents navigate the honeycomb openings, the wave energy is dispersed and redirected, reducing pressure on any single point of the structure. This controlled diffusion of wave forces improves over prior art, where solid or impermeable designs often result in concentrated forces that lead to structural fatigue or failure. The honeycomb structure not only minimizes the impact of hydrodynamic forces but also encourages sediment deposition beneath the arch, contributing to long-term environmental stability.

The arrows A, B, C, D indicate the reaction forces created by wave currents interacting with the arch's curved geometry. The shape of the arch provides a streamlined profile that redistributes wave energy across its surface, preventing localized stress and enhancing overall durability. Unlike conventional flat or angular structures, which are prone to instability under uneven loading, the arch shape ensures a uniform response to dynamic forces. This feature allows the structure to remain stable even in high-energy environments such as tidal zones, rivers, or wave-exposed shorelines.

The diagram also illustrates points 3605, 3610 with opposing forces, representing the stabilizing effects generated by the combined interaction of the wave currents with both the arch shape and the honeycomb structure. These opposing forces act symbiotically to counterbalance the pressures exerted by wave currents, creating equilibrium that reinforces the structure's position. The honeycomb texture dissipates energy within the structure, while the curved geometry redirects external forces along its surface. Together, these features create a dual stabilization mechanism that is particularly effective in mitigating multi-directional forces. This dual stabilization capability marks a substantial improvement over prior art, where traditional designs often fail to address the complexity of interacting forces, leading to displacement or erosion.

Additionally, the diagram shows the sedimentary processes beneath the arch. The controlled flow of wave currents, influenced by the honeycomb openings and the arch's geometry, facilitates sediment accretion 3615 and stability. This sediment accumulation, shaped by the natural angle of repose 3620, anchors the structure to its environment and fosters ecological benefits by creating a stable substrate for habitat restoration. Unlike prior designs that disrupt sediment movement or cause scouring, this structure works in harmony with natural sediment dynamics, promoting long-term environmental integration and sustainability.

Overall, the combination of the honeycomb structure, arch shape, and their interaction with wave forces provides a superior solution for structural stability and environmental integration. The ability to dissipate, redirect, and stabilize wave energy through these features significantly enhances the durability and ecological compatibility of the system, offering clear advantages over conventional approaches to habitat stabilization, erosion control, and ecological restoration.

FIG. 37 is a diagram 3700 illustrating the flow of water through the ecological structures in a chain-like configuration 3705, according to an example embodiment. In the chain-like configuration, the ecological structures are in attachment in a zigzag pattern, similar to the pattern configuration 1700 shown in FIG. 17A and FIG. 17B. In terms of dynamic stability, the design of each arch is optimized to counteract the vertical forces exerted by ocean waves 3710. The curvature of the arches is specifically engineered to channel these forces downward, which typically promotes sediment accumulation that can bury conventional reef structures. To mitigate this, strategically placed openings within each arch feature varying arc angles that facilitate water flow through the structure. These openings are designed such that the internal geometry of the arch creates an uplift force inside the arch, countering the downward pressure of the waves and thus preventing the structure from embedding into the seabed.

The zigzag configuration of the reef system addresses lateral stability challenges posed by wave dynamics. As waves approach and interact with the shoreline, their speed and angle of approach can increase erosive forces. The staggered arrangement of the arches within the zigzag pattern effectively absorbs and dissipates these forces, as shown by waves 3715, before they reach the shore 3720. Each arch in the formation is designed to confront wave energy directly at the points of peak curvature—the most structurally fortified points. This design ensures that wave energy is incrementally absorbed and weakened as it travels through the sequence of arches, significantly reducing the potential for erosion.

In the zigzag pattern, each arch is strategically placed to absorb and dissipate the lateral forces exerted by incoming waves. The positioning allows each arch to intercept waves at an angle, which helps distribute the energy of the wave along the length of the arch rather than concentrating it at a single point. This distribution is critical in reducing the sheer force impact and the subsequent movement or shifting of individual segments. Moreover, the connections between each arch—facilitated by rods that extend through the terminating ends of each segment—further reinforce the assembly against lateral movements.

In an embodiment, the artificial reef system includes artificial reef inserts configured for being retained within the plurality of openings of the artificial reef segments. The reef inserts are specialized structures or modules designed to fit and be secured within the openings of artificial reef segments. In an example, the reef inserts may be retained by removably fitting inside the openings of the reef segments. The artificial reef inserts may be reinforced and/or further secured within the opening using adhesive to prevent uplifting of the reef inserts. The adhesives may be water resistant and corrosion resistant, such as marine epoxy resins, polyurethane marine sealants, marine silicone sealants. The openings have depth, and the reef inserts are placed within the depth of the openings.

The artificial reef inserts within the reef system are equipped with pyramidal-shaped protrusions, which serve a crucial role in protecting marine life from predators. The unique pyramidal shape of these protrusions is instrumental in deterring various predators, including different sizes of crabs, by creating a physically challenging terrain that hinders their access to smaller, vulnerable organisms. This geometric design is effective in providing a safer environment for these smaller marine species to thrive and for larval development of various species, e.g. oysters spat, and coral polyp.

Additionally, the protrusions on the inserts vary in size, which is essential for supporting a hierarchical ecosystem within the insert. This variation allows for different sizes and types of marine life to find suitable habitats. Smaller protrusions offer refuge to tiny species, while the larger ones can accommodate bigger organisms, fostering a diverse and balanced marine ecosystem.

The design of the inserts also includes strategically placed openings that facilitate water flow. These openings are crucial as they allow the circulation of water through the insert, ensuring that essential nutrients and small organisms can flow through, which is vital for the sustenance and growth of marine life attached to the inserts. The water flow also helps in maintaining optimal water quality and temperature conditions around the reef structure. The tapered shape of the structures that comprise the insert vary the hydrodynamics. The deeper into the insert, the faster the water flows. This allows for species specific velocities to be realized for a wide variety of sessile organisms.

Overall, the combination of the protective pyramidal protrusions, varied habitat spaces due to different protrusion sizes, and the inclusion of openings for water flow enhances the ecological functionality of the artificial reef inserts. These features collectively contribute to the effectiveness of the reef system in supporting a diverse and thriving marine ecosystem, aiding in both the restoration and conservation of reef environments.

The artificial reef inserts facilitates coral out planting and oyster growth. The pyramidal protrusions on the inserts, varying in size, provide an ideal substrate for coral out planting. The increased surface area of the pyramidal structures having multiple wings offer multiple attachment points for young coral fragments, which is essential for their initial establishment and growth. The varied sizes and shapes of the protrusions cater to different coral species, accommodating their specific growth patterns and size requirements. This design feature ensures that a variety of coral species can be successfully out planted and nurtured on the inserts, contributing to the biodiversity and resilience of the reef system.

In addition to supporting coral growth, the artificial reef inserts are conducive to oyster colonization. Oysters require sturdy and complex surfaces for attachment, and the textured surface of the inserts, especially the pyramidal protrusions, provides an ideal environment for oyster larvae to settle and grow. The presence of oysters on these inserts is particularly beneficial as they are natural water filterers, thus contributing to the overall health of the marine ecosystem by improving water quality. The strategic placement of reef segments offshore, yet within proximity to coastal areas, is aimed at facilitating oyster recruitment. By positioning these segments in locations that are accessible to oyster larvae, yet sufficiently offshore to avoid direct human impact and coastal disturbances, the reef structure provides an optimal environment for oyster colonization and growth. The proximity to shore ensures that the segments are within the range of natural oyster larvae dispersal, which is crucial for the successful establishment and development of oyster populations. This arrangement not only contributes to the restoration and conservation of oyster habitats but also enhances the ecological benefits of the reef segments, such as water filtration and shoreline protection, provided by a thriving oyster population. The careful consideration of location in relation to oyster recruitment demonstrates a thoughtful approach to maximizing the ecological impact of the artificial reef system.

The openings in the inserts facilitate the flow of water, which is crucial for both coral and oyster development. This water flow brings in essential nutrients and oxygen, while also allowing for the passage of small organisms that form part of the food chain. For corals, the flow of water helps in the removal of waste products and delivers phytoplankton and other microscopic food sources. For oysters, the water flow ensures a steady supply of plankton, their primary food source.

Additionally, for instance, the reef inserts may be made from an environmentally friendly materials, such as textured ceramic tiles or specially designed habitat structures and are fitted into the openings of artificial reef segments to create a more intricate and habitat rich environment for marine life, including invertebrate and other lifeforms and provides protection from a plurality of predators. The structure provides hiding spots and shelters where smaller fish and invertebrates can take refuge, making it more challenging for predators to locate and capture them. The reef inserts retained within the openings of artificial reef segments operate by adding complexity and diversity to the reef structure. The additional surfaces provided by these inserts serve as attachment points for marine organisms, promoting the settlement of coral, algae, and other fauna. This, in turn, contributes to increased biodiversity and ecological functionality within the artificial reef system.

The prior art relies on mass to achieve wave attenuation through direct wave confrontation. This direct confrontation creates wave reflection and compounds wave energy. This is known as constructive interference. This wave reflection and interference creates eddies that erode or scour the structures leading edge, causing problems like seawall, failure, and subsidence that eventually bury many submerged wave breaks and artificial reefs.

These structures scramble wave, currents, creating turbulence and conflicting forces to allow a relatively lightweight design to remain vertically stable. This flow through design is novel to prior art and allow sediment to pass through and accumulate on the lee side to stabilize the structure in the horizontal direction. Early-stage horizontal stabilization is critical prior to sediment accretion on the lee side. To achieve resistance to horizontal shift the units may be tied together and arranged in a flock formation. In contrast, a uniform row would experience the energy of a single wave instantly allowing the structures to shift or roll.

The prior art experiences a phenomenon termed channelization. It is the result of a structure, interrupting longshore drift and allowing current to run parallel to the shoreline on the lee side of a wave break. These structures having a flow-through design help to prevent channelization, and the flock pattern also creates turbulence in any current running on the lee side of the assembly further limiting channelization. Sediment accumulation and shoreline restoration is more possible by limiting this channelization. The flow through design allows for the accumulation of detritus and seeds associated with emergent vegetation, such as mangroves. Channelization in prior art prevents the accumulation and growth of these types of shoreline stabilizing species.

The individual structures and a flock formation must be locked together horizontally to prevent inching forward toward the shore, progressively due to the constant wave interactions. This tight high tolerance attachment is achieved through reinforced resin plates. These plates are bolted tightly to the concrete structure to prevent horizontal shift and limit vertical shift by reducing rotation/torsion forces through high friction achieved by the nut and washer assembly.

The high tolerances of the bolted plate and flock formation are made possible by the use of the precision deployment apparatus. The stable base and high degree of control is contrary to the low tolerance, barge crane deployment that is prone to wave and high pendulum forces that may damage concrete structure and injure personnel.

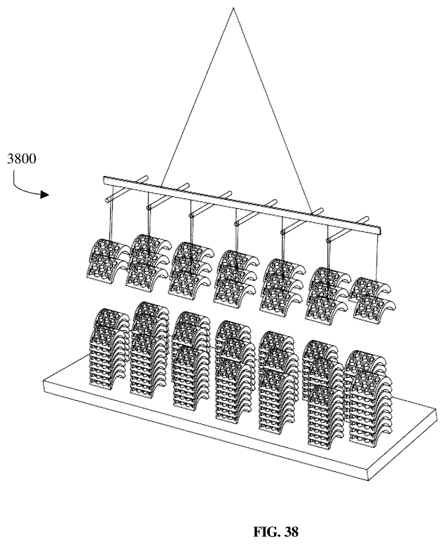

FIG. 38 is a perspective view of the ecological structures in the chain-like configuration 3800 during deployment, according to an example embodiment. Systematic efficient, barge deployment is also possible, due to the relatively lightweight and stackable property of the units. Deck space on a barge is at a premium so efficient use is important in deployment. While the ecological structures may be deployed one by one in some embodiments, the ecological structures may be pre-attached in the chain-like configuration before being deployed underwater. This helps accelerate the deployment process of the ecological structure system. FIG. 38 illustrates an efficient configuration for the storage, transportation, and deployment of modular ecological structures. FIG. 38 shows multiple lightweight, stackable ecological structures arranged in a systematic, chain-like configuration that facilitates barge transport and underwater deployment. The structures are pre-assembled and suspended from a support frame, which organizes them in vertical arrays to optimize the use of limited deck space on a barge. The modular ecological structures are stacked in interlocking columns on the barge's surface and are shown connected by suspending cables or similar mechanisms to a horizontal bar or rail above them. This pre-attachment into a chain-like configuration enables streamlined handling and deployment, allowing multiple units to be lowered into the water in a single, coordinated operation. Such an arrangement minimizes manual intervention during deployment and accelerates the overall process, a critical advantage when time and efficiency are prioritized in large-scale ecological restoration or construction projects.

The stackable nature of the ecological structures is evident in their compact arrangement, maximizing the use of available barge deck space. The lightweight design of the structures further enhances transport efficiency, reducing energy consumption during loading, unloading, and deployment. The pre-deployment configuration also ensures that the modular units are organized and ready for immediate placement in their intended underwater positions, reducing the need for assembly at the deployment site. This system represents a improvement over traditional methods, where individual structures are often deployed one at a time, requiring extensive labor and time. By enabling pre-attachment and efficient organization, this deployment method ensures cost savings, operational efficiency, and reduced environmental impact during installation. The chain-like configuration also supports seamless integration of the ecological structures into the surrounding environment, further enhancing their functionality and utility in ecological restoration and management efforts.

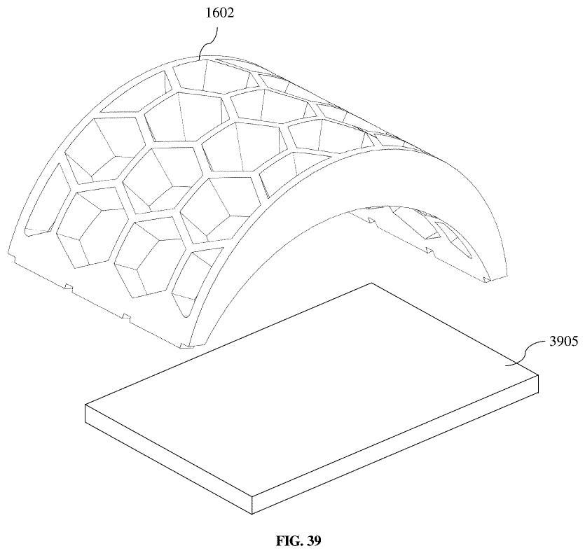

FIG. 39 is a perspective view of the ecological structure 1602 in comparison to an eight cubic foot slab 3905 of concrete, according to an example embodiment. The total amount of materials in the modular ecological structure is equivalent to the total amount of materials in an 8 cubic feet slab. These materials are deployed in a way that maximizes their functional benefits. This involves utilizing the materials to create a structure with internal voids, openings, and complex shapes that provide the necessary structural integrity and ecological benefits while minimizing material waste. Efficient material usage ensures that the modular ecological structure maintains the necessary weight and durability for stability in aquatic environments. The design leverages the material to form a strong frame with strategically placed openings and cutouts, promoting water flow, light penetration, and habitat spaces for marine life. This efficiency not only enhances the structural performance but also optimizes the ecological impact, creating a more hospitable environment for marine organisms. By using materials efficiently, the structure maintains necessary strength and stability while incorporating beneficial features such as openings and cutouts. This design approach ensures that every part of the material contributes to the overall performance of the structure. Efficient material usage reduces waste and production costs, making the structure more economical to produce and deploy. This efficiency can lead to wider adoption and more extensive deployment of artificial reefs. Minimizing material waste and using eco-friendly materials contributes to the sustainability of the project. The efficient design ensures that the structure provides maximum ecological benefits with minimal environmental footprint. The optimized weight and design of the structure make it easier to handle and deploy, reducing the need for heavy machinery and simplifying installation processes.

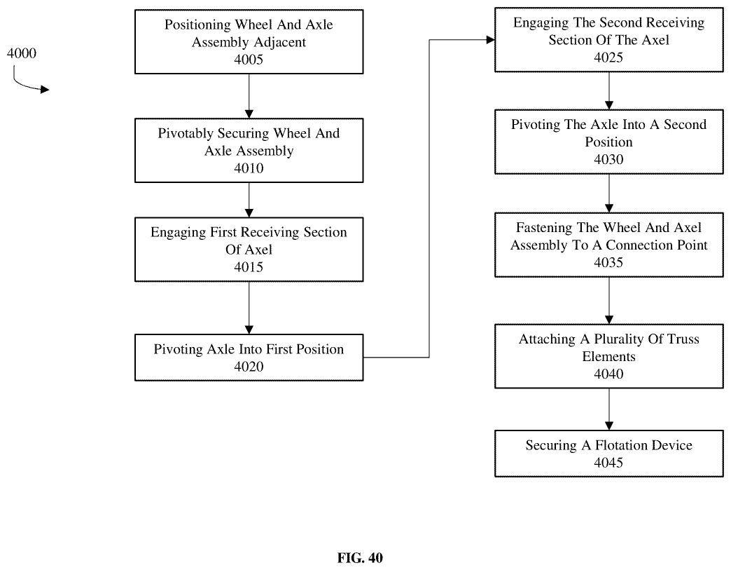

With reference to FIG. 40, a flowchart diagram illustrating the steps for a method 4000 for assembling the modular ecological structure is shown, according to an example embodiment. In step 4005, method 4000 includes positioning a wheel and axle assembly adjacent to a portion of a rod extending outward from a side wall of the modular ecological structure. This step involves aligning the assembly in proximity to a laterally extending rod that is structurally integrated into the side wall of the ecological structure. The rod serves as a connection point and anchoring mechanism for the wheel and axle assembly, enabling the assembly to interface with and support the ecological structure. The wheel and axle assembly is placed adjacent to the rod in such a way that the axle is parallel to the plane of the modular ecological structure's base or ground interface. The adjacency of the wheel and axle assembly to the rod allows for precise alignment, ensuring that forces exerted on the structure are transferred evenly through the rod into the side wall

In step 4010, method 4000 pivotably securing the wheel and axle assembly to the portion of the rod. This step involves attaching the assembly in such a way that it can rotate or pivot about the rod, providing flexibility and adaptability to the modular ecological structure. This mechanism ensures that the wheel and axle assembly can adjust its orientation to accommodate environmental factors such as uneven terrain, hydrodynamic forces, or shifting loads while maintaining a secure connection to the structure.

In step 4015, method 4000 engaging the first receiving section of the axel by inserting a lever arm into the first receiving section. This step involves connecting the lever arm to a receiving section on the axle to facilitate controlled movement or positioning of the axle relative to the modular ecological structure. This process allows for secure attachment and provides mechanical advantage for pivoting or rotating the axle into its desired configuration. The first receiving section on the axle is typically a slot, socket, or similar interface that is specifically shaped to accommodate the lever arm. This receiving section may be angled or aligned to enable precise engagement and to facilitate specific movements, such as tilting, rotating, or pivoting. To engage this section, the lever arm is inserted into the receiving section, fitting snugly to ensure secure contact. The lever arm itself is a rigid and durable tool, like the first frame structure, configured to withstand applied forces during engagement and operation. Once the lever arm is inserted into the first receiving section, it provides the operator with a mechanical advantage to manipulate the axle's orientation.

In step 4020, method 4000 pivoting the axle into a first position. This step involves rotating the axle around its mounting point or rod to achieve an initial alignment. To pivot the axle, a lever arm or first frame structure is engaged with a receiving section on the axle, providing the operator with mechanical advantage to control the pivoting motion. This receiving section, which may include a slot, hinge, or keyed interface, ensures precise engagement and allows for controlled rotation. As force is applied to the lever arm, the axle pivots around its mounting point, moving into the desired first position. The first position is typically a predetermined orientation that prepares the axle for subsequent operational adjustments.

In step 4025, method 4000 engaging the second receiving section of the axel by inserting the lever arm into the second receiving section. This step involves establishing a mechanical connection between the lever arm and a second interface on the axle configured to facilitate further adjustments or alignments. This step provides additional control over the axle's orientation, allowing for precise manipulation and positioning of the modular ecological structure's components. The second receiving section is a dedicated interface, such as a slot, socket, or other structural feature, integrated into the axle. It is positioned at a specific angle relative, such as perpendicularly, to the first receiving section to accommodate a different range of motion or alignment requirements. To engage this section, the operator aligns the lever arm, similar to the second frame structure, with the second receiving section and inserts it securely. The lever arm is configured to fit snugly into the receiving section, ensuring a stable connection that can withstand the forces applied during operation. Once the lever arm is engaged, the operator can apply force to pivot or rotate the axle into the desired orientation. The second receiving section provides a different pivoting axis or mechanical advantage compared to the first, enabling the axle to achieve a new position suited to the next stage of operation. For example, engaging the second receiving section may allow the axle to rotate into a position optimized for final deployment or stabilization of the modular ecological structure.

In step 4030, method 4000 pivoting the axle into a second position. This involves rotating or repositioning the axle around its mounting point to adjust the orientation of the wheels of the modular ecological system. After the axle is engaged with the lever arm, as described previously, the operator applies force to the lever arm to rotate the axle from its initial position into the second position. This pivoting motion occurs around the axle's mounting point. The second position is predetermined or dynamically adjusted based on the needs of the deployment.

In step 4035, method 4000 fastening the wheel and axel assembly to a connection point on the side wall of the modular ecological structure. This step involves securely attaching the assembly to an integrated mounting feature on the structure's side wall. This step provides stability and ensures that the wheel and axle assembly operates effectively as part of the modular system. The connection point serves as the anchoring mechanism and is configured to withstand the forces exerted on the wheel and axle assembly during deployment, operation, and environmental interactions. The connection point is preconfigured with features such as holes, brackets, or threaded inserts to facilitate secure attachment.

In step 4040, method 4000 attaching a plurality of truss elements to the ecological structure. This step involves securely connecting structural members that provide reinforcement and stability by linking the wheel and axle assembly at the base to the apex region of the modular ecological structure. This configuration forms a load-distributing framework that enhances the system's structural integrity, allowing it to withstand environmental forces such as wind, waves, or shifting terrain. Each truss element of the plurality of truss elements extends upwardly from the wheel and axle assembly and connects to the modular ecological structure at an apex region of the modular ecological structure. Each truss element is an elongated component configured to extend upwardly from a connection point on the wheel and axle assembly, which acts as a base support. The truss elements may feature attachment mechanisms at both ends, such as threaded connections, clamps, or locking pins, to facilitate secure and efficient installation. The process of attaching the truss elements begins by aligning the lower end of each truss element with a designated mounting point on the wheel and axle assembly. These mounting points are often preconfigured to allow for precise alignment and may include brackets, slots, or bushings to hold the truss elements securely. Once aligned, the lower ends of the truss elements are fastened using bolts, pins, or other fastening systems to ensure a stable connection. This secure attachment ensures that the truss elements are capable of transferring loads from the apex region of the ecological structure down to the wheel and axle assembly, where the forces are distributed to the ground or supporting surface.

The upper ends of the truss elements are then extended upward and connected to the apex region of the modular ecological structure. The apex region serves as a centralized structural point, often reinforced to handle the converging forces from the truss elements. The connection at the apex is typically facilitated through integrated features such as slots, eyelets, or welded plates that align with the ends of the truss elements. Fasteners, such as bolts, pins, or clamps, are used to secure these connections, ensuring the truss elements remain firmly in place under dynamic conditions. The upward extension of the truss elements from the wheel and axle assembly to the apex region creates a triangulated framework. This configuration is highly effective at distributing loads and resisting both compressive and tensile forces.

In step 4045, method 4000 securing a flotation device to the modular ecological structure. The flotation device, similar to flotation device 1612 in FIG. 21F, is attached to the modular ecological structure through an opening extending from an upper curved surface to a lower curved surface of the modular ecological structure. This step involves attaching a buoyant component to the structure to provide stability, buoyancy, and adaptability in aquatic environments. The flotation device allows the ecological structure to remain afloat or maintain a specific position within a water column, even when subjected to external forces such as currents, waves, or varying water levels.

The flotation device is attached to the ecological structure with a fastener 2110 passing through an opening 130 extending through the upper curved surface to the lower curved surface. To attach the flotation device, it is aligned with the opening in the ecological structure. The fastener is then inserted through the flotation device and threaded through the opening, creating a continuous connection from the upper curved surface to the lower curved surface. The fastener is secured using locking mechanisms such as nuts, washers, or gaskets, which ensure a tight, stable fit. In some embodiments, the fastener may also include seals or waterproofing elements to prevent water ingress through the opening, maintaining the structural integrity of the ecological system. This attachment method ensures that the flotation device is firmly anchored to the ecological structure, allowing it to provide consistent buoyancy even under dynamic conditions such as wave action, currents, or shifting loads. The through-hole design offers enhanced stability by securing the flotation device at two points—the upper and lower surfaces—minimizing the risk of detachment or misalignment. Additionally, the placement of the flotation device can be adjusted by selecting different openings along the structure, providing flexibility to customize the system's buoyancy and balance.

It is understood by those skilled in the art that the steps of the methods described herein are not limited to the specific order presented. Unless explicitly stated otherwise, the method steps may be performed in different sequences, rearranged, or performed concurrently where appropriate without departing from the scope and spirit of the invention. The described order is merely one exemplary embodiment, and variations in the sequence of steps may be made based on the particular circumstances of the implementation, application, or design preferences. For example, certain steps may be combined, omitted, or repeated depending on the operational conditions or requirements of the system. Accordingly, the scope of the invention should not be construed as being limited to the specific order of steps outlined in the methods.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A modular ecological system comprising:
an ecological structure comprising a base section comprising
a body comprising a first end region, a second end region, and an upper curved surface and a lower curved surface spanning between the first end region and the second end region;
a first side wall and a second side wall extending from each of the first end region and second end region and converging at an apex region, wherein the first side wall and the second side wall define a thickness between the upper curved surface and the lower curved surface;
a first rod extending laterally through the first end region;
a second rod extending laterally through the second end region;
wherein each of the first rod and the second rod extend outwardly from both the first side wall and second side wall.

2. The modular ecological system of claim 1 further comprising a wheel and an axle assembly attachable to the first rod at a portion extending outward from the first side wall and the second side wall.

3. The modular ecological system of claim 2 wherein the wheel and axle assembly comprises a first receiving section on the axle disposed at a first angle relative to a second receiving section on the axle.

4. The modular ecological system of claim 3 wherein the modular ecological system further comprises a truss assembly, wherein the truss assembly comprises a plurality of truss elements, each truss element extending upwardly from the wheel and axle assembly and having a connection point the apex region.

5. The modular ecological system of claim 4 wherein the modular ecological system further comprises a flotation device attached to the ecological structure.

6. The modular ecological system of claim 5 wherein the flotation device is attached to the ecological structure with a fastener passing through an opening extending through the upper curved surface to the lower curved surface.

7. The modular ecological system of claim 6, wherein a plurality of flotation devices are arranged symmetrically about the ecological structure.

8. The modular ecological system of claim 7, wherein the ecological structure comprises a plurality of connection points on each of the first side wall and the second side wall.

9. The modular ecological system of claim 8, wherein the ecological structure further comprises a looped cable extending from each of the first side wall and the second side wall.

10. The modular ecological system of claim 9, wherein the ecological structure further comprises a load distribution nub on the upper curved surface.

11. The modular ecological system of claim 10, wherein the upper curved surface comprises a first uniform radius of curvature and the lower curved surface comprises a second uniform radius of curvature, and wherein the thickness between the upper curved surface and the lower curved surface continuously decreases from the apex region to each of the first end region and the second end region.

12. The modular ecological system of claim 11, wherein the opening extending through the upper curved surface to the lower curved surface comprises a predetermined opening angle to direct a plurality of hydrodynamic forces through the structure.

13. A modular ecological system comprising:
an ecological structure comprising a base section comprising
a body comprising a first end region, a second end region, and an upper curved surface and a lower curved surface spanning between the first end region and the second end region;
a first side wall and a second side wall extending from each of the first end region and second end region and converging at an apex region, wherein the first side wall and the second side wall define a thickness between the upper curved surface and the lower curved surface;
a rod extending laterally and outwardly from at least one of the first side wall and second side wall.

14. The modular ecological system of claim 13 further comprising a wheel and an axle assembly attachable to the first rod at a portion extending outward from the first side wall and the second side wall.

15. The modular ecological system of claim 14 further comprising a truss assembly, wherein the truss assembly comprises a plurality of truss elements, each truss element extending upwardly from the wheel and axle assembly and having a connection point the apex region.

16. The modular ecological system of claim 13 further comprising a flotation device attached to the ecological structure.

17. The modular ecological system of claim 13, wherein the modular ecological structure further comprises a load distribution nub on the upper curved surface.

18. The modular ecological system of claim 13, wherein the upper curved surface comprises a first uniform radius of curvature and the lower curved surface comprises a second uniform radius of curvature, and wherein the thickness between the upper curved surface and the lower curved surface continuously decreases from the apex region to each of the first end region and the second end region.

19. The modular ecological system of claim 13, wherein the ecological structure comprises an angled opening extending through the upper curved surface to the lower curved surface to direct a plurality of hydrodynamic forces through the structure.

20. A method for assembling a modular ecological structure, the method comprising:
positioning a wheel and axle assembly adjacent to a portion of a rod extending outward from a side wall of the modular ecological structure;
pivotably securing the wheel and axle assembly to the portion of the rod;
engaging a first receiving section of the axel by inserting a lever arm into the first receiving section;
pivoting the axle into a first position;
engaging a second receiving section of the axel by inserting the lever arm into the second receiving section;
pivoting the axle into a second position; and
fastening the wheel and axel assembly to a connection point on the side wall of the modular ecological structure.
